(19) United States
(12) Patent Application Publication
(10) Pub. No.: US 2019/0373245 A1
(43) Pub. Date: Dec. 5, 2019

(54) 360 VIDEO TRANSMISSION METHOD, 360 VIDEO RECEPTION METHOD, 360 VIDEO TRANSMISSION DEVICE, AND 360 VIDEO RECEPTION DEVICE

(71) Applicant: LG ELECTRONICS INC., Seoul (KR)

(72) Inventors: Jangwon LEE, Seoul (KR); Sejin OH, Seoul (KR)

(73) Assignee: LG ELECTRONICS INC., Seoul (KR)

(21) Appl. No.: 16/485,142

(22) PCT Filed: Jan. 3, 2018
(86) PCT No.: PCT/KR2018/000106

§ 371 Date: Aug. 9, 2019

Related U.S. Application Data
(60) Provisional application No. 62/478,076, filed on Mar. 29, 2017.
(60) Provisional application No. 62/511,399, filed on May 26, 2017.
(60) Provisional application No. 62/530,275, filed on Jul. 9, 2017.
(60) Provisional application No. 62/531,326, filed on Jul. 11, 2017.

(51) Int. Cl. H04N 13/194; H04N 21/845; H04L 29/08

(52) U.S. Cl. CPC H04N 13/194; H04L 67/02; H04N 21/8456

(57) ABSTRACT

The present invention may relate to a method for transmitting a 360 video. The method for transmitting a 360 video according to the present invention may comprise the steps of: processing 360 video data captured by at least one camera; encoding the picture; generating signaling information for the 360 video data; encapsulating the encoded picture and the signaling information into a file; and transmitting the file.

### TECHNICAL FIELD

The present invention relates to a method for transmitting a 360 video, a method for receiving a 360 video, an apparatus for transmitting a 360 video, and an apparatus for receiving a 360 video.

### BACKGROUND ART

A virtual reality (VR) system provides, to a user, the experience of being in an electronically projected environment. The VR system can be enhanced in order to provide images with higher definition and spatial sounds. The VR system can allow a user to interactively use VR content.

### DISCLOSURE

### Technical Problem

The VR system needs to be enhanced in order to more efficiently provide VR environments to users. To this end, it is necessary to provide data transmission efficiency for transmission of a large amount of data such as VR content, robustness between transmission and reception networks, network flexibility considering a mobile receiver, efficient reproduction and a signaling method, etc.

In addition, subtitles based on a typical Timed Text Markup Language (TTML) or subtitles based on a bitmap are not produced considering a 360 video. Accordingly, subtitle-related features and subtitle-related signaling information need to be further extended so as to be suitable for a use case of the VR service in order to provide subtitles suitable for the 360 video.

### Technical Solution

In accordance with the objects of the present invention, the present invention proposes a method for transmitting a 360 video, a method for receiving a 360 video, an apparatus for transmitting a 360 video, and an apparatus for receiving a 360 video.

In one aspect of the present invention, provided herein is a method for transmitting a 360 video including stitching 360 video data captured by at least one camera, projecting the stitched 360 video data onto a first picture, performing region-wise packing by mapping Regions of the first picture to a second picture, processing data of the second picture into Dynamic Adaptive Streaming over HTTP (DASH) representations, generating a Media Presentation Description (MPD) including signaling information about the 360 video data, and transmitting the DASH representations and the MPD.

The MPD may include a first descriptor and a second descriptor, wherein the first descriptor may include information indicating a projection type used when the stitched 360 video data is projected onto the first picture, and wherein the second descriptor may include information indicating a packing type used when region-wise packing is performed from the first picture to the second picture.

The information indicating the projection type may indicate that the projection has an equirectangular projection type or a cubemap projection type, and wherein the information indicating the packing type may indicate that the region-wise packing has a rectangular region-wise packing type.

The MPD may include a third descriptor, wherein the third descriptor may include coverage information indicating a region occupied by an entire region corresponding to the 360 video data in a 3D space, wherein the coverage information may specify a center point of the region in the 3D space using azimuth and elevation values and specify a horizontal range and a vertical range of the region.

At least one of the DASH representations may be a timed metadata representation including timed metadata, wherein the timed metadata may include initial viewpoint information indicating an initial viewpoint, and wherein the timed metadata may include information for identifying a DASH representation having 360 video data to which the initial viewpoint information is applied.

The timed metadata may include recommended viewport information indicating a viewport recommended by a service provider, and wherein the timed metadata may include information for identifying a DASH representation having 360 video data to which the recommended viewport information is applied.

The third descriptor may further include a single signaling field simultaneously indicating frame packing arrangement information about a 360 video corresponding to the region and whether the 360 video is a stereomoscopic 360 video.

In another aspect of the present invention, provided herein is an apparatus for transmitting a 360 video, including a video processor configured to stitch 360 video data captured by at least one camera, the processor projecting the stitched 360 video data onto a first picture and performing region-wise packing by mapping Regions of the first picture to a second picture, an encapsulation processor configured to process data of the second picture into Dynamic Adaptive Streaming over HTTP (DASH) representations, a metadata processor configured to generate a Media Presentation Description (MPD) including signaling information about the 360 video data, and a transmission unit configured to transmit the DASH representations and the MPD.

The MPD may include a first descriptor and a second descriptor, wherein the first descriptor may include information indicating a projection type used when the stitched 360 video data is projected onto the first picture, and wherein the second descriptor may include information indicating a packing type used when region-wise packing is performed from the first picture to the second picture.

The information indicating the projection type may indicate that the projection has an equirectangular projection type or a cubemap projection type, and wherein the information indicating the packing type may indicate that the region-wise packing has a rectangular region-wise packing type.

The MPD may include a third descriptor, wherein the third descriptor may include coverage information indicating a region occupied by an entire region corresponding to the 360 video data in a 3D space, wherein the coverage information may specify a center point of the region in the 3D space using azimuth and elevation values and specify a horizontal range and a vertical range of the region.

At least one of the DASH representations may be a timed metadata representation including timed metadata, wherein the timed metadata may include initial viewpoint information indicating an initial viewpoint, and wherein the timed metadata may include information for identifying a DASH representation having 360 video data to which the initial viewpoint information is applied.

The timed metadata may include recommended viewport information indicating a viewport recommended by a service provider, and wherein the timed metadata may include information for identifying a DASH representation having 360 video data to which the recommended viewport information is applied.

The third descriptor may further include a single signaling field simultaneously indicating frame packing arrangement information about a 360 video corresponding to the region and whether the 360 video is a stereomoscopic 360 video.

### Advantageous Effects

The present invention can efficiently transmit 360 content in an environment supporting future hybrid broadcast using terrestrial broadcast networks and the Internet.

The present invention can propose methods for providing interactive experience in 360 content consumption of users.

The present invention can propose signaling methods for correctly reflecting intention of 360 content producers in 360 content consumption of users.

The present invention can propose methods of efficiently increasing transmission capacity and delivering necessary information in 360 content delivery.

### DESCRIPTION OF DRAWINGS

FIG. 1 illustrates an architecture for providing 360 video according to the present invention.

FIG. 2 illustrates a 360 video transmission apparatus according to one aspect of the present invention.

FIG. 3 illustrates a 360 video reception apparatus according to another aspect of the present invention.

FIG. 4 illustrates a 360 video transmission apparatus/360 video reception apparatus according to another embodiment of the present invention.

FIG. 5 illustrates the concept of aircraft principal axes for describing a 3D space according to the present invention.

FIG. 6 illustrates projection_schemes according to one embodiment of the present invention.

FIG. 7 illustrates tiles according to one embodiment of the present invention.

FIG. 8 illustrates 360 video related metadata according to one embodiment of the present invention.

FIG. 9 illustrates a media file structure according to one embodiment of the present invention.

FIG. 10 illustrates a hierarchical structure of boxes in ISOBMFF according to one embodiment of the present invention.

FIG. 11 illustrates overall operation of a DASH based adaptive streaming model according to one embodiment of the present invention.

FIG. 12 is a diagram exemplarily illustrating the configuration of a data encoder according to the present invention.

FIG. 13 is a diagram exemplarily illustrating the configuration of a data decoder according to the present invention.

FIG. 14 exemplarily shows a hierarchical structure of coded data.

FIG. 15 exemplarily shows a motion constraint tile set (MCTS) extraction and delivery process as an example of region-based independent processing.

FIG. 16 shows an example of an image frame for supporting region-based independent processing.

FIG. 17 shows an example of a bitstream configuration for supporting region-based independent processing.

FIG. 18 exemplarily shows a track configuration of a file according to the present invention.

FIG. 19 shows RegionOriginalCoordinateBox according to an example of the present invention.

FIG. 20 exemplarily shows a region indicated by corresponding information in an original picture.

FIG. 21 shows RegionToTrackBox according to an embodiment of the present invention.

FIG. 22 shows an SEI message according to an embodiment of the present invention.

FIG. 23 shows mcts_sub_bitstream_region_in_original_picture_coordinate_info according to an embodiment of the present invention.

FIG. 24 shows MCTS region-related information in a file including multiple MCTS bitstreams according to an embodiment of the present invention.

FIG. 25 illustrates viewport dependent processing according to an embodiment of the present invention.

FIG. 26 shows coverage information according to an embodiment of the present invention.

FIG. 27 shows sub-picture composition according to an embodiment of the present invention.

FIG. 28 shows overlapping sub-pictures according to an embodiment of the present invention.

FIG. 29 shows the syntax of SubpictureCompositionBox.

FIG. 30 shows a hierarchical structure of Region-wisePackingBox.

FIG. 31 schematically illustrates a transmission/reception procedure of 360-degree video using sub-picture composition according to the present invention.

FIG. 32 exemplarily shows sub-picture composition according to the present invention.

FIG. 33 schematically illustrates a method for processing 360-degree video data by a 360-degree video transmission apparatus according to the present invention.

FIG. 34 schematically illustrates a method for processing 360-degree video data by a 360-degree video reception apparatus according to the present invention.

FIG. 35 is a diagram illustrating a 360 video transmission apparatus according to one aspect of the present invention.

FIG. 36 is a diagram illustrating a 360 video reception apparatus according to another aspect of the present invention.

FIG. 37 shows an embodiment of the coverage information according to the present invention.

FIG. 38 shows another embodiment of the coverage information according to the present invention.

FIG. 39 shows still another embodiment of coverage information according to the present invention.

FIG. 40 shows yet another embodiment of the coverage information according to the present invention.

FIG. 41 shows yet another embodiment of the coverage information according to the present invention.

FIG. 42 illustrates one embodiment of a method for transmitting a 360 video, which may be carried out by the 360 video transmission apparatus according to the present invention.

FIG. 43 is a diagram illustrating a 360 video transmission apparatus according to one aspect of the present invention.

FIG. 44 is a diagram illustrating a 360 video reception apparatus according to another aspect of the present invention.

FIG. 45 shows an embodiment of a coverage descriptor according to the present invention.

FIG. 46 shows an embodiment of a dynamic region descriptor according to the present invention.

FIG. 47 shows an example of use of initial view point information and/or recommended view point/viewport information according to the present invention.

FIG. 48 shows another example of use of initial view point information and/or recommended view point/viewport information according to the present invention.

FIG. 49 shows yet another example of use of initial view point information and/or recommended view point/viewport information according to the present invention.

FIG. 50 is a diagram exemplarily illustrating a gap analysis in stereoscopic 360 video data signaling according to the present invention.

FIG. 51 shows another embodiment of a track coverage information box according to the present invention.

FIG. 52 shows another embodiment of a content coverage descriptor according to the present invention.

FIG. 53 shows an embodiment of sub-picture composition box according to the present invention.

FIG. 54 illustrates an embodiment of a signaling process when fisheye 360 video data according to the present invention is rendered on a spherical surface.

FIG. 55 illustrates an embodiment of signaling information in which new shape_type is defined according to the present invention.

FIGS. 56 and 57 show another embodiment of SphereRegionStruct for a fisheye 360 video according to the present invention.

FIG. 58 show yet another embodiment of SphereRegionStruct for a fisheye 360 video according to the present invention.

FIG. 59 illustrates an embodiment of a method for transmitting a 360 video, which may be carried out by the 360 video transmission apparatus according to the present invention.

### BEST MODE

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention.

Although most terms of elements in this specification have been selected from general ones widely used in the art taking into consideration functions thereof in this specification, the terms may be changed depending on the intention or convention of those skilled in the art or the introduction of new technology. Some terms have been arbitrarily selected by the applicant and their meanings are explained in the following description as needed. Thus, the terms used in this specification should be construed based on the overall content of this specification together with the actual meanings of the terms rather than their simple names or meanings.

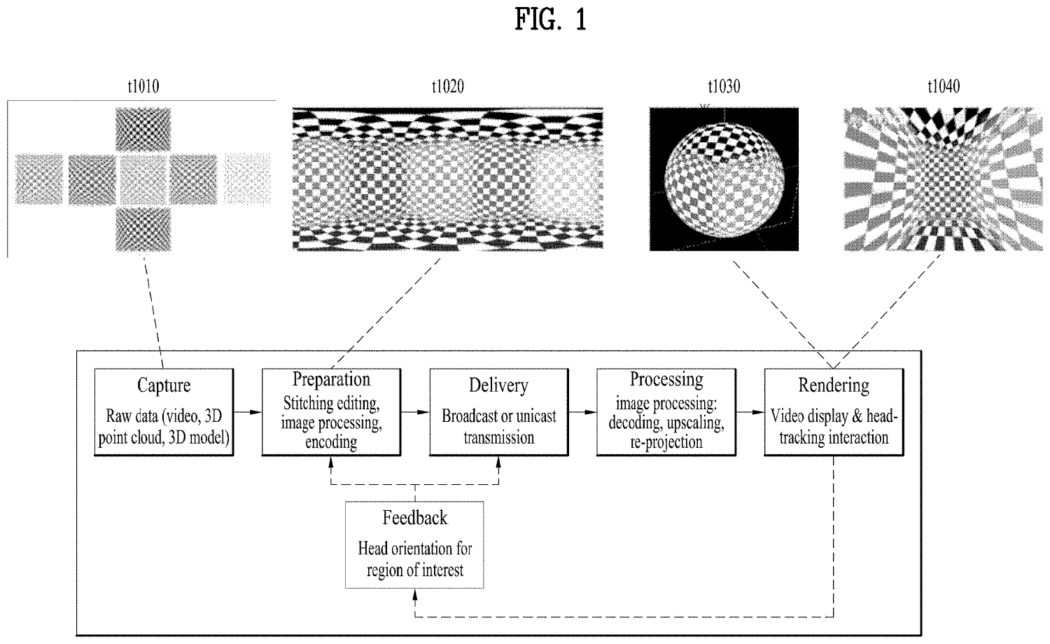

FIG. 1 illustrates an architecture for providing 360 video according to the present invention.

The present invention proposes a method for providing 360 content in order to provide Virtual Reality (VR) to users. VR refers to a technique or an environment for replicating an actual or virtual environment. VR artificially provides sensuous experiences to users and thus users can experience electronically projected environments.

360 content refers to convent for realizing and providing VR and may include 360 video and/or 360 audio. 360 video may refer to video or image content which is necessary to provide VR and is captured or reproduced in all directions (360 degrees). 360 video may refer to video or an image represented on 3D spaces in various forms according to 3D models. For example, 360 video can be represented on a spherical plane. 360 audio is audio content for providing VR and may refer to spatial audio content which can be recognized as content having an audio generation source located on a specific space. 360 content may be generated, processed and transmitted to users, and users may consume VR experiences using the 360 content.

The present invention proposes a method for effectively providing 360degree video. To provide 360 video, first, 360 video may be captured using one or more cameras. The captured 360 video is transmitted through a series of processes, and a reception side may process received data into the original 360 video and render the 360 video. Accordingly, the 360 video can be provided to a user.

Specifically, a procedure for providing 360 video may include a capture process, a preparation process, a transmission process, a processing process, a rendering process and/or a feedback process.

The capture process may refer to a process of capturing images or videos for a plurality of viewpoints through one or more cameras. An image/video data t1010 shown in the figure can be generated through the capture process. Each plane of the shown image/video data t1010 may refer to an image/video for each viewpoint. The captured images/videos may be called raw data. In the capture process, metadata related to capture may be generated.

For capture, a special camera for VR may be used. When 360 video for a virtual space generated using a computer is provided according to an embodiment, capture using a camera may not be performed. In this case, the capture process may be replaced by a process of simply generating related data.

The preparation process may be a process of processing the captured images/videos and metadata generated in the capture process. The captured images/videos may be subjected to stitching, projection, region-wise packing and/or encoding in the preparation process.

First, the images/videos may pass through a stitching process. The stitching process may be a process of connecting the captured images/videos to create a single panorama image/video or a spherical image/video.

Then, the stitched images/videos may pass through a projection process. In the projection process, the stitched images/videos can be projected onto a 2D image. This 2D image may be called a 2D image frame. Projection on a 2D image may be represented as mapping to the 2D image. The projected image/video data can have a form of a 2D image t1020 as shown in the figure.

The video data projected onto the 2D image can pass through a region-wise packing process in order to increase video coding efficiency. Region-wise packing may refer to a process of dividing the video data projected onto the 2D image into regions and processing the regions. Here, regions may refer to regions obtained by dividing a 2D image on which 360 video data is projected. Such regions may be obtained by dividing the 2D image equally or randomly according to an embodiment. The regions may be divided depending on a projection_scheme according to an embodiment. The region-wise packing process is an optional process and thus may be omitted in the preparation process.

According to an embodiment, this process may include a process of rotating the regions or rearranging the regions on the 2D image in order to increase video coding efficiency. For example, the regions can be rotated such that specific sides of regions are positioned in proximity to each other to increase coding efficiency.

According to an embodiment, this process may include a process of increasing or decreasing the resolution of a specific region in order to differentiate the resolution for regions of the 360 video. For example, the resolution of regions corresponding to a relatively important part of the 360 video can be increased to higher than other regions. The video data projected onto the 2D image or the region-wise packed video data can pass through an encoding process using a video codec.

According to an embodiment, the preparation process may additionally include an editing process. In the editing process, the image/video data before or after projection may be edited. In the preparation process, metadata with respect to stitching/projection/encoding/editing may be generated. In addition, metadata with respect to the initial viewpoint or ROI (region of interest) of the video data projected onto the 2D image may be generated.

The transmission process may be a process of processing and transmitting the image/video data and metadata which have passed through the preparation process. For transmission, processing according to an arbitrary transport protocol may be performed. The data that has been processed for transmission may be delivered over a broadcast network and/or broadband. The data may be delivered to a reception side in an on-demand manner. The reception side may receive the data through various paths.

The processing process refers to a process of decoding the received data and re-projecting the projected image/video data on a 3D model. In this process, the image/video data projected onto the 2D image may be re-projected onto a 3D space. This process may be called mapping projection. Here, the 3D space on which the data is mapped may have a form depending on a 3D model. For example, 3D models may include a sphere, a cube, a cylinder and a pyramid.

According to an embodiment, the processing process may further include an editing process, an up-scaling process, etc. In the editing process, the image/video data before or after re-projection can be edited. When the image/video data has been reduced, the size of the image/video data can be increased through up-scaling of samples in the up-scaling process. As necessary, the size may be decreased through down-scaling.

The rendering process may refer to a process of rendering and displaying the image/video data re-projected onto the 3D space. Re-projection and rendering may be collectively represented as rendering on a 3D model. The image/video re-projected (or rendered) on the 3D model may have a form t1030 as shown in the figure. The form t1030 corresponds to a case in which the image/video data is re-projected onto a spherical 3D model. A user can view a region of the rendered image/video through a VR display or the like. Here, the region viewed by the user may have a form t1040 shown in the figure.

The feedback process may refer to a process of delivering various types of feedback information which can be acquired in the display process to a transmission side. Through the feedback process, interactivity in 360 video consumption can be provided. According to an embodiment, head orientation information, viewport information indicating a region currently viewed by a user, etc. can be delivered to the transmission side in the feedback process. According to an embodiment, the user may interact with content realized in a VR environment. In this case, information related to the interaction may be delivered to the transmission side or a service provider in the feedback process. According to an embodiment, the feedback process may not be performed.

The head orientation information may refer to information about the position, angle and motion of a user's head. On the basis of this information, information about a region of 360 video currently viewed by the user, that is, viewport information can be calculated.

The viewport information may be information about a region of 360 video currently viewed by a user. Gaze analysis may be performed using the viewport information to check a manner in which the user consumes 360 video, a region of the 360 video at which the user gazes, and how long the user gazes at the region. Gaze analysis may be performed by the reception side and the analysis result may be delivered to the transmission side through a feedback channel. A device such as a VR display may extract a viewport region on the basis of the position/direction of a user's head, vertical or horizontal FOV supported by the device, etc.

According to an embodiment, the aforementioned feedback information may be consumed on the reception side as well as being delivered to the transmission side. That is, decoding, re-projection and rendering processes of the reception side can be performed using the aforementioned feedback information. For example, only 360 video corresponding to the region currently viewed by the user can be preferentially decoded and rendered using the head orientation information and/or the viewport information.

Here, a viewport or a viewport region can refer to a region of 360 video currently viewed by a user. A viewpoint is a point in 360 video which is viewed by the user and may refer to a center point of a viewport region. That is, a viewport is a region based on a viewpoint, and the size and form of the region can be determined by FOV (field of view) which will be described below.

In the above-described architecture for providing 360 video, image/video data which is subjected to a series of capture/projection/encoding/transmission/decoding/re-projection/rendering processes can be called 360 video data. The term “360 video data” may be used as the concept including metadata or signaling information related to such image/video data.

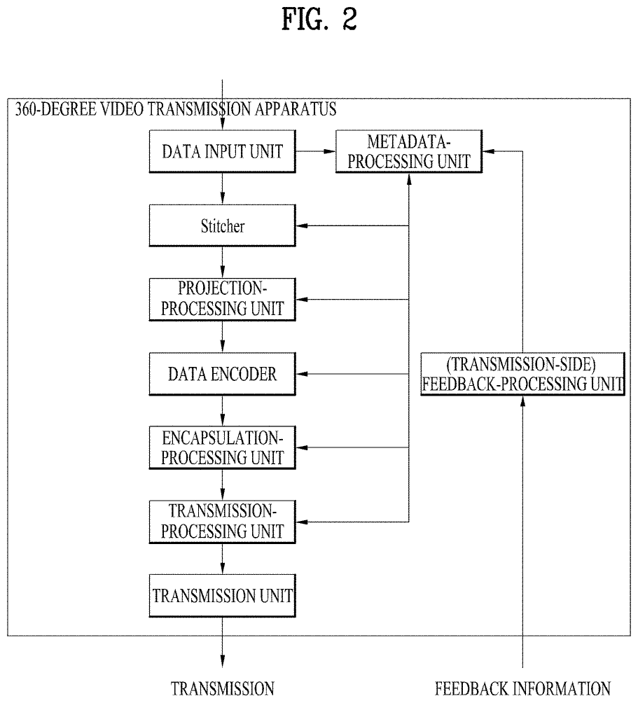

FIG. 2 illustrates a 360 video transmission apparatus according to one aspect of the present invention.

According to one aspect, the present invention may relate to a 360 video transmission apparatus. The 360 video transmission apparatus according to the present invention may perform operations related to the above-described preparation process to the transmission process. The 360 video transmission apparatus according to the present invention may include a data input unit, a stitcher, a projection processor, a region-wise packing processor (not shown), a metadata processor, a (transmission side) feedback processor, a data encoder, an encapsulation processor, a transmission processor and/or a transmitter as internal/external elements.

The data input unit may receive captured images/videos for respective viewpoints. The images/videos for the viewpoints may be images/videos captured by one or more cameras. In addition, the data input unit may receive metadata generated in the capture process. The data input unit may deliver the received images/videos for the viewpoints to the stitcher and deliver the metadata generated in the capture process to a signaling processor.

The stitcher may stitch the captured images/videos for the viewpoints. The stitcher may deliver the stitched 360 video data to the projection processor. The stitcher may receive necessary metadata from the metadata processor and use the metadata for stitching operation as necessary. The stitcher may deliver the metadata generated in the stitching process to the metadata processor. The metadata in the stitching process may include information indicating whether stitching has been performed, a stitching type, etc.

The projection processor may project the stitched 360 video data on a 2D image. The projection processor may perform projection according to various schemes which will be described below. The projection processor may perform mapping in consideration of the depth of 360 video data for each viewpoint. The projection processor may receive metadata necessary for projection from the metadata processor and use the metadata for the projection operation as necessary. The projection processor may deliver metadata generated in the projection process to the metadata processor. The metadata of the projection process may include a projection_scheme type.

The region-wise packing processor (not shown) may perform the aforementioned region-wise packing process. That is, the region-wise packing processor may perform a process of dividing the projected 360 video data into regions, rotating or rearranging the regions or changing the resolution of each region. As described above, the region-wise packing process is an optional process, and when region-wise packing is not performed, the region-wise packing processor can be omitted. The region-wise packing processor may receive metadata necessary for region-wise packing from the metadata processor and use the metadata for the region-wise packing operation as necessary. The metadata of the region-wise packing processor may include a degree to which each region is rotated, the size of each region, etc.

The aforementioned stitcher, the projection processor and/or the region-wise packing processor may be realized by one hardware component according to an embodiment.

The metadata processor may process metadata which can be generated in the capture process, the stitching process, the projection process, the region-wise packing process, the encoding process, the encapsulation process and/or the processing process for transmission. The metadata processor may generate 360 video related metadata using such metadata. According to an embodiment, the metadata processor may generate the 360 video related metadata in the form of a signaling table. The 360 video related metadata may be called metadata or 360 video related signaling information according to the signaling context. Furthermore, the metadata processor may deliver acquired or generated metadata to internal elements of the 360 video transmission apparatus as necessary. The metadata processor may deliver the 360 video related metadata to the data encoder, the encapsulation processor and/or the transmission processor such that the metadata can be transmitted to the reception side.

The data encoder may encode the 360 video data projected onto the 2D image and/or the region-wise packed 360 video data. The 360 video data may be encoded in various formats.

The encapsulation processor may encapsulate the encoded 360 video data and/or 360 video related metadata into a file. Here, the 360 video related metadata may be delivered from the metadata processor. The encapsulation processor may encapsulate the data in a file format such as ISOBMFF, CFF or the like or process the data into a DASH segment. The encapsulation processor may include the 360 video related metadata in a file format according to an embodiment. For example, the 360 video related metadata can be included in boxes of various levels in an ISOBMFF file format or included as data in an additional track in a file. In an embodiment, the encapsulation processor may encapsulate the 360 video related metadata into a file.

The transmission processor may perform processing for transmission on the 360 video data d in a file format. The transmission processor may process the 360 video data according to an arbitrary transport protocol. The processing for transmission may include processing for delivery through a broadcast network and processing for delivery over a broadband. According to an embodiment, the transmission processor may receive 360 video related metadata from the metadata processor in addition to the 360 video data and perform processing for transmission on the 360 video related metadata.

The transmission unit may transmit the processed 360 video data and/or the 360 video related metadata over a broadcast network and/or broadband. The transmission unit may include an element for transmission over a broadcast network and an element for transmission over a broadband.

According to an embodiment of the present invention, the 360 video transmission apparatus may further include a data storage unit (not shown) as an internal/external element. The data storage unit may store the encoded 360 video data and/or 360 video related metadata before delivery to the transmission processor. Such data may be stored in a file format such as ISOBMFF. When 360 video is transmitted in real time, the data storage unit may not be used. However, 360 video is delivered on demand, in non-real time or over a broadband, encapsulated 360 data may be stored in the data storage unit for a predetermined period and then transmitted.

According to another embodiment of the present invention, the 360 video transmission apparatus may further include a (transmission side) feedback processor and/or a network interface (not shown) as internal/external elements. The network interface may receive feedback information from a 360 video reception apparatus according to the present invention and deliver the feedback information to the (transmission side) feedback processor. The feedback processor may deliver the feedback information to the stitcher, the projection processor, the region-wise packing processor, the data encoder, the encapsulation processor, the metadata processor and/or the transmission processor. The feedback information may be delivered to the metadata processor and then delivered to each internal element according to an embodiment. Upon reception of the feedback information, internal elements may reflect the feedback information in 360 video data processing.

According to another embodiment of the 360 video transmission apparatus of the present invention, the region-wise packing processor may rotate regions and map the regions on a 2D image. Here, the regions may be rotated in different directions at different angles and mapped on the 2D image. The regions may be rotated in consideration of neighboring parts and stitched parts of the 360 video data on the spherical plane before projection. Information about rotation of the regions, that is, rotation directions and angles may be signaled using 360 video related metadata. According to another embodiment of the 360 video transmission apparatus according to the present invention, the data encoder may perform encoding differently on respective regions. The data encoder may encode a specific region with high quality and encode other regions with low quality. The feedback processor at the transmission side may deliver the feedback information received from the 360 video reception apparatus to the data encoder such that the data encoder can use encoding methods differentiated for regions. For example, the feedback processor can deliver viewport information received from the reception side to the data encoder. The data encoder may encode regions including a region indicated by the viewport information with higher quality (UHD) than other regions.

According to another embodiment of the 360 video transmission apparatus according to the present invention, the transmission processor may perform processing for transmission differently on respective regions. The transmission processor may apply different transmission parameters (modulation orders, code rates, etc.) to regions such that data delivered for the regions have different robustnesses.

Here, the feedback processor may deliver the feedback information received from the 360 video reception apparatus to the transmission processor such that the transmission processor can perform transmission processing differentiated for respective regions. For example, the feedback processor can deliver viewport information received from the reception side to the transmission processor. The transmission processor may perform transmission processing on regions including a region indicated by the viewport information such that the regions have higher robustness than other regions.

The aforementioned internal/external elements of the 360 video transmission apparatus according to the present invention may be hardware elements. According to an embodiment, the internal/external elements may be modified, omitted, replaced by other elements or integrated with other elements. According to an embodiment, additional elements may be added to the 360 video transmission apparatus.

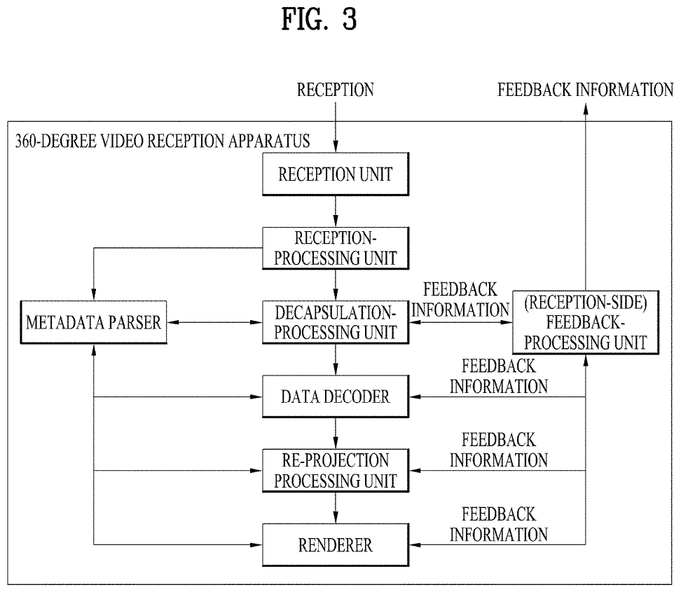

FIG. 3 illustrates a 360 video reception apparatus according to another aspect of the present invention.

According to another aspect, the present invention may relate to a 360 video reception apparatus. The 360 video reception apparatus according to the present invention may perform operations related to the above-described processing process and/or the rendering process. The 360 video reception apparatus according to the present invention may include a reception unit, a reception processor, a decapsulation processor, a data decoder, a metadata parser, a (reception side) feedback processor, a re-projection processor and/or a renderer as internal/external elements.

The reception unit may receive 360 video data transmitted from the 360 video transmission apparatus according to the present invention. The reception unit may receive the 360 video data through a broadcast network or a broadband depending on a transmission channel.

The reception processor may perform processing according to a transport protocol on the received 360 video data. The reception processor may perform a reverse of the process of the transmission processor. The reception processor may deliver the acquired 360 video data to the decapsulation processor and deliver acquired 360 video related metadata to the metadata parser. The 360 video related metadata acquired by the reception processor may have a form of a signaling table.

The decapsulation processor may decapsulate the 360 video data in a file format received from the reception processor. The decapsulation processor may decapsulate files in ISOBMFF to acquire 360 video data and 360 video related metadata. The acquired 360 video data may be delivered to the data decoder and the acquired 360 video related metadata may be delivered to the metadata parser. The 360 video related metadata acquired by the decapsulation processor may have a form of box or track in a file format. The decapsulation processor may receive metadata necessary for decapsulation from the metadata parser as necessary.

The data decoder may decode the 360 video data. The data decoder may receive metadata necessary for decoding from the metadata parser. The 360 video related metadata acquired in the data decoding process may be delivered to the metadata parser.

The metadata parser may parse/decode the 360 video related metadata. The metadata parser may deliver the acquired metadata to the data decapsulation processor, the data decoder, the re-projection processor and/or the renderer.

The re-projection processor may re-project the decoded 360 video data. The re-projection processor may re-project the 360 video data on a 3D space. The 3D space may have different forms depending on used 3D models. The re-projection processor may receive metadata necessary for re-projection from the metadata parser. For example, the re-projection processor may receive information about the type of a used 3D model and detailed information thereof from the metadata parser. According to an embodiment, the re-projection processor may re-project only 360 video data corresponding to a specific region on the 3D space using the metadata necessary for re-projection.

The renderer may render the re-projected 360 video data. This may be represented as rendering of the 360 video data on a 3D space as described above. When two processes are simultaneously performed in this manner, the re-projection processor and the renderer may be integrated and the processes may be performed in the renderer. According to an embodiment, the renderer may render only a region viewed by the user according to view information of the user.

The user may view part of the rendered 360 video through a VR display. The VR display is a device for reproducing 360 video and may be included in the 360 video reception apparatus (tethered) or connected to the 360 video reception apparatus as a separate device (un-tethered).

According to an embodiment of the present invention, the 360 video reception apparatus may further include a (reception side) feedback processor and/or a network interface (not shown) as internal/external elements. The feedback processor may acquire feedback information from the renderer, the re-projection processor, the data decoder, the decapsulation processor and/or the VR display and process the feedback information. The feedback information may include viewport information, head orientation information, gaze information, etc. The network interface may receive the feedback information from the feedback processor and transmit the same to the 360 video transmission apparatus.

As described above, the feedback information may be used by the reception side in addition to being delivered to the transmission side. The reception side feedback processor can deliver the acquired feedback information to internal elements of the 360 video reception apparatus such that the feedback information is reflected in a rendering process. The reception side feedback processor can deliver the feedback information to the renderer, the re-projection processor, the data decoder and/or the decapsulation processor. For example, the renderer can preferentially render a region viewed by the user using the feedback information. In addition, the decapsulation processor and the data decoder can preferentially decapsulate and decode a region viewed by the user or a region to be viewed by the user.

The internal/external elements of the 360 video reception apparatus according to the present invention may be hardware elements. According to an embodiment, the internal/external elements may be modified, omitted, replaced by other elements or integrated with other elements. According to an embodiment, additional elements may be added to the 360 video reception apparatus.

Another aspect of the present invention may relate to a method for transmitting 360 video and a method for receiving 360 video. The methods of transmitting/receiving 360 video according to the present invention may be performed by the above-described 360 video transmission/reception apparatus or embodiments thereof.

The aforementioned embodiments of the 360 video transmission/reception apparatus and embodiments of the internal/external elements thereof may be combined. For example, embodiments of the projection processor and embodiments of the data encoder can be combined to create as many embodiments of the 360 video transmission apparatus as the number of the embodiments. The combined embodiments are also included in the scope of the present invention.

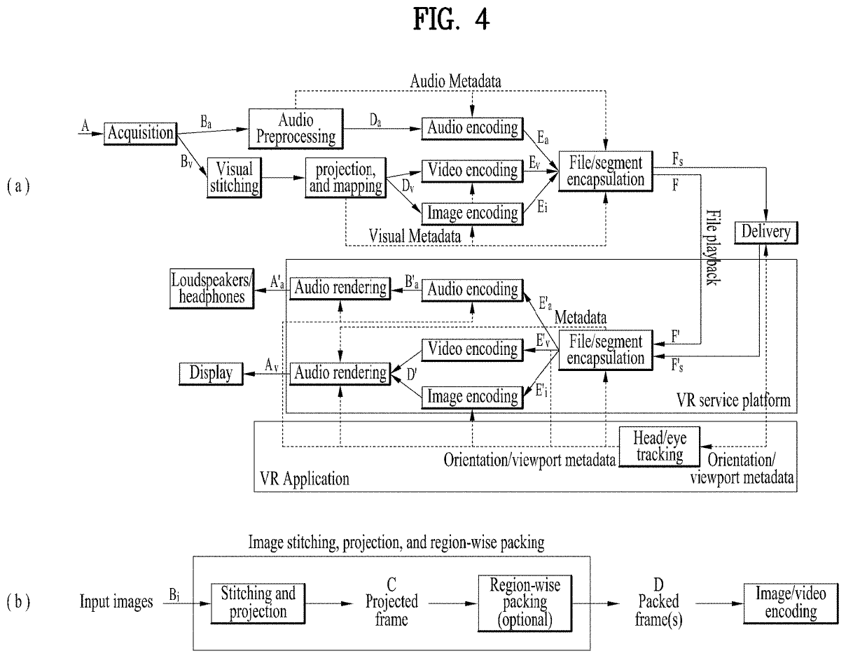

FIG. 4 illustrates a 360 video transmission apparatus/360 video reception apparatus according to another embodiment of the present invention.

As described above, 360 content may be provided according to the architecture shown in (a). The 360 content may be provided in the form of a file or in the form of a segment based download or streaming service such as DASH. Here, the 360 content may be called VR content.

As described above, 360 video data and/or 360 audio data may be acquired.

The 360 audio data may be subjected to audio preprocessing and audio encoding. Through these processes, audio related metadata may be generated, and the encoded audio and audio related metadata may be subjected to processing for transmission (file/segment encapsulation).

The 360 video data may pass through the aforementioned processes. The stitcher of the 360 video transmission apparatus may stitch the 360 video data (visual stitching). This process may be omitted and performed on the reception side according to an embodiment. The projection processor of the 360 video transmission apparatus may project the 360 video data on a 2D image (projection and mapping (packing)).

The stitching and projection processes are shown in (b) in detail. In (b), when the 360 video data (input images) is delivered, stitching and projection may be performed thereon. The projection process may be regarded as projecting the stitched 360 video data on a 3D space and arranging the projected 360 video data on a 2D image. In the specification, this process may be represented as projecting the 360 video data on a 2D image. Here, the 3D space may be a sphere or a cube. The 3D space may be identical to the 3D space used for re-projection on the reception side.

The 2D image may also be called a projected frame C. Region-wise packing may be optionally performed on the 2D image. When region-wise packing is performed, the positions, forms and sizes of regions may be indicated such that the regions on the 2D image can be mapped on a packed frame D. When region-wise packing is not performed, the projected frame may be identical to the packed frame. Regions will be described below. The projection process and the region-wise packing process may be represented as projecting regions of the 360 video data on a 2D image. The 360 video data may be directly converted into the packed frame without an intermediate process according to design.

In (a), the projected 360 video data may be image-encoded or video-encoded. Since the same content may be present for different viewpoints, the same content may be encoded into different bit streams. The encoded 360 video data may be processed into a file format such as ISOBMFF according to the aforementioned encapsulation processor. Alternatively, the encapsulation processor may process the encoded 360 video data into segments. The segments may be included in an individual track for DASH based transmission.

Along with processing of the 360 video data, 360 video related metadata may be generated as described above. This metadata may be included in a video bitstream or a file format and delivered. The metadata may be used for encoding, file format encapsulation, processing for transmission, etc.

The 360 audio/video data may pass through processing for transmission according to the transport protocol and then be transmitted. The aforementioned 360 video reception apparatus may receive the 360 audio/video data over a broadcast network or broadband.

In (a), a VR service platform may correspond to an embodiment of the aforementioned 360 video reception apparatus. In (a), loudspeakers/headphones, display and head/eye tracking components are performed by an external device or a VR application of the 360 video reception apparatus. According to an embodiment, the 360 video reception apparatus may include all of these components. According to an embodiment, the head/eye tracking components may correspond to the aforementioned reception side feedback processor.

The 360 video reception apparatus may perform processing for reception (file/segment decapsulation) on the 360 audio/video data. The 360 audio data may be subjected to audio decoding and audio rendering and then provided to the user through a speaker/headphone.

The 360 video data may be subjected to image decoding or video decoding and visual rendering and provided to the user through a display. Here, the display may be a display supporting VR or a normal display.

As described above, the rendering process may be regarded as a process of re-projecting 360 video data on a 3D space and rendering the re-projected 360 video data. This may be represented as rendering of the 360 video data on the 3D space.

The head/eye tracking components may acquire and process head orientation information, gaze information and viewport information of a user. This has been described above.

The reception side may include a VR application which communicates with the aforementioned processes of the reception side.

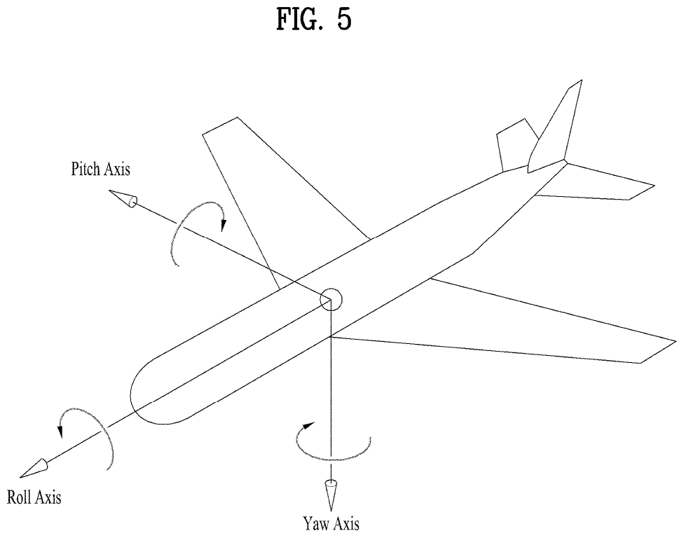

FIG. 5 illustrates the concept of aircraft principal axes for describing a 3D space of the present invention.

In the present invention, the concept of aircraft principal axes may be used to represent a specific point, position, direction, spacing and region in a 3D space.

That is, the concept of aircraft principal axes may be used to describe a 3D space before projection or after re-projection and to signal the same. According to an embodiment, a method using X, Y and Z axes or a spherical coordinate system may be used.

An aircraft can freely rotate in the three dimension. Axes which form the three dimension are called pitch, yaw and roll axes. In the specification, these may be represented as pitch, yaw and roll or a pitch direction, a yaw direction and a roll direction.

The pitch axis may refer to a reference axis of a direction in which the front end of the aircraft rotates up and down. In the shown concept of aircraft principal axes, the pitch axis can refer to an axis connected between wings of the aircraft.

The yaw axis may refer to a reference axis of a direction in which the front end of the aircraft rotates to the left/right. In the shown concept of aircraft principal axes, the yaw axis can refer to an axis connected from the top to the bottom of the aircraft.

The roll axis may refer to an axis connected from the front end to the tail of the aircraft in the shown concept of aircraft principal axes, and rotation in the roll direction can refer to rotation based on the roll axis.

As described above, a 3D space in the present invention can be described using the concept of the pitch, yaw and roll.

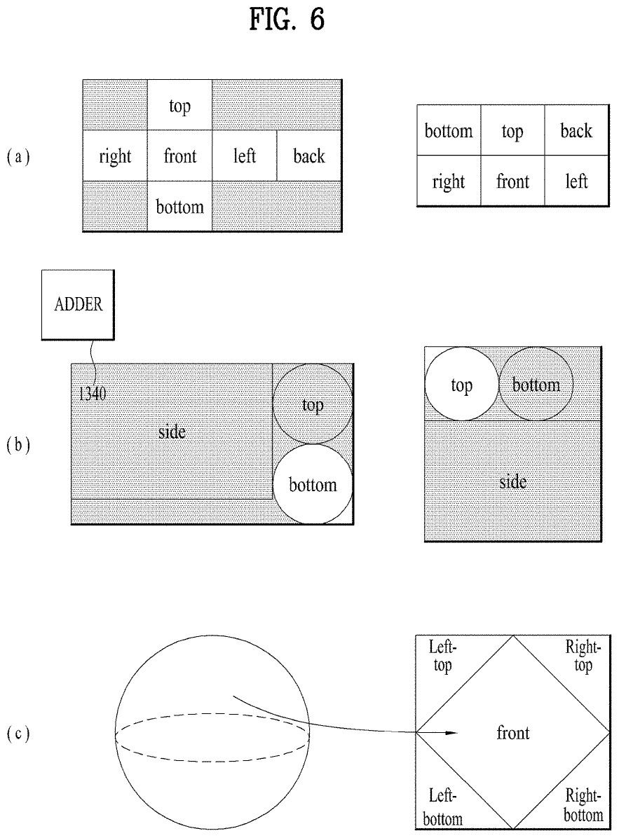

FIG. 6 illustrates projection_schemes according to an embodiment of the present invention.

As described above, the projection processor of the 360 video transmission apparatus according to the present invention may project stitched 360 video data on a 2D image. In this process, various projection_schemes can be used.

According to another embodiment of the 360 video transmission apparatus according to the present invention, the projection processor may perform projection using a cubic projection_scheme. For example, stitched video data can be represented on a spherical plane. The projection processor may segment the 360 video data into faces of a cube and project the same on the 2D image. The 360 video data on the spherical plane may correspond to the faces of the cube and be projected onto the 2D image as shown in (a).

According to another embodiment of the 360 video transmission apparatus according to the present invention, the projection processor may perform projection using a cylindrical projection_scheme. Similarly, if stitched video data can be represented on a spherical plane, the projection processor can segment the 360 video data into parts of a cylinder and project the same on the 2D image. The 360 video data on the spherical plane can correspond to the side, top and bottom of the cylinder and be projected onto the 2D image as shown in (b).

According to another embodiment of the 360 video transmission apparatus according to the present invention, the projection processor may perform projection using a pyramid projection_scheme. Similarly, if stitched video data can be represented on a spherical plane, the projection processor can regard the 360 video data as a pyramid form, segment the 360 video data into faces of the pyramid and project the same on the 2D image. The 360 video data on the spherical plane can correspond to the front, left top, left bottom, right top and right bottom of the pyramid and be projected onto the 2D image as shown in (c).

According to an embodiment, the projection processor may perform projection using an equirectangular projection_scheme and a panoramic projection_scheme in addition to the aforementioned schemes.

As described above, regions may refer to regions obtained by dividing a 2D image on which 360 video data is projected. Such regions need not correspond to respective faces of the 2D image projected according to a projection_scheme. However, regions may be divided such that the faces of the projected 2D image correspond to the regions and region-wise packing may be performed according to an embodiment. Regions may be divided such that a plurality of faces may correspond to one region or one face may correspond to a plurality of regions according to an embodiment. In this case, the regions may depend on projection_schemes. For example, the top, bottom, front, left, right and back sides of the cube can be respective regions in (a). The side, top and bottom of the cylinder can be respective regions in (b). The front, left top, left bottom, right top and right bottom sides of the pyramid can be respective regions in (c).

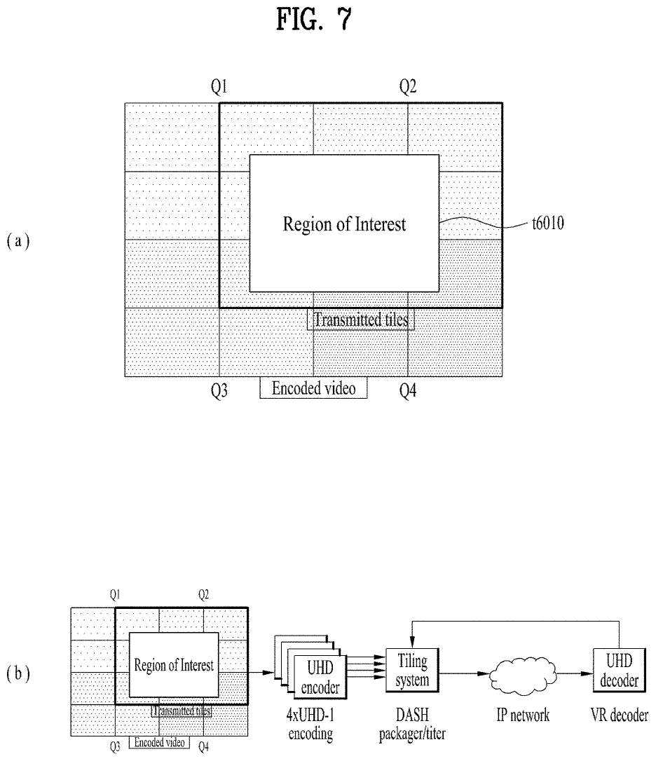

FIG. 7 illustrates tiles according to an embodiment of the present invention.

360 video data projected onto a 2D image or region-wise packed 360 video data may be divided into one or more tiles. (a) shows that one 2D image is divided into 16 tiles. Here, the 2D image may be the aforementioned projected frame or packed frame. According to another embodiment of the 360 video transmission apparatus of the present invention, the data encoder may independently encode the tiles.

The aforementioned region-wise packing can be discriminated from tiling. The aforementioned region-wise packing may refer to a process of dividing 360 video data projected onto a 2D image into regions and processing the regions in order to increase coding efficiency or adjusting resolution. Tiling may refer to a process through which the data encoder divides a projected frame or a packed frame into tiles and independently encode the tiles. When 360 video is provided, a user does not simultaneously use all parts of the 360 video. Tiling enables only tiles corresponding to important part or specific part, such as a viewport currently viewed by the user, to be transmitted to or consumed by the reception side on a limited bandwidth. Through tiling, a limited bandwidth can be used more efficiently and the reception side can reduce computational load compared to a case in which the entire 360 video data is processed simultaneously.

A region and a tile are discriminated from each other and thus they need not be identical. However, a region and a tile may refer to the same area according to an embodiment. Region-wise packing may be performed based on tiles and thus regions can correspond to tiles according to an embodiment. Furthermore, when sides according to a projection_scheme correspond to regions, each side, region and tile according to the projection_scheme may refer to the same area according to an embodiment. A region may be called a VR region and a tile may be called a tile region according to context.

ROI (Region of Interest) may refer to a region of interest of users, which is provided by a 360 content provider. When the 360 content provider produces 360 video, the 360 content provider can produce the 360 video in consideration of a specific region which is expected to be a region of interest of users. According to an embodiment, ROI may correspond to a region in which important content of the 360 video is reproduced.

According to another embodiment of the 360 video transmission/reception apparatus of the present invention, the reception side feedback processor may extract and collect viewport information and deliver the same to the transmission side feedback processor. In this process, the viewport information can be delivered using network interfaces of both sides. In the 2D image shown in (a), a viewport t6010 is displayed. Here, the viewport may be displayed over nine tiles of the 2D images.

In this case, the 360 video transmission apparatus may further include a tiling system. According to an embodiment, the tiling system may be located following the data encoder (b), may be included in the aforementioned data encoder or transmission processor, or may be included in the 360 video transmission apparatus as a separate internal/external element.

The tiling system may receive viewport information from the transmission side feedback processor. The tiling system may select only tiles included in a viewport region and transmit the same. In the 2D image shown in (a), only nine tiles including the viewport region t6010 among 16 tiles can be transmitted. Here, the tiling system may transmit tiles in a unicast manner over a broadband because the viewport region is different for users.

In this case, the transmission side feedback processor may deliver the viewport information to the data encoder. The data encoder may encode the tiles including the viewport region with higher quality than other tiles.

Furthermore, the transmission side feedback processor may deliver the viewport information to the metadata processor. The metadata processor may deliver metadata related to the viewport region to each internal element of the 360 video transmission apparatus or include the metadata in 360 video related metadata.

By using this tiling method, transmission bandwidths can be saved and processes differentiated for tiles can be performed to achieve efficient data processing/transmission.

The above-described embodiments related to the viewport region can be applied to specific regions other than the viewport region in a similar manner. For example, the aforementioned processes performed on the viewport region can be performed on a region determined to be a region in which users are interested through the aforementioned gaze analysis, ROI, and a region (initial view, initial viewpoint) initially reproduced when a user views 360 video through a VR display.

According to another embodiment of the 360 video transmission apparatus of the present invention, the transmission processor may perform processing for transmission differently on tiles. The transmission processor may apply different transmission parameters (modulation orders, code rates, etc.) to tiles such that data delivered for the tiles has different robustnesses.

Here, the transmission side feedback processor may deliver feedback information received from the 360 video reception apparatus to the transmission processor such that the transmission processor can perform transmission processing differentiated for tiles. For example, the transmission side feedback processor can deliver the viewport information received from the reception side to the transmission processor. The transmission processor can perform transmission processing such that tiles including the corresponding viewport region have higher robustness than other tiles.

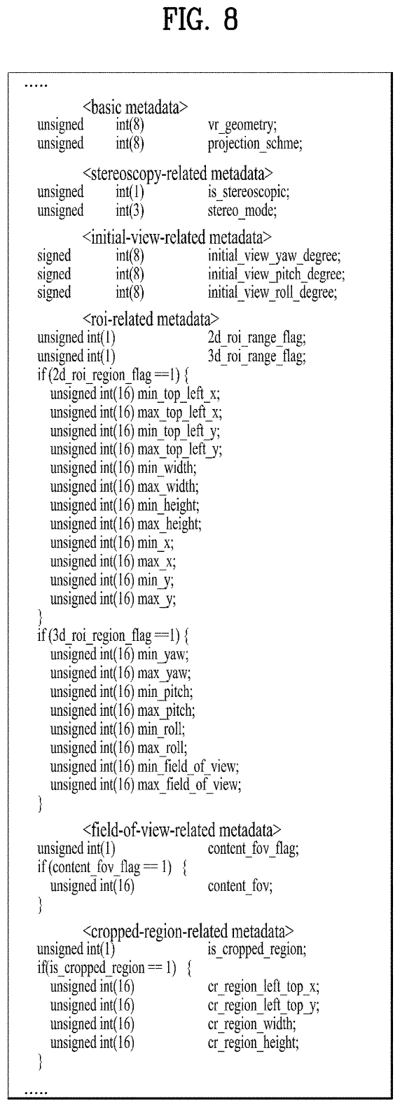

FIG. 8 illustrates 360 video related metadata according to an embodiment of the present invention.

The aforementioned 360 video related metadata may include various types of metadata related to 360 video. The 360 video related metadata may be called 360 video related signaling information according to context. The 360 video related metadata may be included in an additional signaling table and transmitted, included in a DASH MPD and transmitted, or included in a file format such as ISOBMFF in the form of box and delivered. When the 360 video related metadata is included in the form of box, the 360 video related metadata may be included in various levels such as a file, fragment, track, sample entry, sample, etc. and may include metadata about data of the corresponding level.

According to an embodiment, part of the metadata, which will be described below, may be configured in the form of a signaling table and delivered, and the remaining part may be included in a file format in the form of a box or a track.

According to an embodiment of the 360 video related metadata, the 360 video related metadata may include basic metadata related to a projection_scheme, stereoscopic related metadata, initial view/initial viewpoint related metadata, ROI related metadata, FOV (Field of View) related metadata and/or cropped region related metadata. According to an embodiment, the 360 video related metadata may include additional metadata in addition to the aforementioned metadata.

Embodiments of the 360 video related metadata according to the present invention may include at least one of the aforementioned basic metadata, stereoscopic related metadata, initial view/initial viewpoint related metadata, ROI related metadata, FOV related metadata, cropped region related metadata and/or additional metadata. Embodiments of the 360 video related metadata according to the present invention may be configured in various manners depending on the number of cases of metadata included therein. According to an embodiment, the 360 video related metadata may further include additional metadata in addition to the aforementioned metadata.

The basic metadata may include 3D model related information, projection_scheme related information and the like. The basic metadata may include a vr_geometry field, a projection_scheme field, etc. According to an embodiment, the basic metadata may further include additional information.

The vr_geometry field can indicate the type of a 3D model supported by the corresponding 360 video data. When the 360 video data is re-projected onto a 3D space as described above, the 3D space may have a form according to a 3D model indicated by the vr_geometry field. According to an embodiment, a 3D model used for rendering may differ from the 3D model used for re-projection, indicated by the vr_geometry field. In this case, the basic metadata may further include a field which indicates the 3D model used for rendering. When the field has values of 0, 1, 2 and 3, the 3D space can conform to 3D models of a sphere, a cube, a cylinder and a pyramid. When the field has the remaining values, the field can be reserved for future use. According to an embodiment, the 360 video related metadata may further include detailed information about the 3D model indicated by the field. Here, the detailed information about the 3D model may refer to the radius of a sphere, the height of a cylinder, etc. for example. This field may be omitted.

The projection_scheme field can indicate a projection_scheme used when the 360 video data is projected onto a 2D image. When the field has values of 0, 1, 2, 3, 4, and 5, the field indicates that the equirectangular projection scheme, cubic projection scheme, cylindrical projection scheme, tile-based projection scheme, pyramid projection scheme and panoramic projection scheme are used. When the field has a value of 6, the field indicates that the 360 video data is directly projected onto the 2D image without stitching. When the field has the remaining values, the field can be reserved for future use. According to an embodiment, the 360 video related metadata may further include detailed information about regions generated according to a projection scheme specified by the field. Here, the detailed information about regions may refer to information indicating whether regions have been rotated, the radius of the top region of a cylinder, etc. for example.

The stereoscopic related metadata may include information about 3D related attributes of the 360 video data. The stereoscopic related metadata may include an is_stereoscopic field and/or a stereo_mode field. According to an embodiment, the stereoscopic related metadata may further include additional information.

The is_stereoscopic field can indicate whether the 360 video data supports 3D. When the field is 1, the 360 video data supports 3D. When the field is 0, the 360 video data does not support 3D. This field may be omitted.

The stereo_mode field can indicate 3D layout supported by the corresponding 360 video. Whether the 360 video supports 3D can be indicated only using this field. In this case, the is_stereoscopic field can be omitted. When the field is 0, the 360 video may be a mono mode. That is, the projected 2D image can include only one mono view. In this case, the 360 video may not support 3D.

When this field is set to 1 and 2, the 360 video can conform to left-right layout and top-bottom layout. The left-right layout and top-bottom layout may be called a side-by-side format and a top-bottom format. In the case of the left-right layout, 2D images on which left view/right view are projected can be positioned at the left/right on an image frame. In the case of the top-bottom layout, 2D images onto which left view/right view are projected can be positioned at the top/bottom on an image frame. When the field has the remaining values, the field can be reserved for future use.

The initial view/initial viewpoint related metadata may include information about a view (initial view) which is seen by a user when initially reproducing 360 video. The initial view/initial viewpoint related metadata may include an initial_view_yaw_degree field, an initial_view_pitch_degree field and/or an initial_view_roll_degree field. According to an embodiment, the initial view/initial viewpoint related metadata may further include additional information.

The initial view_yaw degree field, initial view_pitch degree field and initial_view_roll_degree field can indicate an initial view when the 360 video is reproduced. That is, the center point of a viewport which is initially viewed when the 360 video is reproduced can be indicated by these three fields. The fields can indicate the center point using a direction (sign) and a degree (angle) of rotation on the basis of yaw, pitch and roll axes. Here, the viewport which is initially viewed when the 360 video is reproduced according to FOV. The width and height of the initial viewport based on the indicated initial view may be determined through FOV. That is, the 360 video reception apparatus can provide a specific region of the 360 video as an initial viewport to a user using the three fields and FOV information.

According to an embodiment, the initial view indicated by the initial view/initial viewpoint related metadata may be changed per scene. That is, scenes of the 360 video change as 360 content proceeds with time. The initial view or initial viewport which is initially viewed by a user can change for each scene of the 360 video. In this case, the initial view/initial viewpoint related metadata can indicate the initial view per scene. To this end, the initial view/initial viewpoint related metadata may further include a scene identifier for identifying a scene to which the initial view is applied. In addition, since FOV may change per scene of the 360 video, the initial view/initial viewpoint related metadata may further include FOV information per scene which indicates FOV corresponding to the relative scene.

The ROI related metadata may include information related to the aforementioned ROI. The ROI related metadata may include a 2d_roi_range_flag field and/or a 3d_roi_range_flag field. These two fields can indicate whether the ROI related metadata includes fields which represent ROI on the basis of a 2D image or fields which represent ROI on the basis of a 3D space. According to an embodiment, the ROI related metadata may further include additional information such as differentiate encoding information depending on ROI and differentiate transmission processing information depending on ROI.

When the ROI related metadata includes fields which represent ROI on the basis of a 2D image, the ROI related metadata may include a min_top_left_x field, a max_top_left_x field, a min_top _left_y field, a max_top_left_y field, a min_width field, a max_width field, a min_height field, a max_height field, a min_x field, a max_x field, a min_y field and/or a max_y field.

The min_top_left_x field, max_top_left_x field, min_top_left_y field, max_top_left_y field can represent minimum/maximum values of the coordinates of the left top end of the ROI. These fields can sequentially indicate a minimum x coordinate, a maximum x coordinate, a minimum y coordinate and a maximum y coordinate of the left top end.

The min_width field, max_width field, min_height field and max_height field can indicate minimum/maximum values of the width and height of the ROI. These fields can sequentially indicate a minimum value and a maximum value of the width and a minimum value and a maximum value of the height.

The min_x field, max_x field, min_y field and max_y field can indicate minimum and maximum values of coordinates in the ROI. These fields can sequentially indicate a minimum x coordinate, a maximum x coordinate, a minimum y coordinate and a maximum y coordinate of coordinates in the ROI. These fields can be omitted.

When ROI related metadata includes fields which indicate ROI on the basis of coordinates on a 3D rendering space, the ROI related metadata may include a min_yaw field, a max_yaw field, a min_pitch field, a max_pitch field, a min_roll field, a max_roll field, a min_field_of_view field and/or a max_field_of_view field.

The min_yaw field, max_yaw field, min_pitch field, max_pitch field, min_roll field and max_roll field can indicate a region occupied by ROI on a 3D space using minimum/maximum values of yaw, pitch and roll. These fields can sequentially indicate a minimum value of yaw-axis based reference rotation amount, a maximum value of yaw-axis based reference rotation amount, a minimum value of pitch-axis based reference rotation amount, a maximum value of pitch-axis based reference rotation amount, a minimum value of roll-axis based reference rotation amount, and a maximum value of roll-axis based reference rotation amount.

The min_field_of_view field and max_field_of_view field can indicate minimum/maximum values of FOV of the corresponding 360 video data. FOV can refer to the range of view displayed at once when 360 video is reproduced. The min field of view field and max_field_of_view field can indicate minimum and maximum values of FOV. These fields can be omitted. These fields may be included in FOV related metadata which will be described below.

The FOV related metadata may include the aforementioned FOV related information. The FOV related metadata may include a content_fov_flag field and/or a content_fov field. According to an embodiment, the FOV related metadata may further include additional information such as the aforementioned minimum/maximum value related information of FOV.

The content_fov_flag field can indicate whether corresponding 360 video includes information about FOV intended when the 360 video is produced. When this field value is 1, a content_fov field can be present.

The content_fov field can indicate information about FOV intended when the 360 video is produced. According to an embodiment, a region displayed to a user at once in the 360 video can be determined according to vertical or horizontal FOV of the 360 video reception apparatus. Alternatively, a region displayed to a user at once in the 360 video may be determined by reflecting FOV information of this field according to an embodiment.

Cropped region related metadata may include information about a region including 360 video data in an image frame. The image frame may include a 360 video data projected active video area and other areas. Here, the active video area can be called a cropped region or a default display region. The active video area is viewed as 360 video on an actual VR display and the 360 video reception apparatus or the VR display can process/display only the active video area. For example, when the aspect ratio of the image frame is 4:3, only an area of the image frame other than an upper part and a lower part of the image frame can include 360 video data. This area can be called the active video area.

The cropped region related metadata can include an is_cropped_region field, a cr_region_left_top_x field, a cr_region_left_top_y field, a cr_region_width field and/or a cr_region_height field. According to an embodiment, the cropped region related metadata may further include additional information.

The is_cropped_region field may be a flag which indicates whether the entire area of an image frame is used by the 360 video reception apparatus or the VR display. That is, this field can indicate whether the entire image frame indicates an active video area. When only part of the image frame is an active video area, the following four fields may be added.

A cr_region_left_top_x field, a cr_region_left_top_y field, a cr_region_width field and a cr_region_height field can indicate an active video area in an image frame. These fields can indicate the x coordinate of the left top, the y coordinate of the left top, the width and the height of the active video area. The width and the height can be represented in units of pixel.

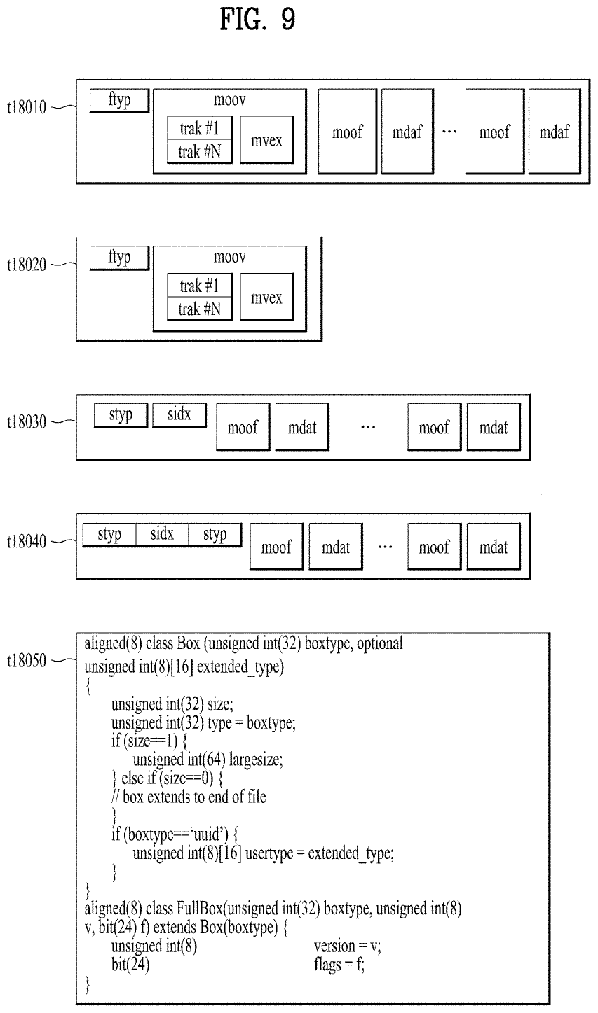

FIG. 9 illustrates a media file structure according to one embodiment of the present invention.

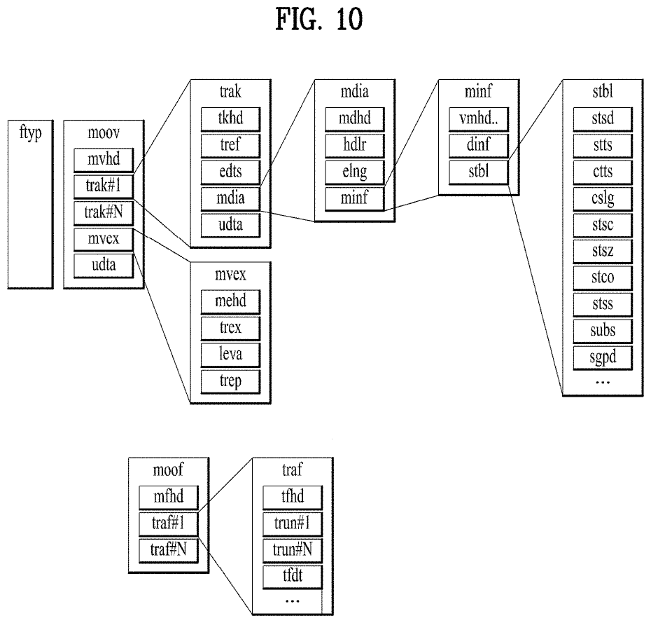

FIG. 10 illustrates a hierarchical structure of boxes in ISOBMFF according to one embodiment of the present invention.

To store and transmit media data such as audio or video, a standardized media file format can be defined. According to an embodiment, a media file may have a file format based on ISO base media file format (ISOBMFF).

A media file according to the present invention may include at least one box. Here, a box may be a data block or an object including media data or metadata related to media data. Boxes may be arranged in a hierarchical structure, and thus data can be classified and a media file can take a form suitable for storage and/or transmission of media data. In addition, the media file may have a structure which facilitates accessing media information such as user moving to a specific point in media content.

The media file according to the present invention can include an ftyp box, a moov box and/or an mdat box.

The ftyp box (file type box) can provide information related to file type or compatibility of the corresponding media file. The ftyp box can include configuration version information about media data of the media file. A decoder can identify the corresponding media file with reference to the ftyp box.

The moov box (movie box) may include metadata about the media data of the media file. The moov box can serve as a container for all pieces of metadata. The moov box may be a box at the highest level among metadata related boxes. According to an embodiment, only one moov box may be included in the media file.

The mdat box (media data box) may contain actual media data of the corresponding media file. The media data can include audio samples and/or video samples and the mdat box can serve as a container for containing such media samples.

According to an embodiment, the moov box may include an mvhd box, a trak box and/or an mvex box as lower boxes.

The mvhd box (movie header box) can include media presentation related information of media data included in the corresponding media file. That is, the mvhd box can include information such as a media generation time, change time, time standard and period of corresponding media presentation.

The trak box (track box) can provide information related to a track of corresponding media data. The trak box can include information such as stream related information about an audio track or a video track, presentation related information, and access related information. A plurality of trak boxes may be provided depending on the number of tracks.

The trak box may include a tkhd box (track header box) as a lower box according to an embodiment. The tkhd box can include information about a track indicated by the trak box. The tkhd box can include information such as a generation time, change time and track identifier of the corresponding track.

The mvex box (movie extend box) can indicate that the corresponding media file may include a moof box which will be described below. Moov boxes may need to be scanned to recognize all media samples of a specific track.

The media file according to the present invention may be divided into a plurality of fragments according to an embodiment (t18010). Accordingly, the media file can be segmented and stored or transmitted. Media data (mdat box) of the media file is divided into a plurality of fragments and each fragment can include the moof box and divided mdat boxes. According to an embodiment, information of the ftyp box and/or the moov box may be necessary to use fragments.

The moof box (movie fragment box) can provide metadata about media data of a corresponding fragment. The moof box may be a box at the highest layer among boxes related to the metadata of the corresponding fragment.

The mdat box (media data box) can include actual media data as described above. The mdat box can include media samples of media data corresponding to each fragment.

According to an embodiment, the aforementioned moof box can include an mfhd box and/or a traf box as sub-boxes.

The mfhd box (movie fragment header box) can include information related to correlation of divided fragments. The mfhd box can include a sequence number to indicate the order of the media data of the corresponding fragment. In addition, it is possible to check whether there is omitted data among divided data using the mfhd box.

The traf box (track fragment box) can include information about a corresponding track fragment. The traf box can provide metadata about a divided track fragment included in the corresponding fragment. The traf box can provide metadata for decoding/reproducing media samples in the corresponding track fragment. A plurality of traf boxes may be provided depending on the number of track fragments.

According to an embodiment, the aforementioned traf box may include a tfhd box and/or a trun box as lower boxes.

The tfhd box (track fragment header box) can include header information of the corresponding track fragment. The tfhd box can provide information such as a basic sample size, period, offset and identifier for media samples of the track fragment indicated by the aforementioned traf box.

The trun box (track fragment run box) can include information related to the corresponding track fragment. The trun box can include information such as a period, size and reproduction timing of each media sample.

The aforementioned media file and fragments of the media file can be processed into segments and transmitted. Segments may include an initialization segment and/or a media segment.

A file of an embodiment t18020 shown in the figure may be a file including information related to initialization of a media decoder except media data. This file can correspond to the aforementioned initialization segment. The initialization segment can include the aforementioned ftyp box and/or the moov box.

The file of an embodiment t18030 shown in the figure may be a file including the aforementioned fragments. For example, this file can correspond to the aforementioned media segment. The media segment can include the aforementioned moof box and/or mdat box. In addition, the media segment can further include an styp box and/or an sidx box.

The styp box (segment type box) can provide information for identifying media data of a divided fragment. The styp box can perform the same role as the aforementioned ftyp box for a divided fragment. According to an embodiment, the styp box can have the same format as the ftyp box.

The sidx box (segment index box) can provide information indicating an index for a divided fragment. Accordingly, the sidx box can indicate the order of the divided fragment.

An ssix box may be further provided according to an embodiment t18040. The ssix box (sub-segment index box) can provide information indicating indexes of sub-segments when a segment is divided into the sub-segments.

Boxes in a media file may further include extended information on the basis of a box as shown in an embodiment t18050 or a full box. In this embodiment, a size field and a largesize field can indicate the length of a corresponding box in bytes. A version field can indicate the version of a corresponding box format. A type field can indicate the type or identifier of the corresponding box. A flags field can indicate flags related to the corresponding box.

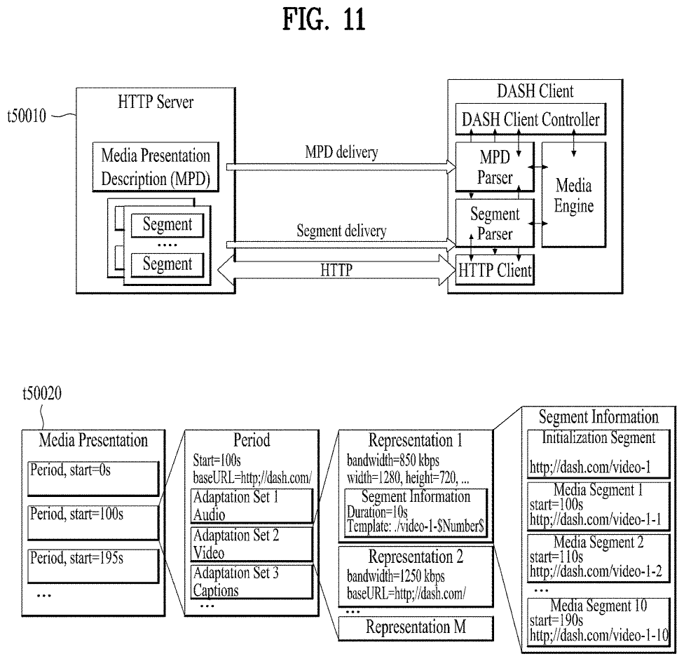

FIG. 11 illustrates overall operation of a DASH based adaptive streaming model according to an embodiment of the present invention.

A DASH based adaptive streaming model according to an embodiment t50010 shown in the figure describes operations between an HTTP server and a DASH client. Here, DASH (dynamic adaptive streaming over HTTP) is a protocol for supporting HTTP based adaptive streaming and can dynamically support streaming depending on network state. Accordingly, reproduction of AV content can be seamlessly provided.

First, the DASH client can acquire an MPD. The MPD can be delivered from a service provider such as the HTTP server. The DASH client can request segments described in the MPD from the server using information for accessing the segments. The request can be performed based on a network state.

The DASH client can acquire the segments, process the segments in a media engine and display the processed segments on a screen. The DASH client can request and acquire necessary segments by reflecting a presentation time and/or a network state in real time (adaptive streaming). Accordingly, content can be seamlessly presented.

The MPD (media presentation description) is a file including detained information used for the DASH client to dynamically acquire segments and can be represented in XML.

A DASH client controller can generate a command for requesting the MPD and/or segments on the basis of a network state. In addition, the DASH client controller can control an internal block such as the media engine to use acquired information.

An MPD parser can parse the acquired MPD in real time. Accordingly, the DASH client controller can generate a command for acquiring necessary segments.

A segment parser can parse acquired segments in real time. Internal blocks such as the media engine can perform a specific operation according to information included in the segment.

An HTTP client can request a necessary MPD and/or segments from the HTTP server. In addition, the HTTP client can deliver the MPD and/or segments acquired from the server to the MPD parser or the segment parser.

The media engine can display content on the screen using media data included in segments. Here, information of the MPD can be used.

A DASH data model may have a hierarchical structure t50020. Media presentation can be described by the MPD. The MPD can describe a time sequence of a plurality of periods which forms media presentation. A period indicates one section of media content.

In one period, data can be included in adaptation sets. An adaptation set may be a set of media content components which can be exchanged. Adaptation can include a set of representations. A representation can correspond to a media content component. In one representation, content can be temporally divided into a plurality of segments for appropriate accessibility and delivery. To access each segment, the URL of each segment may be provided.

The MPD can provide information related to media presentation and a period element, an adaptation set element and a representation element can describe a corresponding period, adaptation set and representation. A representation can be divided into sub-representations, and a sub-representation element can describe a corresponding sub-representation.

Here, common attribute/elements can be defined. The common attributes/elements can be applied to (included in) sub-representations. The common attributes/elements may include EssentialProperty and/or SupplementalProperty.

The essential property may be information including elements regarded as mandatory elements in processing of corresponding media presentation related data. The supplemental property may be information including elements which may be used to process corresponding media presentation related data. In an embodiment, descriptors which will be described below may be defined in the essential property and/or the supplemental property and delivered through an MPD.

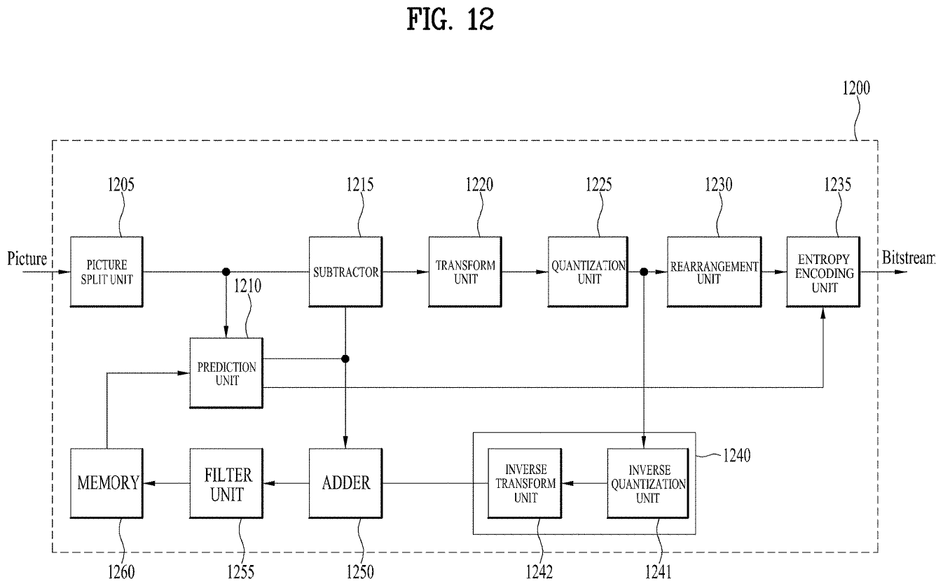

FIG. 12 is a diagram exemplarily illustrating the configuration of a data encoder according to the present invention. The data encoder according to the present invention may perform various encoding schemes including a video/image encoding scheme according to a high efficiency video codec (HEVC).

Referring to FIG. 12, a data decoder 700 may include a picture split unit 705, a prediction unit 710, a subtractor 715, a transform unit 720, a quantization unit 725, a rearrangement unit 730, an entropy encoding unit 735, a residual processing unit 740, an adder 750, a filter unit 755, and a memory 760. The residual processing unit 740 may include an inverse quantization unit 741 and an inverse transform unit 742.

The picture split unit 705 may split an input image into at least one processing unit. A unit represents a basic unit of image processing. A unit may include at least one of a specific region in a picture and information related to the region. The term unit and terms such as block or area may be interchangeably used in some cases. In general, an M×N block may represent a set of samples or transform coefficients arranged in M columns and N rows.

As one example, the processing unit may be referred to as a coding unit (CU). In this case, the CU may be recursively split from the largest coding unit (LCU) according to a quad-tree binary-tree (QTBT) structure. For example, one coding unit may be split into a plurality of coding units of a deeper depth based on a quad-tree structure and/or a binary-tree structure. In this case, for example, the quad-tree structure may be applied first and then the binary tree structure may be applied. Alternatively, the binary-tree structure may be applied first. The coding procedure according to the present invention may be carried out based on the final coding unit which is not further divided. In this case, the LCU may be directly used as a final coding unit based on the coding efficiency or the like depending on the image characteristics. Alternatively, the coding unit may be recursively split into deeper-depth CUs, and a CU having an optimum size may be used as a final CU. Here, the coding procedure may include procedures such as prediction, transformation, and restoration, which will be described later.

As another example, the processing unit may include a coding unit (CU), a prediction unit (PU), or a transform unit (TU). For the CU, the largest coding unit (LCU) may be split into coding units of deeper depth along a quad-tree structure. In this case, the LCU may be directly used as a final coding unit based on the coding efficiency or the like depending on the image characteristics. Alternatively, the coding unit may be recursively split into deeper-depth CUs, and a CU having an optimum size may be used as a final CU. When a smallest coding unit (SCU) is set, a CU cannot be split into CUs smaller than the SCU. Herein, the term “final CU” means a CU forming the basis of partition or split into a PU or a TU. A PU is a unit that is partitioned from a CU, and may be a unit of sample prediction. Here, the PU may be divided into sub-blocks. A TU may be split from a CU along the quad-tree structure, and may be a unit for deriving a transform coefficient and/or a unit for deriving a residual signal from the transform coefficient. Hereinafter, the CU may be referred to as a coding block (CB), the PU may be referred to as a prediction block (PB), and the TU may be referred to as a transform block (TB). The PB or PU may refer to a specific area in the form of a block in a picture and may include an array of predicted samples. The TB or TU may refer to a specific area in the form of a block in a picture, and may include an array of transform coefficients or residual samples.

The prediction unit 710 may predict a block to be processed (hereinafter, referred to as a current block), and may generate a predicted block including predicted samples for the current block. A unit in which prediction is performed by the prediction unit 710 may be a CB, a TB, or a PB.

The prediction unit 710 may determine whether intra prediction or inter prediction is applied to the current block. In an example, the prediction unit 710 may determine whether intra prediction or inter prediction is applied on a CU-by-CU basis.

In the intra prediction, the prediction unit 710 may derive a predicted sample for a current block based on a reference sample outside the current block in a picture to which the current block belongs (hereinafter referred to as a current picture). In this operation, the prediction unit 710 may (i) derive the predicted sample based on an average or interpolation of neighboring reference samples of the current block or (ii) derive the predicted sample based on a reference sample existing in a specific (prediction) direction with respect to the predicted sample among the samples. Case (i) may be referred to as a non-directional mode or a non-angular mode, and case (ii) may be referred to as a directional mode or an angular mode. In the intra prediction, prediction modes may include, for example, 33 or more directional prediction modes and two or more non-directional modes. The non-directional modes may include a DC prediction mode and a planar mode. The prediction unit 710 may determine a prediction mode applied to the current block, using the prediction mode applied to the neighboring block.

In the inter prediction, the prediction unit 710 may derive a predicted sample for the current block based on a sample specified by a motion vector on a reference picture. The prediction unit 710 may derive the predicted sample for the current block by applying one of a skip mode, a merge mode, and a motion vector prediction (MVP) mode. In the skip mode and the merge mode, the prediction unit 710 may use motion information about a neighboring block as motion information about a current block. In the skip mode, unlike the merge mode, a difference (residual) between the predicted sample and the original sample is not transmitted. In the MVP mode, a motion vector of the current block may be derived using the motion vector of the neighboring block as a motion vector predictor of the current block.

In the inter prediction, neighboring blocks may include a spatial neighboring block existing in a current picture and a temporal neighboring block existing in a reference picture. The reference picture including the temporal neighboring block may be referred to as a collocated picture (colPic). The motion information may include a motion vector and a reference picture index. Information such as the prediction mode information and the motion information may be (entropy) encoded and output in the form of a bitstream.

When the motion information about the temporal neighboring blocks is used in the skip mode and the merge mode, the highest picture in a reference picture list may be used as a reference picture. The reference pictures included in the reference picture list may be sorted on the basis of a picture order count (POC) difference between the current picture and the corresponding reference picture. The POC may correspond to display order of the pictures and may be distinguished from coding order.

The subtractor 715 generates a residual sample, which is a difference between the original sample and the predicted sample. When the skip mode is applied, the residual sample may not be generated in contrast with the case described above.

The transform unit 720 transforms residual sample on a TB-by-TB basis to generate transform coefficients. The transform unit 720 may perform the transform according to the size of the TB and the prediction mode applied to the CB or PB spatially overlapping the TB. For example, if intra prediction is applied to the CB or the PB that overlaps the TB and the TB is a 4×4 residual array, the residual sample may be transformed using a discrete sine transform (DST) kernel. Otherwise, the residual sample may be transformed using a discrete cosine transform (DCT) kernel.

The quantization unit 725 may quantize transform coefficients to generate quantized transform coefficients.

The rearrangement unit 730 rearranges the quantized transform coefficients. The rearrangement unit 130 may rearrange the quantized transform coefficients, which take the form of a block, into a one-dimensional vector form using a scanning technique. Although the rearrangement unit 130 has been described as a separate element, the rearrangement unit 730 may be a part of the quantization unit 725.

The entropy encoding unit 735 may perform entropy encoding on the quantized transform coefficients. Entropy encoding may include an encoding technique such as, for example, exponential Golomb, context-adaptive variable length coding (CAVLC), or context-adaptive binary arithmetic coding (CABAC). In addition the entropy encoding unit 735 may encode information necessary for video reconstruction (e.g., a value of a syntax element, etc.) together with separately from the quantized transform coefficients. The entropy-encoded information may be transmitted or stored in the form of bitstreams on a network abstraction layer (NAL) unit basis.

The inverse quantization unit 741 inversely quantizes the quantized values (quantized transform coefficients) from the quantization unit 725 and the inverse transform unit 742 inversely transforms the inversely quantized values from the inverse quantization unit 741 to generate a residual sample.

The adder 750 reconstructs the picture by adding the residual sample and the predicted sample. A reconstruction block may be generated by adding the residual sample and the predicted sample on a block-by-block basis. Here, while the adder 750 has been described as a separate element, the adder 750 may be a part of the prediction unit 710. The addition unit 750 may be referred to as a reconstruction unit or a reconstruction block generation unit.

The filter unit 755 may apply a deblocking filter and/or a sample adaptive offset to the reconstructed picture. Through deblocking filtering and/or the sample adaptive offset, artifacts on the block boundary in the reconstructed picture or distortion occurring in the quantization operation may be corrected. The sample adaptive offset may be applied on a sample-by-sample basis and may be applied after the operation of deblocking filtering is complete. The filter unit 755 may apply an adaptive loop filter (ALF) to the reconstructed picture. The ALF may be applied to the reconstructed picture after the deblocking filter and/or sample adaptive offset is applied.

The memory 760 may store the reconstructed picture (decoded picture) or information necessary for encoding/decoding. Here, the reconstructed picture may be a reconstructed picture for which the filtering procedure has been completed by the filter unit 755. The stored reconstructed picture may be used as a reference picture for (inter) prediction of other pictures. For example, the memory 760 may store (reference) pictures to be used for inter prediction. Here, the pictures to be used for inter prediction may be designated by a reference picture set or a reference picture list.

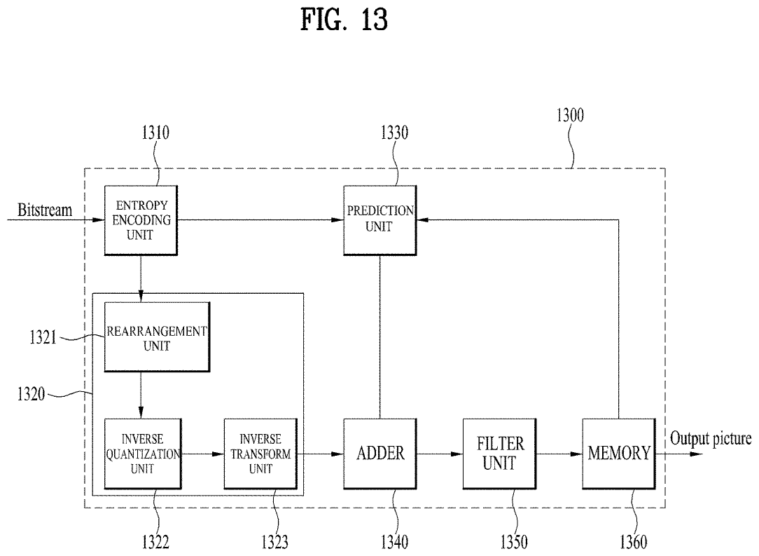

FIG. 13 is a diagram exemplarily illustrating the configuration of a data decoder according to the present invention.

Referring to FIG. 13, a data decoder 800 may include an entropy decoding unit 810, a residual processing unit 820, a prediction unit 830, an adder 840, a filter unit 850, and a memory 860. Here, the residual processing unit 820 may include a rearrangement unit 821, an inverse quantization unit 822, and an inverse transform unit 823.

When a bitstream including video information is input, the video decoder 800 may reconstruct the video in response to the process in which the video information is processed by the video encoder.

For example, the video decoder 800 may perform video decoding using a processing unit applied by the video encoder. Thus, the processing unit block of video decoding may be, for example, a CU. In another example, the processing unit block may be a PU or a TU. The CU may be split from the LCU along a quad-tree structure and/or a binary-tree structure.

A PU and a TU may be further used. In this case, the PU may be a block derived or partitioned from the CU and may be a unit of sample prediction. Here, the PU may be divided into subblocks. The TU may be split from the CU along the quad-tree structure and may be a unit for deriving a transform coefficient or a unit for deriving a residual signal from the transform coefficient.

The entropy decoding unit 810 may parse the bitstream and output information necessary for video reconstruction or picture reconstruction. For example, the entropy decoding unit 810 may decode the information in the bitstream based on a coding technique such as exponential Golomb, CAVLC, or CABAC, and calculate a value of a syntax element necessary for video reconstruction, a quantized value of a transform coefficient for the residual.

More specifically, according to the CABAC entropy decoding method may include receiving a bin corresponding to each syntax element in the bitstream, determining a context model using context element information to be decoded and decoding information about the block to be decoded and neighboring blocks or using information about the symbol/bin decoded in a previous step, predicting an occurrence probability of a bin according to the determined context model and generating a symbol corresponding to the value of each syntax element through arithmetic decoding of the bin. Here, the CABAC entropy decoding method may update the context model using the information about the decoded symbol/bin for a context model of the next symbol/bin after determining the context model.

In the information decoded by the entropy decoding unit 810, information about prediction may be provided to the prediction unit 830. The residual values obtained through the entropy decoding in the entropy decoding unit 810, i.e., the quantized transform coefficients, may be input to the rearrangement unit 821.

The rearrangement unit 821 may rearrange the quantized transform coefficients in the form of a two-dimensional block. The rearrangement unit 821 may perform rearrangement in response to the coefficient scanning performed by the encoder. While the rearrangement unit 821 has been described as a separate element, the rearrangement unit 821 may be a part of the inverse quantization unit 822.

The inverse quantization unit 822 may inversely quantize the quantized transform coefficients based on the (inverse) quantization parameter, and output transform coefficients. Here, information for deriving the quantization parameter may be signaled from the encoder.

The inverse transform unit 823 may inversely transform the transform coefficients to derive residual samples.

The prediction unit 830 may predict a current block and generate a predicted block including predicted samples for the current block. The unit forming the basis of prediction performed in the prediction unit 830 may be a CB, a TB, or a PB.

The prediction unit 830 may determine whether to apply intra prediction or inter prediction based on the information about the prediction. Here, a unit forming the basis of determining whether to apply intra prediction or inter prediction may differ from a unit for generating a predicted sample. In addition, a unit for generating a predicted sample in inter prediction may differ from a unit for generating a predicted sample in intra prediction. For example, whether to apply inter prediction or intra prediction may be determined on a CU-by-CU basis. In addition, for example, in inter prediction, a prediction mode may be determined on a PU-by-PU basis to generate predicted samples. In intra prediction, a prediction mode may be determined on a PU-by-PU basis, predicted samples may be generated on a TU-by-TU basis.

In the case of intra prediction, the prediction unit 830 may derive predicted samples for the current block based on a neighboring reference sample in the current picture. The prediction unit 830 may derive predicted samples for the current block by applying the directional mode or the non-directional mode based on the neighboring reference sample of the current block. In this case, a prediction mode to be applied to the current block may be determined using the intra prediction mode of the neighboring block.

In the inter prediction, the prediction unit 830 may derive a predicted sample for the current block based on a sample specified in the reference picture by a motion vector in the reference picture. The prediction unit 830 may derive the predicted sample for the current block by applying one of the skip mode, the merge mode, and the MVP mode. In this case, motion information necessary for inter prediction of the current block provided by the video encoder, for example, information about a motion vector, a reference picture index, and the like may be acquired or derived based on the information about the prediction.

In the skip mode and the merge mode, motion information about a neighboring block may be used as motion information about the current block. Here, the neighboring block may include a spatial neighboring block and a temporal neighboring block.

The prediction unit 830 may configure a merge candidate list using the motion information about available neighboring blocks and use information indicated by the merge index in the merge candidate list as the motion vector of the current block. The merge index may be signaled from the encoder. The motion information may include a motion vector and a reference picture. When motion information about the temporal neighboring block is used in the skip mode and the merge mode, the top-level picture in the reference picture list may be used as the reference picture.

In the skip mode, unlike the merge mode, the difference (residual) between the predicted sample and the original sample is not transmitted.

In the MVP mode, a motion vector of the current block may be derived using the motion vector of the neighboring block as a motion vector predictor. Here, the neighboring block may include a spatial neighboring block and a temporal neighboring block.

As an example, when the merge mode is applied, a merge candidate list may be generated using a motion vector of the reconstructed spatial neighboring block and/or a motion vector corresponding to a Col block that is a temporal neighboring block. In the merge mode, the motion vector of a candidate block selected in the merge candidate list is used as the motion vector of the current block. The information about prediction may include a merge index indicating a candidate block having the optimum motion vector selected from among the candidate blocks included in the merge candidate list. In this case, the prediction unit 830 may derive the motion vector of the current block using the merge index.

As another example, when the motion vector prediction mode (MVP) is applied, a motion vector predictor candidate list may be generated using a motion vector of the reconstructed spatial neighboring block and/or a motion vector corresponding to a Col block that is a temporal neighboring block. That is, the motion vector of the reconstructed spatial neighboring block and/or the motion vector corresponding to the Col block which is the temporal neighboring block may be used as a motion vector candidate. The information on the prediction may include a prediction motion vector index indicating the optimum motion vector selected from among the motion vector candidates included in the list. In this case, the prediction unit 830 may use the motion vector index to select a prediction motion vector of the current block from among the motion vector candidates included in the motion vector candidate list. The prediction unit of the encoder may obtain the motion vector difference (MVD) between the motion vector of the current block and the motion vector predictor, and output the same in the form of a bitstream through encoding. That is, the MVD may be obtained by subtracting the motion vector predictor from the motion vector of the current block. The prediction unit 830 may acquire the MVD included in the information about the prediction and derive the motion vector of the current block by adding the MVD and the motion vector predictor. The prediction unit may also acquire or derive a reference picture index or the like indicating the reference picture from the information about the prediction.

The adder 840 may reconstruct the current block or the current picture by adding the residual sample and the predicted sample. The adder 840 may reconstruct the current picture by adding the residual sample and the predicted sample on a block-by-block basis. When the skip mode is applied, the residual is not transmitted, and thus the predicted sample may be the reconstructed sample. Here, while the adder 840 has been described as a separate element, the adder 840 may be a part of the prediction unit 830. The adder 840 may be referred to as a reconstruction unit or a reconstruction block generation unit.

The filter unit 850 may apply deblocking filtering a sample adaptive offset, and/or an ALF to the reconstructed picture. In this case, the sample adaptive offset may be applied on a sample-by-sample basis and may be applied after deblocking filtering. The ALF may be applied after deblocking filtering and/or the sample adaptive offset.

The memory 860 may store the reconstructed picture (decoded picture) or information necessary for decoding. Here, the reconstructed picture may be a reconstructed picture for which the filtering procedure has been completed by the filter unit 850. For example, the memory 860 may store pictures to be used for inter prediction. Here, the pictures to be used for inter prediction may be designated by a reference picture set or a reference picture list. The reconstructed picture may be used as a reference picture for other pictures. In addition, the memory 860 may output reconstructed pictures in an output order.

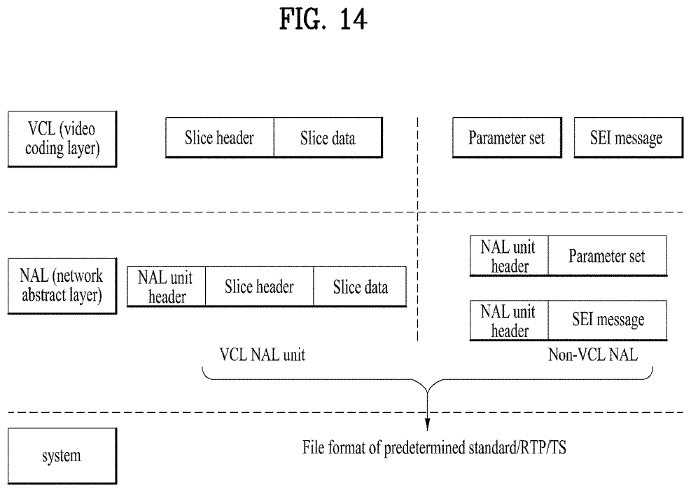

FIG. 14 exemplarily shows a hierarchical structure of coded data.

Referring to FIG. 14, coded data may be divided into a video coding layer (VCL) that performs coding processing of a video/image and handles the video/image and a network abstraction layer (NAL) positioned between the VCL and a system that is at a lower level and configured to store and transmit the coded video/image.

The NAL unit, which is a basic unit of the NAL, serves to map the coded image to a file format according to a predetermined standard, a real-time transport protocol (RTP), and a bitstream of the lower-level system such as a transport stream (TS)

In the VCL, parameter sets (a picture parameter set, a sequence parameter set, a video parameter set, etc.) corresponding to a header such as a sequence and a picture, and a supplemental enhancement information (SEI) message that is supplementarily needed in a related procedure such as display in the operation of coding the video/image are separated from information (slice data) about the video/image. The VCL, which contains information about the video/image, consists of slice data and a slice header.

As shown in the figure, the NAL unit consists of two parts: a NAL unit header and a Raw Byte Sequence Payload (RBSP) generated by the VCL. The NAL unit header contains information about the type of the corresponding NAL unit.

The NAL units are divided into a VCL NAL unit and a non-VCL NAL unit according to the RBSP generated in the VCL. The VCL NAL unit refers to a NAL unit that contains information about a video/image, and a non-VCL NAL unit represents a NAL unit that contains information (parameter sets or SEI message) necessary for coding the video/image. The VCL NAL unit may be divided into several types depending on the characteristics and type of a picture included in the corresponding NAL unit.

The present invention may relate to a method for transmitting 360-degree video and a method for receiving 360-degree video. The method for transmitting/receiving 360-degree video according to the present invention may be carried out by the above-described 360-degree video transmission/reception apparatus according to the present invention or embodiments of the apparatus.

Respective embodiments of the above-described 360-degree video transmission/reception apparatus and the 360-degree video transmission/reception method, and the inner/outer elements thereof may be combined with each other. For example, embodiments of the projection processor and embodiments of the data encoder may be combined with each other to produce a corresponding number of embodiments of the 360-degree video transmission apparatus. Such combined embodiments are also within in the scope of the present invention.

According to the present invention, region-based independent processing may be supported to ensure user viewpoint-based efficient processing. For this purpose, an independent bitstream may be configured by extracting and/or processing a specific region of an image, and a file format for the specific region extraction and/or processing may be configured. In this case, efficient decoding and rendering of an image region at the reception end may be supported by signaling the original coordinate information about the extracted region. Hereinafter, a region where independent processing of the input image is supported may be referred to as a sub-picture. The input image may be split into sub-picture sequences prior to encoding, and each of the sub-picture sequences may cover a subset of the spatial area of the 360-degree video content. Each sub-picture sequence may be independently encoded and output as a single-layer bitstream. Each sub-picture bitstream may be encapsulated in a file on a track basis and streamed. In this case, the reception apparatus may decode and render tracks covering the entire region, or may select and decode and render a track related to a specific sub-picture based on metadata related to the orientation and the viewport.

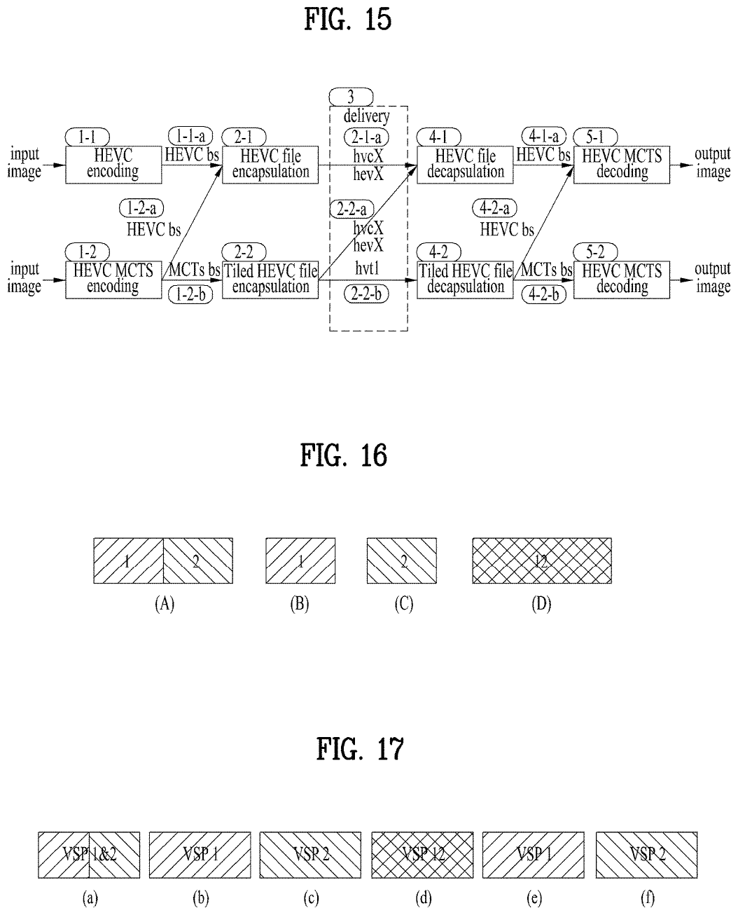

FIG. 15 exemplarily shows a motion constraint tile set (MCTS) extraction and delivery process as an example of region-based independent processing.

Referring to FIG. 15, a transmission apparatus encodes an input image. Herein, the input image may correspond to the projected picture or the packed picture described above.

As an example, the transmission apparatus may encode an input image according to a typical HEVC encoding procedure (1-1). In this case, the input image may be encoded and output as one HEVC bitstream (HEVC bs) (1-1-a).

As another example, an input image may be subjected to region-based independent encoding (HEVC MCTS encoding) (1-2). Thereby, an MCTS stream for a plurality of regions may be output (1-2-b). Alternatively, some regions may be extracted from the MCTS stream and output as a single HEVC bitstream (1-2-a). In this case, complete information for decoding and reconstructing the some regions may be included in the bitstream, and accordingly the reception end may completely reconstruct the some region based on one bitstream for the some regions. The MCTS stream may be referred to as an MCTS bitstream.

The transmission apparatus may encapsulate the encoded HEVC bitstream according to (1-1-a) or (1-2-a) into one track in the file for storage and transmission (2-1) and transmit the same to the reception apparatus. In this case, the track may be represented by an identifier such as hvcX, hevX, or the like.

The transmission apparatus may encapsulate the encoded MCTS stream according to (1-2-b) in a file for storage and transmission (2-2). As an example, the transmission apparatus may deliver MCTSs for independent processing by encapsulating the MCTSs into separate tracks (2-2-b). In this operation, information about a base track for processing the entire MCTS stream or an extractor track for extracting and processing some MCTS regions may also be included in the file. In this case, the separate tracks may be represented by identifiers such as hvcX, hevX, and the like. As another example, the transmission apparatus may encapsulate and deliver a file including a track for one MCTS region, using an extractor track (2-2-a). That is, the transmission apparatus may extract and deliver only a track corresponding to one MCTS. In this case, the track may be represented by an identifier such as, for example, hvt1.

The reception apparatus may receive the file according to (2-1-a) or (2-2-a), carry out a decapsulation procedure (4-1), and derive the HEVC bitstream (4-1-a). In this case, the reception apparatus may derive one bitstream by decapsulating one track in the received file.

The reception apparatus may receive the file according to (2-2-b), carry out the decapsulation procedure (4-2), and derive an MCTS stream or one HEVC bitstream. As an example, if tracks of MCTSs corresponding to all regions and a base track are included in the file, the reception apparatus may extract the entire MCTS streams (4-2-b). As another example, if the extractor track is included in the file, the reception apparatus may extract a corresponding MCTS track and then decapsulate the same to generate one HEVC bitstream (4-2-a).

The reception apparatus may generate an output image by decoding one bitstream according to (4-1-a) or (4-2-a) (5-1). Here, when one bitstream according to (4-2-a) is decoded, the image may be an output image for a part of MCTS regions of the output image. Alternatively, the reception apparatus may decode the MCTS stream according to (4-2-b) to generate an output image (5-2).

FIG. 16 shows an example of an image frame for supporting region-based independent processing. The region that supports independent processing as described above may be referred to as a sub-picture.

Referring to FIG. 16, one input image may consist of two region, left and right MCTS regions. The shape of an image frame encoded/decoded through the procedures 1-2 to 5-2 described above in FIG. 15 may be the same as or (A) to (D) of FIG. 16 or correspond to a part thereof.

In FIG. 16, (A) shows an image frame in which both regions 1 and 2 are present and the individual regions can be processed independently/in parallel. (B) shows an independent image frame having only region 1 and a half horizontal resolution. (C) shows an independent image frame having only region 2 and a half horizontal resolution. (D) shows an image frame in which both regions 1 and 2 are present, and which can be processed without supporting independent/parallel processing of the individual regions.

The bitstream configuration according to 1-2-b and 4-2-b for deriving an image frame as described above may correspond to the following or a part thereof.

FIG. 17 shows an example of a bitstream configuration for supporting region-based independent processing.

Referring to FIG. 17, VSP represents VPS, SPS, and PPS, VSP1 represents the VSP for region 1, VSP2 represents the VSP for region 2, and VSP12 represents the VSP for both regions 1 and 2. VCL1 represents the VCL for region 1, and VCL2 represents the VCL for region 2.

In FIG. 17, (a) represents non-VCL NAL units (e.g., a VPS NAL unit, a SPS NAL unit, a PPS NAL unit, etc.) for image frames in which independent/parallel processing of regions 1 and 2 can be performed. (b) represents non-VCL NAL units (e.g., a VPS NAL unit, a SPS NAL unit, a PPS NAL unit, etc.) for image frames having only region 1 and a half resolution. (c) represents non-VCL NAL units (e.g., a VPS NAL unit, a SPS NAL unit, a PPS NAL unit, etc.) for image frames having only region 2 and a half resolution. (d) represents non-VCL NAL units (e.g., a VPS NAL unit, a SPS NAL unit, a PPS NAL unit, etc.) for image frames in which both regions 1 and 2 are present and which can be processed without supporting independent/parallel processing of the individual regions. (e) represents VCL NAL units of region 1. (f) represents VCL NAL units of region 2.

For example, in order to generate an image frame of (A), a bitstream including the NAL units of (a), (e), and (f) may be generated. In order to generate an image frame of (B), a bitstream including the NAL units of (b) and (e) may be generated. In order to generate an image frame of (C), a bitstream including the NAL units of (c) and (f) may be generated. In order to generate an image frame of (D), a bitstream including the NAL units of (d), (e), and (f) may be generated. In this case, information (e.g., mcts_sub_bitstream_region_in_original_picture_coordinate_info( ), which will be described later) indicating the position of a specific region in the picture may be transmitted in the bitstream for the image frame such as (B), (C), or (D). In this case, the information may enable identification of the information about the position of the selected region in the original frame.

If the selected region is not positioned at the top left end, which is the origin of the original image frame, as in the case where only region 2 is selected (the bitstream includes NAL units of (c), (f)), a process of modifying the slice segment address in the slice segment header during the bitstream extraction may be involved.

FIG. 18 exemplarily shows a track configuration of a file according to the present invention. In the case of optionally encapsulating or coding a specific region as in 2-2-a or 4-2-a illustrated in FIG. 15, the related file configuration may have the following cases or correspond to a part thereof.

Referring to FIG. 18, when a specific region is optionally encapsulated or coded as shown in 2-2-a or 4-2-a in FIG. 15, the related file configuration may include the following cases or correspond to a part thereof:

(1) one track 10 includes the NAL units of (b) or (e);

(2) one track 20 includes the NAL units of (c) or (f);

(3) one track 30 includes NAL units of (d), (e), or (f).

In addition, the related file configuration may include all or some of the following tracks:

(4) a base track 40 including (a);

(5) an extractor track 50 including (d) and having an extractor (e.g., ext1, ext2) for accessing (e) and (f);

(6) an extractor track 60 including (e) and having an extractor for accessing (e);

(7) an extractor track 70 including (c) and having an extractor for accessing (f);

(8) a tile track 80 including (e);

(9) a tile track 90 including (f).

In this case, the information indicating the position of the specific region in the picture may be included in the above-described tracks 10, 20, 30, 50, 60, 70, etc. in the form of a box such as RegionOriginalCoordinateBox, thereby enabling identification of the position information about the selsected region in the original frame. Here, the region may be referred to as a sub-picture as described above. The service provider may configure all the above-mentioned tracks, and select and combine only a part thereof so as to be delivered in the transmission operation.

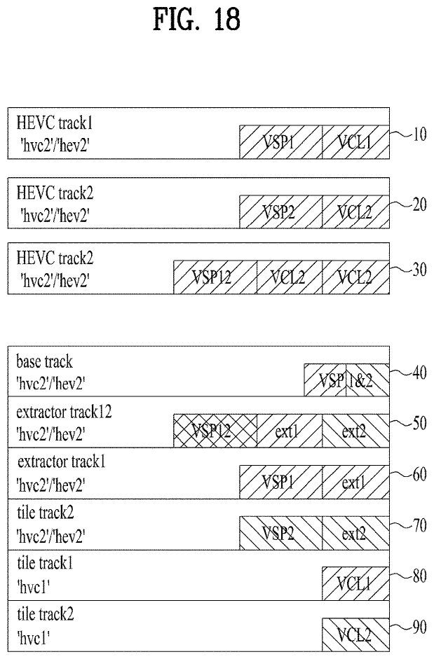

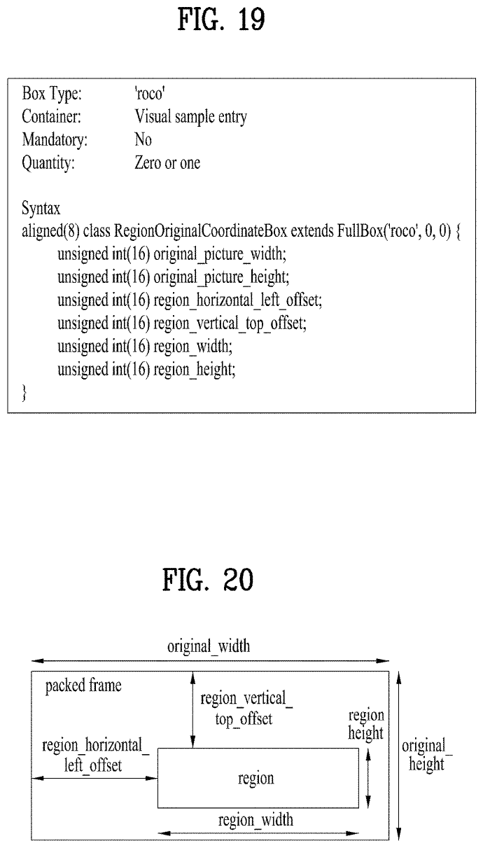

FIG. 19 shows RegionOriginalCoordinateBox according to an example of the present invention. FIG. 20 exemplarily shows a region indicated by corresponding information in an original picture.

Referring to FIG. 19, RegionOriginalCoordninateBox is information indicating the size and/or position of a region (sub-picture, or MCTS) for which region-based independent processing according to the present invention can be performed. Specifically, when one visual content is split into one or more regions and stored/transmitted, RegionOriginalCoordinateBox may be used to identify the position of a corresponding region on the coordinates of the entire visual content. For example, a packed frame (a packed picture) or a projected frame (a projected picture) for an entire 360-degree video may be stored/transmitted in the form of independent video streams as several individual regions to ensure user viewpoint-based efficient processing, and one track may correspond to a rectangular region consisting of one tile or multiple tiles. The individual regions may correspond to HEVC bitstreams extracted from the HEVC MCTS bitstream. RegionOriginalCoordninateBox may be present below a visual sample entry of the track through which an individual region is stored/transmitted and describe the coordinate information about the region. RegionOriginalCoordninateBox may be hierarchically present below another box, such as a scheme information box, in addition to the visual sample entry.

The syntax of RegionOriginalCoordinateBox may include an original_picture_width field, an original_picture_height field, a region_horizontal_left_offset field, a region_vertical_top_offset field, a region_width field, and a region_height field. Some of the fields may be omitted. For example, in the case where the size of the original picture is predefined or already acquired through information of another box or the like, the original_picture_width field, the original_picture_height field, and the like may be omitted.

The original_picture_width field indicates the horizontal resolution (width) of the original picture (i.e., the packed frame or the projected frame) to which the corresponding region (sub-picture or tile) belongs. The original_picture_height field indicates the vertical resolution (height) of the original picture (i.e., the packed frame or the projected frame) to which the corresponding region (sub-picture or tile) belongs. The region_horizontal_left_offset field indicates the abscissa of the left end of the corresponding region with respect to the original picture coordinates. For example, the field may indicate the value of the abscissa of the left end of the region with respect to the coordinates of the top left end of the original picture. The region_vertical_top_offset field indicates the ordinate of the left end of the region with respect to the original picture coordinates. For example, the field may indicate the value of the ordinate of the upper end of the region with respect to the coordinates of the top left end of the original picture. The region_width field indicates the horizontal resolution (width) of the region. The region_height field indicates the vertical resolution (height) of the region. Based on the above-described fields, the corresponding region may be derived from the original picture as shown in FIG. 20.

According to an embodiment of the present invention, RegionToTrackBox may be used.

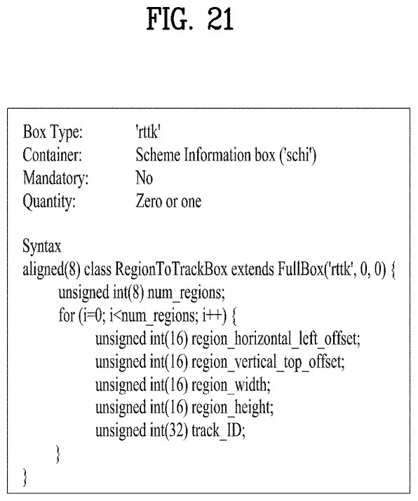

FIG. 21 shows RegionToTrackBox according to an embodiment of the present invention.

RegionToTrackBox may identify a track associated with a corresponding region. The box (box-type information) may be sent in every track or only in a representative track. RegionToTrackBox may be stored under the ‘schi’ box along with 360-degree video information such as projection and packing information. In this case, the horizontal resolution and the vertical resolution of the original picture may be identified by the width or width value (of the original picture) existing in the track header box or the visual sample entry. In addition, the reference relationship between the track carrying the box and the track in which an individual region is stored/transmitted may be identified by a new reference type such as ‘ovrf’ (omnidirectional video reference) in the track reference box.

The box may exist hierarchically below other boxes, such as a visual sample entry, outside the Scheme Information box.

The syntax of RegionToTrackBox may include a num regions field, and may include a region_horizontal_left_offset field, a region_vertical_top_offset field, a region_width field, a region_width field, and a track_ID field for each region. In some cases, some of the fields may be omitted.

The num_region field indicates the number of regions in the original picture. The region_horizontal_left_offset field indicates the abscissa of the left end of a corresponding region with respect to the original picture coordinates. For example, the field may indicate the value of the abscissa of the left end of the corresponding region with respect to the coordinates of the top left end of the original picture. The region_vertical_top_offset field indicates the ordinate of the left end of the corresponding region with respect to the original picture coordinates. For example, the field may indicate the value of the ordinate of the upper end of the corresponding region with respect to the coordinates of the top left end of the original picture. The region_width field indicates the horizontal resolution (width) of the region. The region_height field indicates the vertical resolution (height) of the region. The Track_ID field indicates an ID of a track in which data corresponding to the region is stored/transmitted.

According to an embodiment of the present invention, the following information may be included in an SEI message.

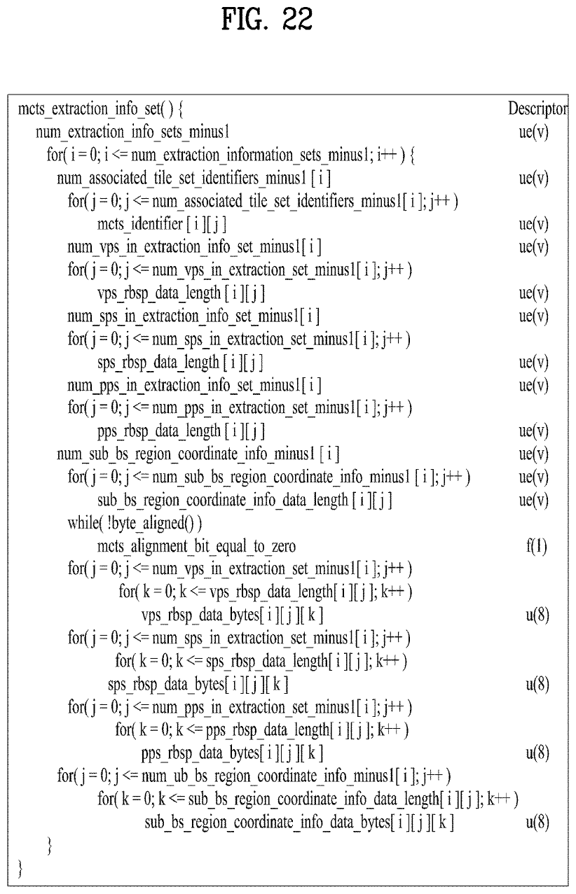

FIG. 22 shows an SEI message according to an embodiment of the present invention.

Referring to FIG. 22, the num_sub_bs_region_coordinate_info_minus1[i] field indicates a value of the number of mcts_sub_bitstream_region_in_original_picture_coordinate_info corresponding to the extracted information−1. The sub_bs_region_coordinate_info_data_length[i][j] field indicates the number of bytes of the included individual mcts_sub_bitstream_region_in_original_picture_coordinate_info. The num_sub_bs_region_coordinate_info_minus1[i] field and the sub_bs_region_coordinate_info_data_length[i][j] field may be coded based on ue(v) representing unsigned integer 0-th Exp-Golomb coding. Here, (v) may indicate that the bits used to code the information are variable. The sub_bs_region_coordinate_info_data_bytes[i][j][k] field indicates the bytes of the included individual mcts_sub_bitstream_region_in_original_picture_coordinate_info. The sub_bs_region_coordinate_info_data_bytes[i][j][k] field may be coded based on u(8) indicating an unsigned integer 0-th coding using 8 bits.

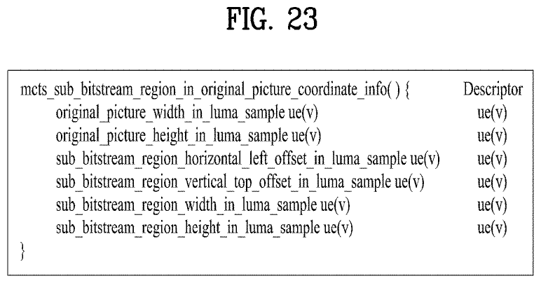

FIG. 23 shows mcts_sub_bitstream_region_in_original_picture_coordinate_info according to an embodiment of the present invention. mcts_sub_bitstream_region_in_original_picture_coordinate_info may be hierarchically included in the SEI message.

Referring to FIG. 23, the original_picture_width_in_luma_sample field indicates the horizontal resolution of the original picture (i.e., the packed frame or the projected frame) before extraction of the extracted MCTS sub-bitstream region. The original_picture_height in luma sample field indicates the vertical resolution of the original picture (i.e., the packed frame or the projected frame) before extraction of the extracted MCTS sub-bitstream region. The sub_bitstream_region_horizontal_left_offset_in_luma_sample field indicates the abscissa of the left end of the corresponding region with respect to the original picture coordinates. The sub_bitstream_region_vertical_top_offset_in_luma_sample field indicates the ordinate of the upper end of the region with respect to the original picture coordinates. The sub_bitstream_region_width_in_luma_sample field indicates the horizontal resolution of the region. The sub_bitstream_region_height_in_luma_sample field indicates the vertical resolution of the region.

When all the MCTS bitstreams are present in one file, the following information may be used for extraction of data about a specific MCTS region.

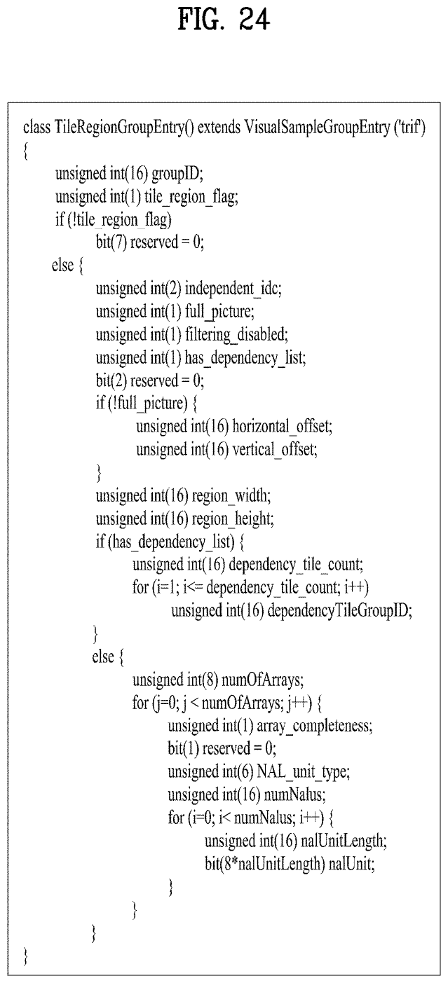

FIG. 24 shows MCTS region-related information in a file including multiple MCTS bitstreams according to an embodiment of the present invention.

Referring to FIG. 24, the extracted MCTS bitstreams may be defined as a group through sample grouping, and the VPS, SPS, PPS, and the like associated with the corresponding MCTS described above may be included in a nalUnit field of FIG. 24. The NAL unit type field may indicate one of the VPS, SPS, PPS, etc. as the type of the corresponding NAL unit, and the NAL unit (s) of the indicated type may be included in the nalUnit field.

In the present invention, the “region for which the independent processing is supported,” the “MCTS region,” and the like are different phases that may have the same meaning and may be referred to as a sub-picture, as described above. An omnidirectional 360-degree video may be stored and delivered through a file comprised of sub-picture tracks, which may be used for user viewpoint or viewport dependent processing. The sub-pictures may be a subset of the spatial area of the original picture, and each sub-picture may generally be stored on a separate track.

The viewport dependent processing may be performed based on, for example, the following flow.

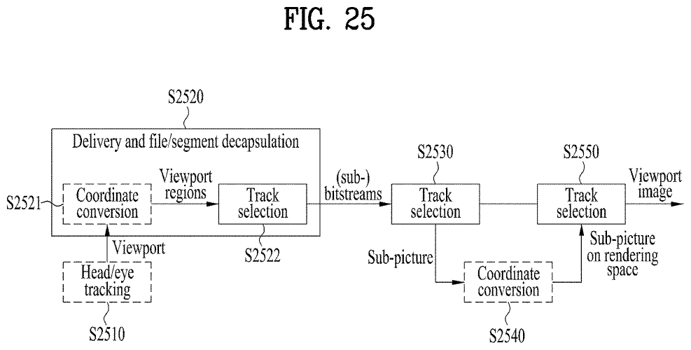

FIG. 25 illustrates viewport dependent processing according to an embodiment of the present invention.

Referring to FIG. 25, the reception apparatus performs head and/or eye tracking (S2010). The reception apparatus derives viewport information through head and/or eye tracking

The reception apparatus performs file/segment decapsulation on the received file (S2020). In this case, the reception apparatus may recognize the regions (viewport regions) corresponding to the current viewport through coordinate conversion (S2021). The apparatus may select and extract tracks containing sub-pictures covering the viewport regions (S2022).

The reception apparatus decodes the (sub-)bitstream(s) for the selected track(s) (S2030). The reception apparatus may decode/reconstruct the sub-pictures through the decoding. In this case, the reception apparatus may decode only the sub-pictures, not the whole original picture as in the existing decoding procedure, in which decoding is performed on the original picture basis.

The reception apparatus maps the decoded sub-picture(s) to a rendering space through the coordinate conversion (S2040). Since it performs decoding on the sub-picture(s) rather than the whole picture, it may map the sub-picture to the rendering space based on information about the position of the in the original picture, and may perform viewport dependent processing. The reception apparatus may generate an image (viewport image) associated with the viewport and display the same for the user (S2050).

As described above, the coordinate conversion procedure for the sub-pictures may be required in the rendering procedure. This is a procedure that is not needed in the conventional 360-degree video processing procedures. According to the present invention, since decoding is performed on sub-picture(s) rather than the whole picture, they may be mapped to the rendering space based on information indicating the position of the corresponding sub-picture in the original picture, and viewport dependent processing may be performed.

That is, after sub-picture unit decoding, the decoded picture may need to be arranged for proper rendering. The packed frame may be rearranged into a projected frame (when applied to the region-specific packing process) and the projected frame may be arranged according to the projection structure for rendering. Thus, when 2D coordinates in the packed frame/projected frame are indicated in the signaling of the coverage information about the tracks carrying sub-pictures, the decoded sub-pictures may be arranged into the packed frame/projected frame prior to rendering. Here, the coverage information may include information indicating the position (position and size) of the region according to the present invention described above.

According to the present invention, at least one sub-picture may be composed in a packed frame/projected frame so as to be spatially separated. In this case, regions separated from each other in the 2D space in one sub-picture may be referred to as sub-picture regions. For example, when the Equirectangular Projection (ERP) format is used as the projection format, the left and right ends of the packed frame/projected frame may be adjacent to each other on a spherical surface on which the frame is actually rendered. In order to cover this case, sub-picture regions spaced apart from each other in the packed frame/projected frame may configure one sub-picture, and the related coverage information and sub-picture composition may be, for example, as follows.

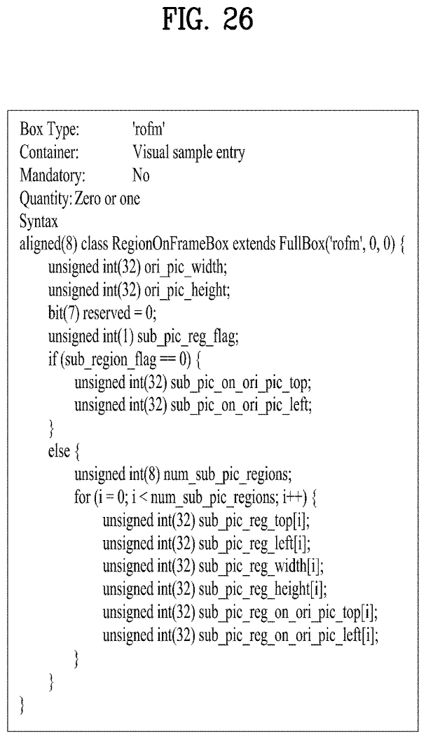

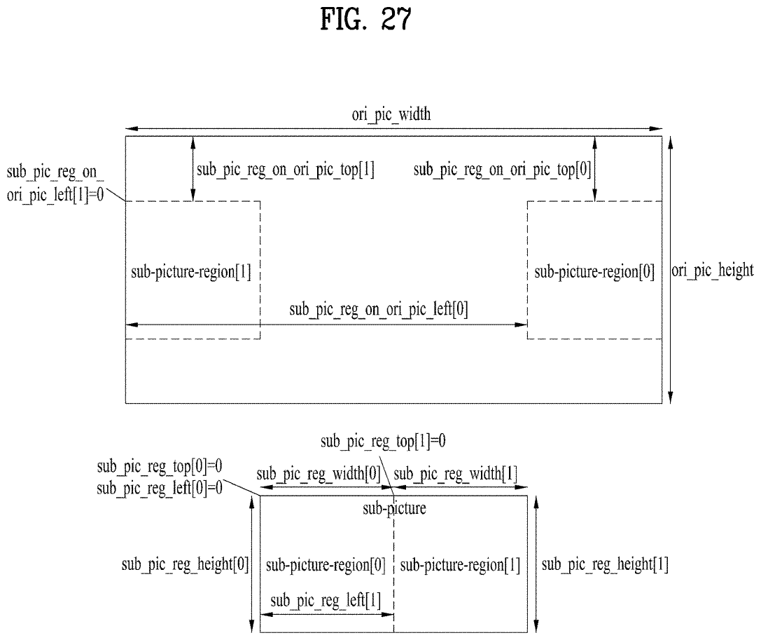

FIG. 26 shows coverage information according to an embodiment of the present invention, and FIG. 27 shows sub-picture composition according to an embodiment of the present invention. The sub-picture composition of FIG. 27 may be derived based on the coverage information shown in FIG. 26.

Referring to FIG. 26, the ori_pic_width field and the ori_pic_height field indicate the width and height of the entire original picture including sub-pictures, respectively. The width and height of a sub-picture may be indicated by the width and height in the visual sample entry. The sub_pic_reg_flag field indicates whether there is a sub-picture region. When the value of the sub_pic_reg_flag field is 0, it indicates that the sub-picture is wholly arranged into the original picture. When the value of the sub_pic_reg_flag field is 1, it may indicate that the sub-picture is divided into sub-picture regions and each sub-picture region is arranged into a frame (original picture). As shown in FIG. 26, the sub-picture regions may be arranged across the frame boundary. The sub_pic_on_ori_pic_top field and the sub_pic_on_ori_pic_left field indicate the top sample row and the leftmost sample column of a sub-picture in a original picture, respectively. The ranges of values of the sub_pic_on_ori_pic_top field and the sub_pic_on_ori_pic_left field may be from 0 (inclusive), which indicates the top-left corner of the original picture, to the value of the ori_pic_height field and the value of the ori_pic_width field (exclusive), respectively. The num_sub_pic_regions field indicates the number of sub-picture regions constituting the sub-picture. The sub_pic_reg_top[i] field and the sub_pic_reg_left[i] field indicate the top sample row and the leftmost sample column of the corresponding sub-picture region (sub-picture region i) in the sub-picture, respectively. Through these fields, a relationship (position sequence and arrangement) between a plurality of sub-picture regions in one sub-picture may be derived. The ranges of values of the subsub_pic_reg_top[i] field and the sub_pic_reg_left[i] field may be from 0 (inclusive), which indicates the top-left corner of each sub-picture, to the width and height of the sub-picture, respectively. Here, the width and height of the sub-picture may be derived from the visual sample entry. The sub_pic_reg_width[i] field and the sub_pic_reg_height[i] field indicate the width and height of the corresponding sub-picture region (sub-picture region i), respectively. The sum of the values of the sub_pic_reg_width[i] field (where i is from 0 to the value of the num_sub_pic_regions field−1) may be equal to the width of the sub-picture. Alternatively, the sum of the values of the sub_pic_reg_height[i] field (where i is from 0 to the value of the num_sub_pic_regions field−1) may be equal to the height of the sub-picture. The sub_pic_reg_on_ori_pic_top[i] field and the sub_pic_reg_on_ori_pic_left[i] field indicate the top sample row and the leftmost sample column of the corresponding sub-picture region in the original picture, respectively. The ranges of values of the sub_pic_reg_on_ori_pic_top[i] field and the sub_pic_reg_on_ori_pic_left[i] field may be from 0 (inclusive), which indicates the top-left corner of each the value of the projected frame, to the value of the ori_pic_height field and the value of the ori_pic_width field (exclusive), respectively.

In the above example, one sub-picture includes a plurality of sub-picture regions. According to the present invention, sub-pictures may be configured in an overlapping manner. When it is assumed that each sub-picture bitstream is exclusively decoded by one video decoder at a time, the overlapping sub-pictures may be used to limit the number of video decoders.

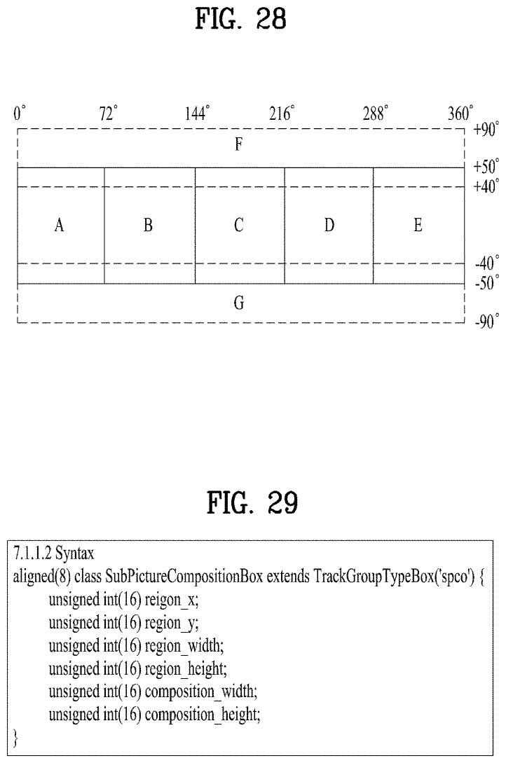

FIG. 28 shows overlapping sub-pictures according to an embodiment of the present invention. FIG. 28 illustrates a case where source content (for example, an original picture) is split into seven rectangular regions, and the regions are grouped into seven sub-pictures.

Referring to FIG. 28, sub-picture 1 consists of regions (sub-picture regions) A and B, sub-picture 2 consists of regions B and C, sub-picture 3 consists of regions C and D, sub-picture 4 consists of regions D and E, sub-picture 5 consists of regions E and A, sub-picture 6 consists of region F, and sub-picture 7 consists of region G.

With the above configuration, the number of video decoders required for decoding of the sub-picture bitstreams for the current viewport may be reduced. In particular, when the viewport is positioned on a side of a picture of the ERP format, sub-pictures may be efficiently extracted and decoded.

For example, the following conditions may be considered in order to support sub-picture composition including multiple rectangular regions in the above-mentioned track. A single SubpictureCompositionBox may describe a single rectangular region. TrackGroupBox may have multiple SubpictureCompositionBoxes. The order of the multiple SubpictureCompositionBoxes may indicate the positions of the rectangular regions in a sub-picture. Here, the order may be a raster scan order.

TrackGroupTypeBox with track_group_type set to ‘spco’ may indicate that the track belongs to a composition of tracks that may be spatially arranged to acquire suitable pictures for presentation. Visual tracks mapped to the grouping (i.e., visual tracks having the same value of track_group_id in the TrackGroupTypeBox with track_group_type set to ‘spco’) may collectively indicate visual content that may be presented. Each separate visual track mapped to the grouping may or may not be sufficient for presentation. When a track carries a sub-picture sequence mapped to multiple rectangular regions on the composed picture, there may be multiple TrackGroupTypeBoxes that have the same track_group_id value and track_group_type set to ‘spco’. The boxes may appear in the TrackGroupBox according in the raster scan order of the rectangular regions on the sub-picture. In this case, CompositionRestrictionBox may be used to indicate that the visual track alone is not sufficient for presentation. A suitable picture for presentation may be composed by spatially arranging the time-parallel samples of all tracks of the same sub-picture composition track group as indicated by the syntax elements of the track group.

FIG. 29 shows the syntax of SubpictureCompositionBox.

Referring to FIG. 29, the region_x field indicates the horizontal positions of the top-left corners of the rectangular regions of the samples of the track on the composed picture in luma sample units. The value of the region _x field may range from 0 to the value of the composition_width field−1 (minus 1). The region_y field indicates the vertical positions of the top-left corners of the rectangular regions of the samples of the track on the composed picture in luma sample units. The value of the region_y field may range from 0 to the value of the composition_height field−1. The region_width field indicates the width of the rectangular regions of the samples of the track on the composed picture in luma sample units. The value of the region_width field may range from 1 to the value of the composition_width field−(minus) the value of the region_x field. The region_height field indicates the height of the rectangular regions of the samples of the track on the composed picture in luma sample units. The value of the region_height field may range from 1 to the value of the composition_height field−(minus) the value of the region_y field. The composition_width field indicates the width of the composed picture in units of luma samples. The value of the composition_width field may be greater than or equal to the value of the region_x field+(plus) the value of the region_width field. The composition_height field indicates the height of the composed picture in luma sample units. The value of the composition_height field may be greater than or equal to the value of the region_y field+(plus) the value of the region_height field. The composed picture may correspond to the original picture, the packed picture, or the projected picture described above.

In order to identify a sub-picture track including a multiple rectangular regions mapped into a composed picture, the following methods may be used.

As an example, the information for identifying the rectangular regions may be signaled through information about a guard band.

When 360-degree video data that is continuous in a three-dimensional space is mapped onto regions of a 2D image, the 2D image may be coded on a region-by-region basis and transmitted to the reception side. Then, when the 360-degree video data mapped to the 2D image is rendered into the three-dimensional space again, the boundaries between the regions may appear in the three-dimensional space due to differences in coding process between the regions, thereby causing a problem. The problem that the boundaries between the regions appear in the three-dimensional space may be called a boundary error. The boundary error may degrade the immersion of the user in the virtual reality. To prevent such an issue from being raised, a guard band may be used. The guard band may represent an region that is not be directly rendered, but is used to enhance the rendered portion of an associated region or to avoid or mitigate visual artifacts such as seams. The guard band may be used when a region-wise packing operation is applied.

In this example, the multiple rectangular regions may be identified using Region-wisePackingBox.

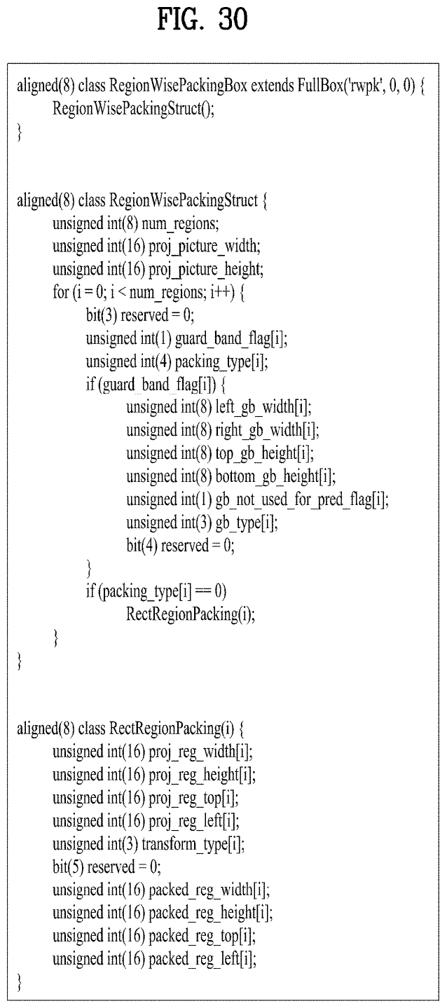

FIG. 30 shows a hierarchical structure of Region-wisePackingBox.

Referring to FIG. 30, when the value of the guard_band_flag[i] field is 0, the field indicates that the i-th region has no guard band. The value of the guard_band_flag[i] field is 1, the field indicates that the i-th region has a guard band. The packing_type[i] field indicates the type of region-wise packing. The packing_type[i] field having the value of 0 indicates rectangular region-wise packing. The other values may be reserved. The left_gb_width[i] field indicates the width of a guard band on the left side of the i-th region. The left_gb_width[i] field may indicate the width of a guard band in units of two luma samples. The right_gb_width[i] field indicates the width of a guard band on the right side of the i-th region. The right_gb_width[i] field may indicate the width of the guard band in units of two luma samples. The top_gb_width[i] field indicates the width of a guard band on the top side of the i-th region. The top_gb_width[i] field may indicate the width of the guard band in units of luma samples. The bottom_gb_width[i] field indicates the width of a guard band on the lower side of the i-th region. The bottom_gb_width[i] field may indicate the width of the guard band in units of luma samples. When the value of the guard_band_flag[i] is 1, the value of the left_gb_width[i] field, the right_gb_width[i] field, the top_gb_width[i] field, or the bottom_gb_width[i] field is greater than 0. The i-th region, including its guard bands, if any, shall not overlap with any other region, including its guard bands.

The gb_not_used_for_pred_flag[i] field having a value of 0 indicates that guard bands are available for inter prediction. That is, when the value of the gb_not_used_for_pred_flag[i] field is 0, the guard bands may or may not be used for inter prediction. The gb_not_used_for_pred_flag[i] field having a value of 1 indicates that sample values of the guard bands are not used in the inter prediction procedure. When the value of the gb_not_used_for_pred_flag[i] field is 1, even if the decoded pictures (decoded packed pictures) were used as references for inter prediction of subsequent pictures to be decoded, the sample values in the guard bands on the decoded pictures can be rewritten or modified. For example, the content of a region may be seamlessly extended to the guard bands thereof, using decoded and re-projected samples of another other region.

The gb_type[i] field may indicate the type of the guard bands of the i-th region as follows. The gb_type[i] field having the value of 0 indicates that the contents of the guard bands are unspecified in relation to the content of the region(s). If the value of the gb_not_used_for_pred_flag field is 0, the value of the gb type field cannot be 0. The gb_type[i] field having the value of 1 indicates that the contents of the guard bands are sufficient for interpolation of subpixel values in the region (and within one pixel outside the region boundary). The gb_type[i] field having the value of 1 may be used when the boundary samples of the region are copied horizontally or vertically to the guard bands. The gb_type[i] field having the value of 2 indicates the contents of the guard bands represent the actual image content on the basis of a gradually changing quality, and the gradually changing quality is gradually changed from the picture quality of the corresponding region to the picture quality of an adjacent region on the spherical surface. The gb_type[i] field having the value of 3 indicates that the contents of the guard bands represent the actual image content on the basis of the picture quality of the corresponding region.

When a single track includes rectangular regions mapped to multiple rectangular regions in a composed picture, some of the regions may be identified as a region-wise packing region as identified by RectRegionPacking(i), and the other regions may be identified as guard band regions as identified based on a part or the entirety of the guard_band_flag[i] field, the left_gb_width[i] field, the right_gb_width[i] field, the top_gb_height[i] field, the bottom_gb_height[o] field, the gb_not_used_for_pred_flag[i] field, and the gb_type[i] field.

As an example, in the case of sub-picture 7 illustrated in FIG. 27 and described in detail above, region E may be identified as a region-wise packing region, and region A may be identified as a guard band region positioned on the right side of region E. In this case, the width of the guard band region may be identified based on the right_gb_width[i] field. Conversely, region A may be identified as a region-wise packing region, and region E may be identified as a guard band region on the left side. In this case, the width of the guard band region may be identified based on the left_gb_width[i] field. Such types of the guard band region may be indicated by the gb_type[i] field, and through the value ‘3’ described above, the rectangular region may be identified as a region having the same quality as an identical adjacent region. Alternatively, when the quality of the region-wise packing region is different from that of the guard band region, the rectangular region may be identified through the value ‘2’ described above.

In addition, the rectangular region may be identified through values ‘4’ to ‘7’ of the gb_type[i] field as follows. The gb_type[i] field having the value of 4 may indicate that the content of the rectangular region is the actual image content that is positioned adjacent to the region on the spherical surface and the quality gradually changes from an associated region-wise packing region. The gb_type[i] field having the value of 5 may indicate that the content is the actual image content that is positioned adjacent to the region on the spherical surface and the quality thereof is equal to the quality of an associated region-wise packing region. The gb_type[i] field having the value of 6 may indicate that the content of the rectangular region is the actual image content that is positioned adjacent to the region on the projected picture and the quality gradually changes from the region-wise packing region. The gb_type[i] field having the value of 7 may indicate that the content of the rectangular region is the actual image content that is positioned adjacent to the region on the projected picture and the quality thereof is equal to the quality of an associated region-wise packing region.

As another example, information for identifying the rectangular region may be signaled using SubPicturecompositionBox.

In the present invention, the multiple rectangular regions may be divided into a region present in the composed picture region and a region present outside the composed picture region, based on the coordinate values. The multiple rectangular regions may be presented by clipping the region present outside the composed picture region and placing the clipped region on the opposite corner.

As an example, when x, which is the abscissa of a rectangular region in the composed picture region, is greater than or equal to the value of the composition_width field, a value obtained by subtracting the value of the composition_width field from x may be used. When y, which is the ordinate of the rectangular region, is greater than or equal to the value of the composition_height field, a value obtained by subtracting the value of the composition_height field from y may be used.

To this end, the ranges of the track_width field, the track_height field, the composition_width field, and the composition_height field of SubPictureCompositionBox described in detail in FIG. 28 may be modified as follows.

The value of the region_width field may range from 1 to the value of the composition_width field. The value of the region_height field may range from 1 to the value of the composition_height field. The value of the composition_width field may be greater than or equal to the value of the region_x field+1 (plus 1). The value of the composition_height field may be greater than or equal to the value of the region_y field+1 (plus 1).

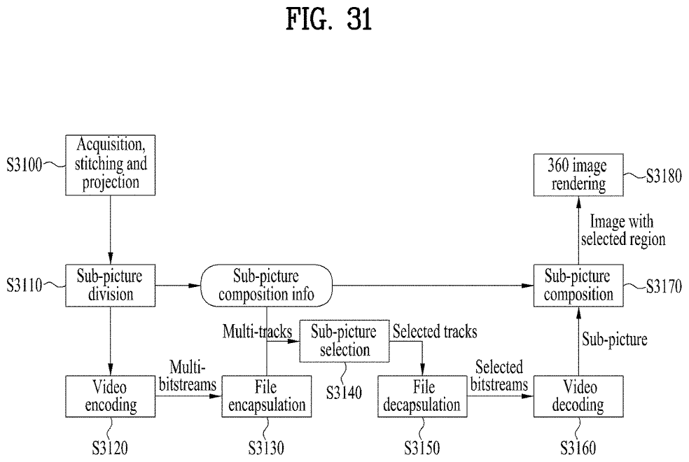

FIG. 31 schematically illustrates a transmission/reception procedure of 360-degree video using sub-picture composition according to the present invention.

Referring to FIG. 31, the transmission apparatus acquires a 360-degree image, and maps the acquired image to one 2D picture through stitching and projection (S2600). In this case, the region-wise packing operation may be optionally included. Here, the 360-degree image may be an image captured using at least one 360-degree camera, or may an image generated or synthesized through an image processing apparatus such as a computer. In addition, the 2D picture may include the original picture, the projected picture/packed picture, and the composed picture described above.

The transmission apparatus divide the 2D picture into multiple sub-pictures (S2610). In this case, the transmission apparatus may generate and/or use sub-picture composition information.

The transmission apparatus may encode at least one of the multiple sub-pictures (S2520). The transmission apparatus may select and encode a part of the multiple sub-pictures. Alternatively, the transmission apparatus may encode all the multiple sub-pictures. Each of the multiple sub-pictures may be independently coded.

The transmission apparatus construct a file using the encoded sub-picture stream (S2630). The sub-picture stream may be stored in the form of separate tracks. The sub-picture composition information may be included in a corresponding sub-picture track using at least one of the methods according to the present invention described above.

The transmission apparatus or the reception apparatus may select a sub-picture (S2640). The transmission apparatus may select a sub-picture using the user's viewport information and interaction-related feedback information, and transmit a related track. Alternatively, the transmission apparatus may transmit a plurality of sub-picture tracks, and the reception apparatus may select at least one sub-picture (sub-picture track) using the user's viewport information and the interaction-related feedback information.

The reception apparatus interprets the file, acquires the sub-picture bitstream and the sub-picture composition information (S2650), and decodes the sub-picture bitstream (S2660). The reception apparatus maps the decoded sub-picture to the composed picture (original picture) region based on the sub-picture composition information (S2670). The reception apparatus renders the mapped composed picture (S2680). In this case, the reception apparatus may perform a rectilinear projection operation of mapping a part of the spherical surface corresponding to the user's viewport to a viewport plane.

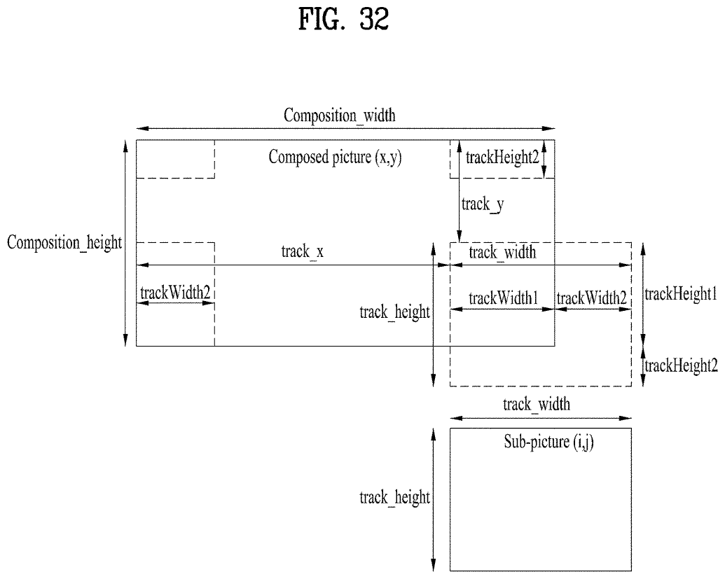

According to the present invention, as shown in FIG. 32, the sub-picture may include regions which are not adjacent to each other on the 2D composed picture as sub-picture regions. In the above-described operation S2610, the sub-picture may be derived by extracting a region corresponding to a position (track_x, track_y) and a size (width, height) given by the sub-picture composition information for the pixels (x, y) constituting the composed picture. In this case, the position (i, j) of a pixel in the sub-picture may be derived as shown in Table 1 below.

TABLE 1

if (track_x+track_width > composition_width) {

trackWidth1 = composition_width − track_x;
trackWidth2 = track_width − trackWidth1

} else {

trackWidth1 = track_width
trackWidth2 = 0

}
if (track_y+track_height > composition_height) {

trackHeight1 = composition_height − track_y;
trackHeight2 = track_height − trackHeight1

} else {

trackHeight1 = track_height
trackHeight2 = 0

}
for (y=track_y; y<trackHeight1; y++) {

for (x=track_x; x<trackWidth1; x++) {

i = x − track_x
j = y − track_y

}
for (x=0; x<trackWidth2; x++) {

i = x
j = y − track_y

}

}
for (y=0; y<trackHeight2; y++) {

for (x=track_x; x<trackWidth1; x++) {

i = x − track_x
j = y

}
for (x=0; x<trackWidth2; x++) {

i = x
j = y

}

}

Further, in the above-described operation S2680, the position (x, y) of the pixels in the composed picture mapped to the position (i, j) of the pixels constituting the sub-picture may be derived as shown in Table 2 below.

TABLE 2

for (j=0; j<track_height; j++) {

for (i=0; i<track_width; i++) {

x = track_x + i
y = track_y + j
if ( x >= composition_width)

x −= composition_width

if (y >= composition_height)

y −= composition_height

}

}

As described above, the position (i, j) of the pixels in the sub-picture may be mapped to the position (x, y) of the pixels constituting the composed picture. When (x, y) is out of the boundary of the composed picture, it may be connected to the left side of the composed picture if it deviates rightward, or may be connected to the upper side of the composed picture if it deviates downward, as shown in FIG. 32.

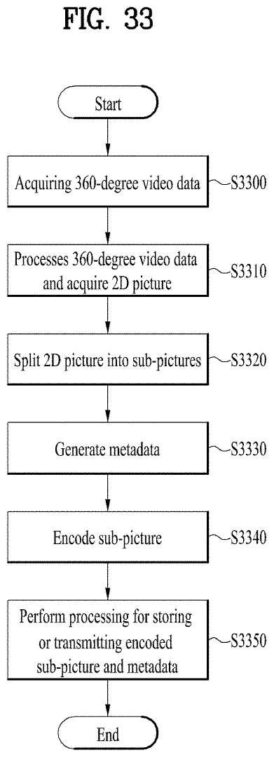

FIG. 33 schematically illustrates a method for processing 360-degree video data by a 360-degree video transmission apparatus according to the present invention. The method disclosed in FIG. 33 may be carried out by a 360-degree video transmission apparatus.

The 360-degree video transmission apparatus acquires 360-degree video data (S2800). Here, the 360-degree image may be an image captured using at least one 360-degree camera, or may be an image generated or synthesized through an image processing apparatus such as a computer.

The 360-degree video transmission apparatus processes the 360-degree video data and acquires a 2D picture (S2810). The acquired image may be mapped to one 2D picture through stitching and projection. In this case, the above-described region-wise packing operation may be optionally performed. Here, the 2D picture may include the original picture, the projected picture/packed picture, and the composed picture described above.

The 360-degree video transmission apparatus splits the 2D picture into sub-pictures (S2820). The sub-pictures may be processed independently. The 360-degree video transmission apparatus may generate and/or use sub-picture composition information. The sub-picture composition information may be included in the metadata.

The sub-picture may include multiple sub-picture regions. The sub-picture regions may not be spatially adjacent to each other in the 2D picture. The sub-picture regions may not be spatially adjacent to each other in the 2D picture, but may be spatially adjacent to each other in a 3D space (spherical surface) in which the regions are to be presented or rendered.

Metadata about the 360-degree video data is generated (S2830). The metadata may include various kinds of information proposed in the present invention.

As an example, the metadata may include position information about the sub-picture in the 2D picture. If the 2D picture is a packed picture derived through a region-wise packing operation, the position information about the sub-picture may include information indicating the abscissa of the left end of the sub-picture, information indicating the ordinate of the top end of the sub-picture, information indicating the width of the sub-picture, and information indicating the height of the sub-picture, with respect to the coordinates of the packed picture. The position information about the sub-picture may further include information indicating the width of the packed picture and information indicating the height of the packed picture. For example, the position information about the sub-picture may be included in RegionOriginalCoordinateBox included in the metadata.

At least one sub-picture track may be generated through S2850, which will be described later, and the metadata may include the position information about the sub-picture and track ID information associated with the sub-picture. For example, the position information about the sub-picture and the track ID information associated with the sub-picture may be included in RegionToTrackBox included in the metadata. In addition, a file including a plurality of sub-picture tracks may be generated through the step of processing for the storing or transmission, and the metadata may include a video parameter set (VPS), a sequence parameter set (SPS), or a picture parameter set (PPS) associated with the sub-picture, as shown in FIG. 24.

As another example, the position information about the sub-picture may be included in an SEI message. The SEI message may include, in luma sample units, information indicating the abscissa of the left end of the sub-picture, information indicating the ordinate of the top end of the sub-picture, information indicating the width of the sub-picture, and information indicating the height of the sub-picture, with respect to the coordinates of the 2D picture. The SEI message may further include information indicating the number of bytes of the position information about the sub-picture as shown in FIG. 22.

The sub-picture may include a plurality of sub-picture regions. In this case, the metadata may include sub-picture region information. The sub-picture region information may include position information about the sub-picture regions and information about association between the sub-picture regions. The sub-picture regions may be indexed in a raster scan order. As shown in FIG. 26, the association information may include at least one of information indicating the top row of each sub-picture region in the sub-picture or information indicating the leftmost column of each sub-picture region in the sub-picture.

The position information about the sub-picture may include information indicating the abscissa of the left end of the sub-picture, information indicating the ordinate of the top end of the sub-picture, information indicating the width of the sub-picture, and information indicating the height of the sub-picture, with respect to the coordinates of the 2D picture. The value of the information indicating the width of the sub-picture may range from 1 to the width of the 2D picture, and the value of the information indicating the height of the sub-picture may range from 1 to the height of the 2D picture. If the abscissa of the left end of the sub-picture plus the width of the sub-picture is greater than the width of the 2D picture, the sub-picture may include the plurality of sub-picture regions. If the ordinate of the top end of the sub-picture plus the height of the sub-picture is greater than the height of the 2D picture, the sub-picture may include the plurality of sub-picture regions.

The 360-degree video transmission apparatus encodes at least one of the sub-pictures (S2840). The 360-degree video transmission apparatus may select and encode a part of the multiple sub-pictures, or may encode all the multiple sub-pictures. Each of the multiple sub-pictures may be independently coded.

The 360-degree video transmission apparatus performs processing for storing or transmitting the encoded at least one sub-picture and the metadata (S2850). The 360-degree video transmission apparatus may encapsulate the encoded at least one sub-picture and/or the metadata into a file or the like. The 360-degree video transmission apparatus may encapsulate the encoded at least one sub-picture and/or the metadata into a file format such as ISOBMFF or CFF to store or transmit the encoded at least one sub-picture and the metadata, or may process the same in the form of a DASH segment or the like. The 360-degree video transmission apparatus may include the metadata in a file format. For example, the metadata may be included in boxes of various levels in the file format of ISOBMFF, or may be included as data in a separate track within the file. The 360-degree video transmission apparatus may process the encapsulated file according to the file format so as to be transmitted. The 360-degree video transmission apparatus may process the file according to any transport protocol. The processing for the transmission may include processing for transmission over a broadcasting network, or processing for transmission over a communication network such as broadband. In addition, the 360-degree video transmission apparatus may perform processing on the metadata for transmission. The 360-degree video transmission apparatus may transmit the transmission-processed 360-degree video data and the metadata over the broadcasting network and/or broadband.

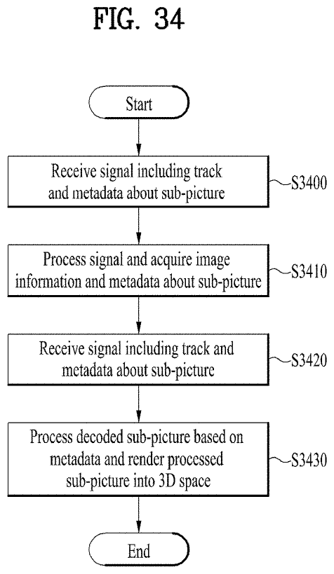

FIG. 34 schematically illustrates a method for processing 360-degree video data by a 360-degree video reception apparatus according to the present invention. The method disclosed in FIG. 34 may be carried out by the 360-degree video reception apparatus.

The 360-degree video reception apparatus receives a signal including a track and metadata about the sub-picture (S2900). The 360-degree video reception apparatus may receive the image information and the metadata about the sub-picture signaled from the 360-degree video transmission apparatus over the broadcasting network. The 360-degree video reception apparatus may receive the image information and the metadata about the sub-picture over a communication network such as broadband or a storage medium. Here, the sub-picture may be positioned in a packed picture or a projected picture.

The 360-degree video reception apparatus processes the signal and acquires image information and metadata about the sub-picture (S2910). The 360-degree video reception apparatus may process the received image information about the sub-picture and the metadata according to the transport protocol. Further, the 360-degree video reception apparatus may perform a reverse operation of the processing for transmission by the 360-degree video transmission apparatus described above.

The received signal may include a track about at least one sub-picture. When the received signal includes a track about a plurality of sub-pictures, the 360-degree video reception apparatus may select a part (including one) of the tracks about the plurality of sub-pictures. In this case, viewport information and the like may be used.

The sub-picture may include multiple sub-picture regions, and the sub-picture regions may not be spatially adjacent to each other on the 2D picture. The sub-picture regions may not be spatially adjacent to each other in the 2D picture. The sub-picture regions may not be spatially adjacent to each other in the 2D picture, but may be spatially adjacent to each other in a 3D space (spherical surface) in which the regions are to be presented or rendered.

The metadata may include various kinds of information proposed in the present invention.

As an example, the metadata may include position information about the sub-picture in the 2D picture. If the 2D picture is a packed picture derived through a region-wise packing operation, the position information about the sub-picture may include information indicating the abscissa of the left end of the sub-picture, information indicating the ordinate of the top end of the sub-picture, information indicating the width of the sub-picture, and information indicating the height of the sub-picture, with respect to the coordinates of the packed picture. The position information about the sub-picture may further include information indicating the width of the packed picture and information indicating the height of the packed picture. For example, the position information about the sub-picture may be included in RegionOriginalCoordinateBox included in the metadata.

The metadata may include the position information about the sub-picture and track ID information associated with the sub-picture. For example, the position information about the sub-picture and the track ID information associated with the sub-picture may be included in RegionToTrackBox included in the metadata. In addition, a file including a plurality of sub-picture tracks may be generated through the step of processing for the storing or transmission, and the metadata may include a video parameter set (VPS), a sequence parameter set (SPS), or a picture parameter set (PPS) associated with the sub-picture, as shown in FIG. 24.

As another example, the position information about the sub-picture may be included in an SEI message. The SEI message may include, in luma sample units, information indicating the abscissa of the left end of the sub-picture, information indicating the ordinate of the top end of the sub-picture, information indicating the width of the sub-picture, and information indicating the height of the sub-picture, with respect to the coordinates of the 2D picture. The SEI message may further include information indicating the number of bytes of the position information about the sub-picture as shown in FIG. 22.

The sub-picture may include a plurality of sub-picture regions. In this case, the metadata may include sub-picture region information. The sub-picture region information may include position information about the sub-picture regions and information about association between the sub-picture regions. The sub-picture regions may be indexed in a raster scan order. As shown in FIG. 26, the association information may include at least one of information indicating the top row of each sub-picture region in the sub-picture or information indicating the leftmost column of each sub-picture region in the sub-picture.

The position information about the sub-picture may include information indicating the abscissa of the left end of the sub-picture, information indicating the ordinate of the top end of the sub-picture, information indicating the width of the sub-picture, and information indicating the height of the sub-picture, with respect to the coordinates of the 2D picture. The value of the information indicating the width of the sub-picture may range from 1 to the width of the 2D picture, and the value of the information indicating the height of the sub-picture may range from 1 to the height of the 2D picture. If the abscissa of the left end of the sub-picture plus the width of the sub-picture is greater than the width of the 2D picture, the sub-picture may include the plurality of sub-picture regions. If the ordinate of the top end of the sub-picture plus the height of the sub-picture is greater than the height of the 2D picture, the sub-picture may include the plurality of sub-picture regions.

The 360-degree video reception apparatus decodes the sub-picture based on the image information about the sub-picture (S2920). The 360-degree video reception apparatus may independently decode the sub-picture based on the image information about the sub-picture. Even when the image information about a plurality of sub-pictures is input, the 360-degree video reception apparatus may decode only a specific sub-picture based on the acquired viewport-related metadata.

The 360-degree video reception apparatus processes the decoded sub-picture based on the metadata and renders the processed sub-picture into a 3D space (S2930). The 360-degree video reception apparatus may map the decoded sub-picture to the 3D space based on the metadata. In this case, the 360-degree video reception apparatus may perform coordinate conversion based on the position information about the sub-picture and/or sub-picture regions according to the present invention to map and render the decoded sub-picture into the 3D space.

The steps described above may be omitted, or may be replaced by another step of performing a similar/same operation according to an embodiment.

The 360-degree video transmission apparatus according to an embodiment of the present invention may include the data input unit, the stitcher, the signaling processor, the projection processor, the data encoder, the transmission processor, and/or the transmission unit as described above. Each of the internal components is as described above. The 360 degree video transmission apparatus and its internal components according to an embodiment of the present invention may carry out embodiments of the method for transmitting a 360 degree video of the present invention described above.

The 360-degree video reception apparatus according to an embodiment of the present invention may include the reception unit, the reception processor, the data decoder, the signaling parser, the re-projection processor, and/or the renderer described above. Each of the internal components is as described above. The 360 degree video reception apparatus and the internal components thereof according to an embodiment of the present invention may carry out embodiments of the method for receiving a 360 degree video of the present invention described above.

The internal components of the above-described apparatus may be processors to execute the sequential execution processes stored in the memory, or other hardware components configured as hardware. These components may be positioned inside or outside the apparatus.

The above-described modules may be omitted or replaced by other modules performing the similar/same operations, depending on embodiments.

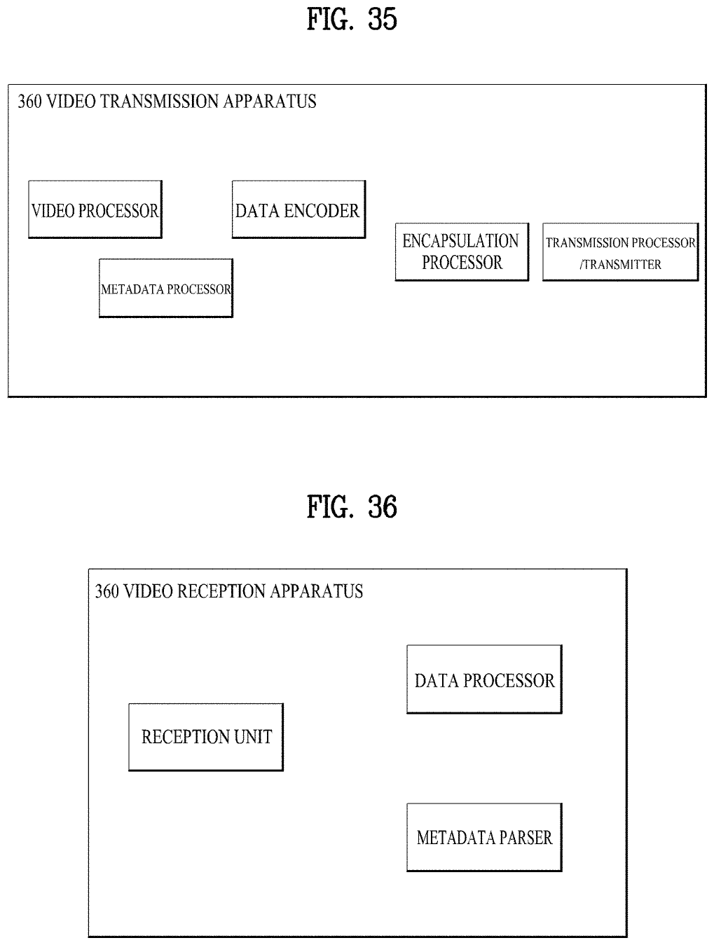

FIG. 35 is a diagram illustrating a 360 video transmission apparatus according to one aspect of the present invention.

In one aspect, the invention may relate to a 360 video transmission apparatus. The 360 video transmission apparatus may process 360 video data, generate signaling information about the 360 video data, and transmit the signaling information to the reception side.

Specifically, the 360 video transmission apparatus may stitch 360 video, project the 360 video onto a picture and process the same, encode the picture, generate signaling information about the 360 video data, and transmit the 360 video data and/or the signaling information in various forms in various ways.

The 360 video transmission apparatus according to the present invention may include a video processor, a data encoder, a metadata processor, an encapsulation processor, and/or a transmission unit as internal/external components.

The video processor may process 360 video data captured by at least one camera. The video processor may stitch the 360 video data and project the stitched 360 video data onto a 2D image, i.e., a picture. According to an embodiment, the video processor may further perform region-wise packing. Here, the stitching, projection, and region-wise packing may correspond to the above-described processes of the same names. The region-wise packing may be referred to as region-by-region packing depending on the embodiment. The video processor may be a hardware processor that performs functions corresponding to the stitcher, the projection processor, and/or the region-wise packing processor described above.

The data encoder may encode the picture onto which the 360 video data is projected. According to an embodiment, if region-based packing is performed, the data encoder may encode a packed picture. The data encoder may correspond to the data encoder described above.

The metadata processor may generate signaling information for the 360 video data. The metadata processor may correspond to the metadata processor described above.

The encapsulation processor may encapsulate the encoded picture and the signaling information into a file. The encapsulation processor may correspond to the encapsulation processor described above.

The transmission unit may transmit the 360 video data and the signaling information. When the information is encapsulated into a file, the transmission unit may transmit files. The transmission unit may be a component corresponding to the transmission processor and/or the transmission unit described above. The transmission unit may transmit the information over a broadcasting network or broadband.

In one embodiment of the 360 video transmission apparatus according to the present invention, the signaling information may include coverage information. The coverage information may indicate a region occupied by a sub-picture of the above-mentioned picture in a 3D space. According to an embodiment, the coverage information may indicate a region occupied by one region of the picture, which is not a sub-picture, in the 3D space.

In another embodiment of the 360 video transmission apparatus according to the present invention, the data encoder may process some regions of the entire 360 video data into an independent video stream for processing based on a user viewpoint. The data encoder may process each of some regions in the projected picture or region-wise packed picture in the form of independent media streams. These video streams may be stored and transmitted separately. Here, each of the regions may be a tile as described above.

In the case where the video streams are encapsulated into a file, one track may include this rectangular region, which may correspond to one or more tiles. According to an embodiment, when the video streams are delivered by DASH, one Adaptation Set, Representation, or Sub Representation may include a rectangular region, which may correspond to one or more tiles. According to an embodiment, the respective regions may be HEVC bitstreams extracted from an HEVC MCTS bitstream. Depending on the embodiment, this process may be carried out by the above-described tiling system or transmission processor, not by the data encoder.

In another embodiment of the 360 video transmission apparatus according to the present invention, the coverage information may include information for specifying the region. In order to specify the region, the coverage information may include information for specifying the center, width, and/or height of the region. The coverage information may include information indicating a yaw value and/or a pitch value of the center point of the region. When the 3D space is a spherical surface, such information may be represented as an azimuth value or an elevation value. The coverage information may also include a width value and/or a height value of the region, which specify the width and height of the region with respect to the specified center point, thereby indicating the coverage of the entire region.

In another embodiment of the 360 video transmission apparatus according to the present invention, the coverage information may include information specifying the shape of the region. Depending on the embodiment, the region may be of a shape specified by four great circles or a shape specified by two yaw circles and two pitch circles. The coverage information may have information indicating which of these shapes the region has.

In another embodiment of the 360 video transmission apparatus according to the present invention, the coverage information may include information indicating whether the 360 video of the region is a 3D video and/or whether it is left/right views. The coverage information may indicate whether the 360 video is a 2D video or a 3D video and whether the 360 video corresponds to a left view or a right view if it is a 3D video. Depending on the embodiment, this information may also indicate whether the 360 video includes both left and right views. Depending on the embodiment, this information may be defined by one field, and all details described above may be signaled depending on the value of this field.

In another embodiment of the 360 video transmission apparatus according to the present invention, the coverage information may be generated in the form of a Dynamic Adaptive Streaming over HTTP (DASH) descriptor. The coverage information may be composed as a DASH descriptor in a different format. In this case, the DASH descriptor may be included in the Media Presentation Description (MPS) and transmitted through a separate path different from the path for the 360 video data file. In this case, the coverage information and the 360 video data may not be encapsulated together into a file. That is, the coverage information may be transmitted to the reception side on a separate signaling channel in the form of MPD or the like. Depending on the embodiment, the coverage information may be included in the file and in separate signaling information, such as MPD, at the same time.

In another embodiment of the 360 video transmission apparatus according to the present invention, the 360 video transmission apparatus may further include a (transmission side) feedback processor. The (transmission side) feedback processor may correspond to the above-described (transmission side) feedback processor. The (transmission side) feedback processor may receive feedback information indicating the viewport of the current user from the reception side. This feedback information may include information specifying the viewport that the current user is viewing through a VR device or the like. As described above, tiling or the like may be performed using this feedback information. In this case, one region of the sub-picture or picture transmitted by the 360 video transmission apparatus may be one region of a sub-picture or picture corresponding to the viewport indicated by the feedback information. In this case, the coverage information may indicate the coverage of one region of the sub-picture and the picture corresponding to the viewport indicated by the feedback information.

In another embodiment of the 360 video transmission apparatus according to the present invention, the 3D space may be a sphere. According to an embodiment, the 3D space may be a cube or the like.

In another embodiment of the 360 video transmission apparatus according to the present invention, the signaling information about the 360 video data may be embedded in a file in the form of an ISO Base Media File Format (ISOBMFF) box. According to an embodiment, the file may be an ISOBMFF file or a file according to Common File Format (CFF).

In another embodiment of the 360 video transmission apparatus according to the present invention, the 360 video transmission apparatus may further include a data input unit, which is not shown. The data input unit may correspond to the above-mentioned internal component of the same name.

The 360 video transmission apparatus according to embodiments of the present invention may be configured to effectively provide 360 video services by defining and transmitting metadata about the attributes and the like of the 360 video in providing 360 video contents.

As the 360 video transmission apparatus according to the embodiments of the present invention adds a shape_type field or parameter to the coverage information, a region corresponding to the viewport may be effectively selected on the reception side.

The 360 video transmission apparatus according to embodiments of the present invention may receive and process, through tiling, only the video region corresponding to a viewport currently viewed by the user and provide the video region to the user. This may enable efficient data transmission and processing.

In the case of a 3D 360 video, the 360 video transmission apparatus according to embodiments of the present invention may signal, through the coverage information, whether the region is a left/right view, and whether the video is a 2D/3D video. Thereby, the 3D 360 video may be effectively acquired and processed.

Embodiments of the above-described 360 video transmission apparatus according to the present invention may be combined with each other. In addition, the internal/external components of the 360 video transmission apparatus described above according to the present invention may be added, changed, replaced or omitted according to embodiments. In addition, the internal/external components of the 360 video transmission apparatus described above may be implemented as hardware components.

FIG. 36 is a diagram illustrating a 360 video reception apparatus according to another aspect of the present invention.

In accordance with another aspect, the present invention may relate to a 360 video reception apparatus. The 360 video reception apparatus may receive and process 360 video data and/or signaling information about the 360 video data and render the 360 video for the user. The 360 video reception apparatus may be a reception side apparatus corresponding to the above-described 360 video transmission apparatus.

Specifically, the 360 video reception apparatus may receive 360 video data and/or signaling information about the 360 video data, acquire the signaling information, process the 360 video data based on the signaling information, and render a 360 video.

The 360 video reception apparatus according to the present invention may include a reception unit, a data processor, and/or a metadata parser as internal/external components.

The reception unit may receive 360 video data and/or signaling information about the 360 video data. According to an embodiment, the reception unit may receive the information in the form of a file. According to an embodiment, the reception unit may receive the information over a broadcasting network or broadband. The reception unit may be a component corresponding to the reception unit described above.

The data processor may acquire the 360 video data and/or the signaling information about the 360 video data from the received file or the like. The data processor may process the received information according to a transport protocol, decapsulate the file, or decode the 360 video data. The data processor may also perform re-projection of 360 video data and then perform corresponding rendering. The data processor may be a hardware processor that performs functions corresponding to the reception processor, the decapsulation processor, the data decoder, the re-projection processor, and/or the renderer described above.

The metadata parser may parse the acquired signaling information. The metadata parser may correspond to the above-described metadata parser.

The 360 video reception apparatus according to the present invention may have embodiments corresponding to the 360 video transmission apparatus according to the present invention described above. The 360 video reception apparatus and the internal/external components thereof according to the present invention may carry out embodiments corresponding to the embodiments of the 360 video transmission apparatus according to the present invention described above.

The embodiments of the 360 video reception apparatus according to the present invention described above may be combined with each other. In addition, the internal/external components of the 360 video reception apparatus according to the present invention may be added, changed, replaced or omitted according to the embodiments. In addition, the internal/external components of the 360 video reception apparatus described above may be implemented as hardware components.

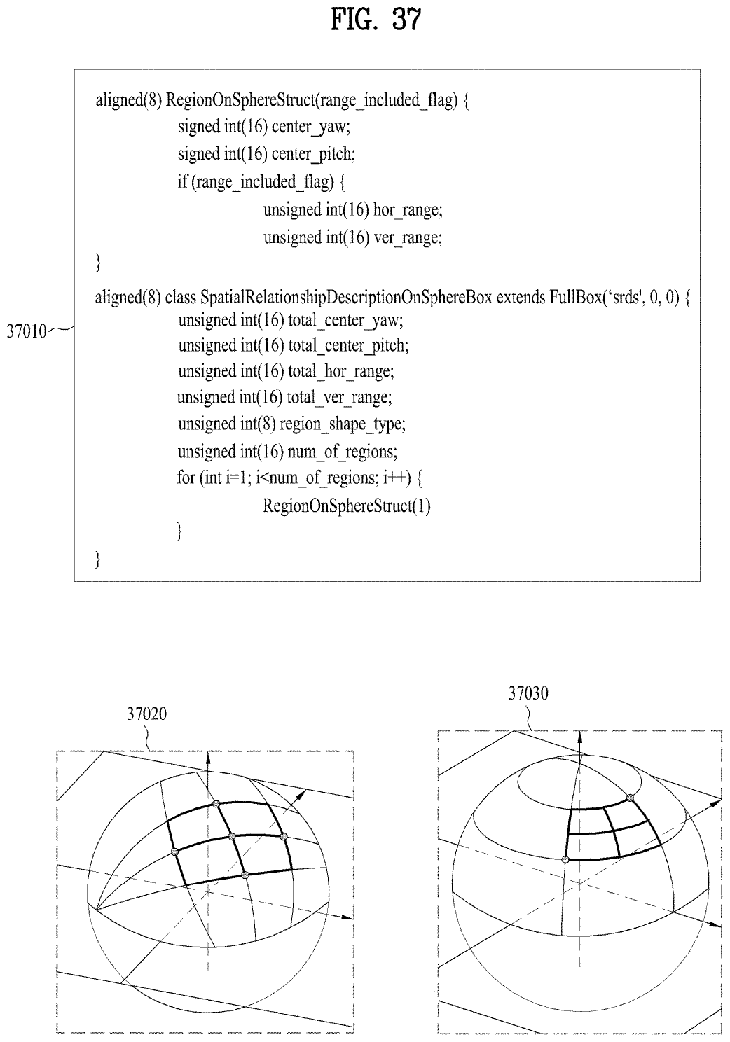

FIG. 37 shows an embodiment of the coverage information according to the present invention.

The coverage information according to the present invention may indicate a region occupied by a sub-picture of the above-mentioned picture in a 3D space as described above. According to an embodiment, the coverage information may indicate a region occupied by one region of the picture, which is not a sub-picture, in the 3D space.

As described above, the coverage information may include information for specifying the region, information for specifying the shape of the region, and/or information indicating whether the 360 video of the region is a 3D video, and/or information indicating whether the 360 video is left/right views.

In one embodiment 37010 of the illustrated coverage information, the coverage information may be defined by SpatialRelationshipDescriptionOnSphereBox. SpatialRelationshipDescriptionOnSphereBox may be defined as a box that may be represented by srds and be included in an ISOBMFF file. Depending on the embodiment, this box may be within the visual sample entry of a track in which each region is stored/transmitted. Depending on the embodiment, this box may be within another box, such as the Scheme Information box.

Specifically, SpatialRelationshipDescriptionOnSphereBox may include total_center_yaw, total_center_pitch, total_hor_range, total_ver_range, region_shape_type, and/or num_of_region fields.

The total_center_yaw field may indicate a yaw (longitude) value of the center point of the entire 3D spatial region (3D geometry surface) to which a corresponding region (tile according to an embodiment) belongs.

The total_center_pitch field may indicate a pitch (latitude) value of the center point of the entire 3D spatial region to which the corresponding region belongs.

The total_hor_range field may indicate a range of yaw values of the entire 3D spatial region to which the region belongs.

The total_ver_range field may indicate a range of pitch values of the entire 3D spatial region to which the region belongs.

The region_shape_type field may indicate the shapes that the regions have. The shape of the region may be one of a shape specified by four great circles or a shape specified by two yaw circles and two pitch circles. When the value of this field is 0, the regions may have a shape such as a region surrounded by the four great circles (37020). In this case, one region may represent one cube face such as a front face, a back face, a back face, and the like. When the value of this field is 1, the regions may have a shape such as a region surrounded by two yaw circles and two pitch circles (37030).

The num_of_region field may indicate the number of corresponding regions that the SpatialRelationshipDescriptionOnSphereBox is intended to represent. Depending on the value of this field, SpatialRelationshipDescriptionOnSphereBox may include RegionOnSphereStruct( ) for each of the regions.

RegionOnSphereStruct( ) may represent information about the region. RegionOnSphereStruct( ) may include center_yaw, center_pitch, hor_range, and/or ver_range fields.

The center_yaw and center_pitch fields may indicate the yaw and pitch values of the center point of the region. The range_included_flag field may indicate whether RegionOnSphereStruct( ) includes hor_range and ver_range fields. Depending on the range_included_flag field, RegionOnSphereStruct( ) may include the hor_range and ver_range fields.

The hor_range and ver_range fields may indicate the width and height of the region. This width and height may be based on the specified center point of the region. The coverage occupied by the region in the 3D space may be specified by the position, width, and height of the center point.

According to an embodiment, RegionOnSphereStruct( ) may further include a center roll field. The center_yaw, center_pitch, and center_roll fields may indicate the yaw, pitch, and roll values of the point corresponding to the center of the region based on the coordinate system specified in the ProjectionOrientationBox in units of 2⁻¹⁶ degrees. According to an embodiment, RegionOnSphereStruct( ) may further have an interpolate field. The interpolate field may have a value of 0.

According to an embodiment, the center_yaw may range from 180*2¹⁶ to 180*2¹⁶¹. The center_pitch may range from 90*2¹⁶ to 90*2¹⁶¹. The center roll may range from 180*2¹⁶ to 180*2¹⁶¹.

According to an embodiment, the hor_range and ver_range fields may indicate the width and height of the region in units of 2⁻¹⁶ degrees. According to an embodiment, hor_range may range from 1 to 720*2¹⁶. ver_range may range from 1 to 180*2¹⁶.

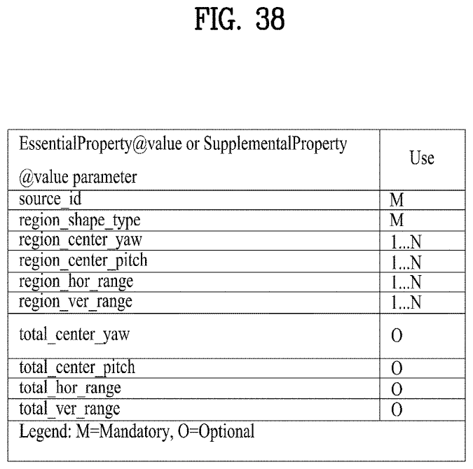

FIG. 38 shows another embodiment of the coverage information according to the present invention.

In another embodiment of the illustrated coverage information, the coverage information may take the form of a DASH descriptor. As described above, when 360 video data is divided into regions and transmitted, the 360 video data may be transmitted through the DASH. Here, the coverage information may be delivered in the form of an Essential Property or Supplemental Property descriptor of DASH MPD.

The descriptor including the coverage information may be identified by new schemeIdURI such as “urn:mpeg:dash:mpd:vr-srd:201x”. In addition, this descriptor may be positioned within the Adaptation Set, Representation, or Sub Representation in which each region is stored/transmitted.

Specifically, the illustrated descriptor may include source_id, region_shape_type, region_center_yaw, region_center_pitch, region_hor_range, region_ver_range, total_center_yaw, total_center_pitch, total_hor_range, and/or total_ver_range parameters.

The source_id parameter may indicate an identifier for identifying source 360 video content of the corresponding regions. Regions from the same 360 video content may have the same source_id parameter values.

The region_shape_type parameter may be the same as the region_shape_type field described above.

A plurality of sets of the region_center_yaw and region_center_pitch parameters, which indicate the yaw (longitude) and pitch (latitude) values of the center point of the N-th region, respectively, may be included.

A plurality of sets of the region_hor_range and region_ver_range parameters, which indicate a yaw value range and a pitch value range of the N-th region, respectively, may be included.

The total_center_yaw, total_center_pitch, total_hor_range and total_ver_range parameters may be the same as the total_center_yaw, total_center_pitch, total_hor_range, and total_ver_range fields described above.

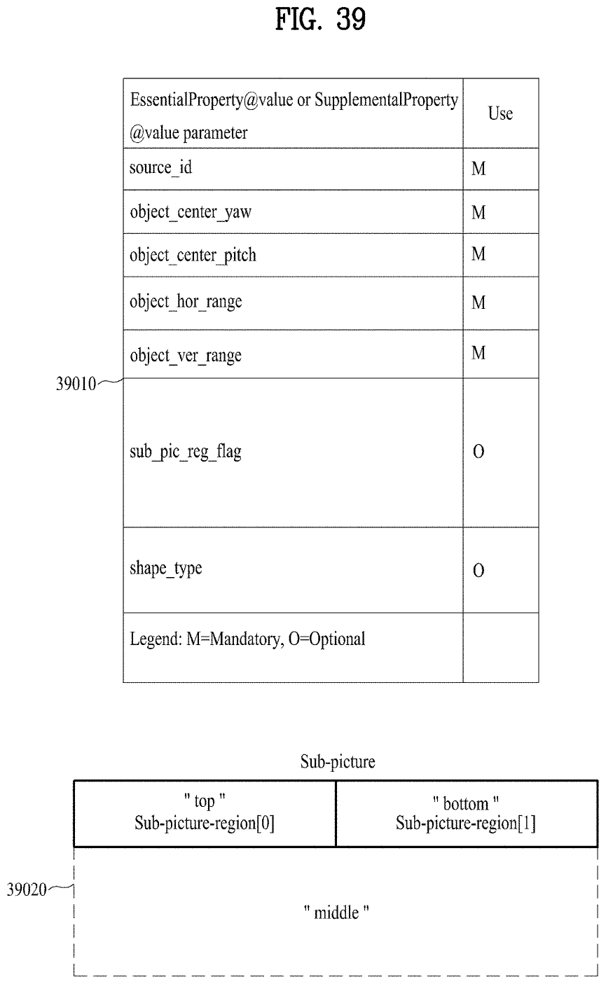

FIG. 39 shows still another embodiment of coverage information according to the present invention.

In another embodiment 39010 of the illustrated coverage information, the coverage information may take the form of a DASH descriptor. Like the above-described coverage information, the DASH descriptor may provide information indicating the spatial relationship between the regions. This descriptor may be identified by schemeIdURI such as “urn:mpeg:dash:spherical-region:201X.”

As described above, the coverage information may be delivered in the form of the Essential Property or Supplemental Property descriptor of DASH MPD. In addition, this descriptor may be positioned within the Adaptation Set, Representation, or Sub Representation in which each region is stored/transmitted. According to an embodiment, the DASH descriptor of the illustrated embodiment may be present only within the Adaptation Set or Sub Representation.

Specifically, the illustrated descriptor 39010 may include source_id, object_center_yaw, object_center_pitch, object_hor_range, object_ver_range, sub_pic_reg_flag, and/or shape_type_parameters.

The source_id parameter may be an identifier for identifying the source of the corresponding VR content. This parameter may be the same as the above-mentioned parameter of the same name. According to an embodiment, this parameter may have a non-negative integer value.

The object_center_yaw and object_center_pitch parameters may indicate the yaw and pitch values of the center of a corresponding region, respectively. Here, according to an embodiment, the corresponding region may refer to a region for which a corresponding object (video region) is projected onto a spherical surface.

The object_hor_range and object_ver_range parameters may indicate the width and height of the corresponding region, respectively. These parameters may indicate the range of the yaw value and the range of the pitch value in degrees, respectively.

The sub_pic_reg_flag parameter may indicate whether the corresponding region is a whole sub-picture arranged on the spherical surface. If the value of this parameter is 0, the region may correspond to one whole sub-picture. If the value of this parameter is 1, the region may correspond to a sub-picture region in one sub-picture. A sub-picture or tile may be divided into a plurality of sub-picture regions (39020). One sub-picture may include a ‘top’ sub-picture region and a ‘bottom’ sub-picture region. In this case, the descriptor 39010 may describe a sub-picture region, that is, the corresponding region. In this case, the Adaptation Set or Sub Representation may include a plurality of descriptors 39010 to describe each of the sub-picture regions. The sub-picture region may be different from the region in the region-wise packing described above.

The shape_type parameter may be the same as the region_shape_type field described above.

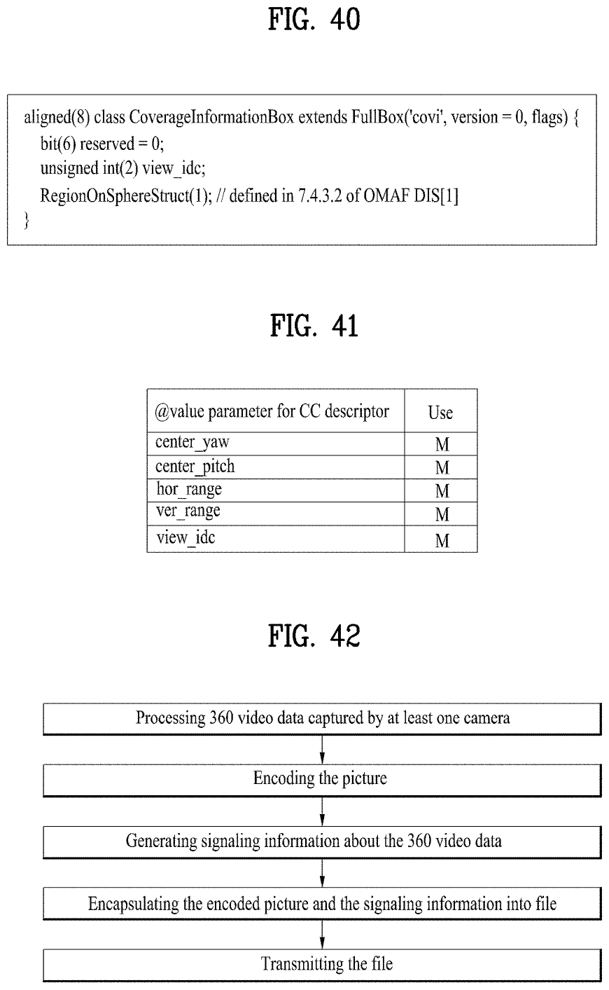

FIG. 40 shows yet another embodiment of the coverage information according to the present invention.

As described above, 360 video may be provided as 3D video. Such 360 video may be called 3D 360 video or stereoscopic omnidirectional video.

When the 3D 360 video is delivered through a plurality of sub-picture tracks, each track may carry a left or right view of the video regions. Alternatively, each track may carry a left view and a right view of a region at the same time. When the left and right views are separated into different sub-pictures and transmitted, a receiver supporting only 2D may reproduce the 360 video data in 2D using only one of the views.

According to an embodiment, when one sub-picture track carries both left and right views of a region having the same coverage, the number of video decoders required to decode the sub-picture bitstreams corresponding to the current viewport of the 3D 360 video may be limited.

In another embodiment of the illustrated coverage information, in order to select a sub-picture bitstream of the 3D 360 video corresponding to the viewport, coverage information about a region of the spherical surface related to each track may be provided.

Specifically, for the composition and coverage signaling of the sub-picture of 3D 360 video, the coverage information of the illustrated embodiment may further include view_idc information. The view_idc information may be additionally included in all other embodiments of the above-described coverage information. According to an embodiment, the view_idc information may be included in CoverageInformationBox and/or a content converge (CC) descriptor.

The coverage information of the illustrated embodiment may be presented in the form of CoverageInformationBox. CoverageInformationBox may additionally include a view_idc field in the existing RegionOnSphereStruct( ).

The view_idc field may indicate whether the 360 video of the region is a 3D video and/or whether it is left/right views. When this field is 0, the 360 video of the region may be a 2D video. When this field is 1, the 360 video of the region may be the left view of a 3D video. When this field is 2, the 360 video of the region may be the right view of the 3D video. When this field is 3, the 360 video of the region may be the left and right views of the 3D video.

RegionOnSphereStruct( ) may be as described above.

FIG. 41 shows yet another embodiment of the coverage information according to the present invention.

In yet another embodiment of the illustrated coverage information, the view_idc information may be added as a parameter to the coverage information composed as a DASH descriptor.

Specifically, the DASH descriptor of the illustrated embodiment may include center_yaw, center_pitch, hor_range, ver_range, and/or view_idc parameters. The center_yaw, center_pitch, hor_range, and ver_range parameters may be the same as the center_yaw, center_pitch, hor_range, and ver_range fields described above.

Similar to the view_idc field described above, the view_idc parameter may indicate whether the 360 video of the corresponding region is a 3D video and/or whether it is left/right views. The meanings assigned to the values of this parameter may be the same as those of the view_idc field described above.

The embodiments of the coverage information according to the present invention described above may be combined with each other. In the embodiments of the 360 video transmission apparatus and the 360 video reception apparatus according to the present invention, the coverage information may be the coverage information according to the above-described embodiments.

FIG. 42 illustrates one embodiment of a method for transmitting a 360 video, which may be carried out by the 360 video transmission apparatus according to the present invention.

One embodiment of a method for transmitting a 360 video may include processing 360 video data captured by at least one camera, encoding the picture, generating signaling information about the 360 video data, encapsulating the encoded picture and the signaling information into a file, and/or transmitting the file.

The video processor of the 360 video transmission apparatus may process 360 video data captured by at least one camera. In this processing operation, the video processor may stitch the 360 video data and project the stitched 360 video data onto a picture. According to an embodiment, the video processor may perform region-wise packing of mapping the projected picture to a packed picture.

The data encoder of the 360 video transmission apparatus may encode the picture. The metadata processor of the 360 video transmission apparatus may generate signaling information about the 360 video data. Here, the signaling information may include coverage information indicating a region occupied by a sub-picture of the picture in a 3D space. The encapsulation processor of the 360 video transmission apparatus may encapsulate the encoded picture and the signaling information into a file. The transmission unit of the 360 video transmission apparatus may transmit the file.

In another embodiment of the method for transmitting a 360 video, the coverage information may include information indicating a yaw value and a pitch value of a point that is the center of the corresponding region in the 3D space. In addition, the coverage information may include information indicating a width and a height that the region has in 3D space.

In another embodiment of the method for transmitting a 360 video, the coverage information may further include information indicating whether the region has a shape specified by 4 great circles, or a shape specified by two yaw circles and two pitch circles.

In another embodiment of the method for transmitting a 360 video, the coverage information may further include information indicating whether the 360 video corresponding to the region is a 2D video, a left view of a 3D video, or a right view of a 3D video, or include both the left and right views of the 3D video.

In another embodiment of the method for transmitting a 360 video, the coverage information may be generated in the form of a Dynamic Adaptive Streaming over HTTP (DASH) descriptor, included in the Media Presentation Description (MPD), and transmitted through a separate path different from the path for the file having the 360 video data.

In another embodiment of the method for transmitting a 360 video, the 360 video transmission apparatus may further include a (transmission side) feedback processor. The (transmission side) feedback processor may receive feedback information indicating the viewport of the current user from the reception side.

In another embodiment of the method for transmitting a 360 video, the sub-picture may be a sub-picture corresponding to the viewport of the current user indicated by the received feedback information, and the coverage information may be coverage information about a sub-picture corresponding to the viewport indicated by the feedback information.

The above-described 360 video reception apparatus according to the present invention may carry out a method for receiving a 360 video. The method for receiving the 360 video may have embodiments corresponding to the above-described method for transmitting a 360 video according to the present invention. The method for receiving a 360 video and embodiments thereof may be carried out by the 360 video reception apparatus and the internal/external components thereof according to the present invention described above.

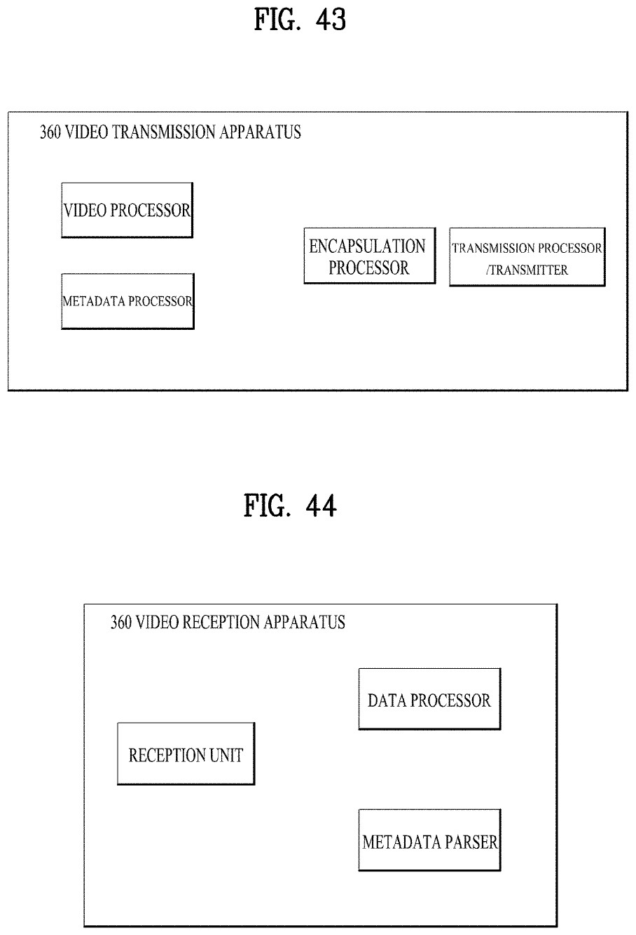

FIG. 43 is a diagram illustrating a 360 video transmission apparatus according to one aspect of the present invention.

In accordance with one aspect, the present invention may relate to a 360 video transmission apparatus. The 360 video transmission apparatus may process 360 video data, generate signaling information about the 360 video data, and transmit the signaling information to the reception side.

Specifically, the 360 video transmission apparatus may stitch a 360 video, project the video onto a picture, perform region-wise packing, process the video in a format according to DASH, generate signaling information about the 360 video data, and transmit the 360 video data and/or the signaling information over a broadcast network or broadband.

The 360 video transmission apparatus according to the present invention may include a video processor, a metadata processor, an encapsulation processor, and/or a transmission unit as internal/external components.

The video processor may process 360 video data captured by at least one camera. The video processor may stitch the 360 video data and project the stitched 360 video data onto a 2D image, i.e., a picture. Here, the projected picture may be called a first picture. According to an embodiment, the video processor may further perform region-wise packing by mapping the respective regions of the projected picture to a packed picture. Here, the packed picture may be referred to as a second picture. Here, the stitching, projection, and region-wise packing may correspond to the above-described processes of the same names. The region-wise packing may be referred to as region-by-region packing, region-specific packing, or the like_depending on the embodiment. The video processor may be a hardware processor that performs functions corresponding to the stitcher, the projection processor, the region-wise packing processor, and/or the data encoder described above.

The encapsulation processor may process the processed 360 video data into data in a Dynamic Adaptive Streaming over HTTP (DASH) format. The encapsulation processor may process the projected picture (first picture) or the packed picture (second picture) obtained through region-wise packing into data in the DASH format. The encapsulation processor may process the 360 video data into DASH segments, i.e., DASH representations. The encapsulation processor may correspond to the encapsulation processor described above.

The metadata processor may generate signaling information for the 360 video data. The metadata processor may generate signaling information about the 360 video data in the form of Media Presentation Description (MPD). The MPD may include signaling information about the 360 video data transmitted in the DASH format. The metadata processor may correspond to the metadata processor described above.

The transmission unit may transmit the 360 video data and the signaling information. Here, the transmission unit may transmit the DASH representations and the MPD. The transmission unit may be a component corresponding to the transmission processor and/or the transmission unit described above. The transmission unit may transmit the information over a broadcasting network or broadband.

In one embodiment of the 360 video transmission apparatus according to the present invention, the MPD described above may include a first descriptor. The first descriptor may provide signaling information about the above-described projection operation. The first descriptor may include information indicating a projection type used when the 360 video data is projected onto the first picture.

In another embodiment of the 360 video transmission apparatus according to the present invention, the information indicating the above-mentioned projection type may indicate whether the projection is equirectangular projection or cubemap projection. The information indicating the projection type may indicate another projection type.

In another embodiment of the 360 video transmission apparatus according to the present invention, the MPD described above may include a second descriptor. The second descriptor may provide signaling information about the above-described region-wise packing operation. The second descriptor may include information indicating a packing type used when the region-wise packing from the first picture into the second picture is performed.

In another embodiment of the 360 video transmission apparatus according to the present invention, the above-mentioned information indicating the packing type may indicate that the region-wise packing has a rectangular region-wise packing type. The information indicating the packing type may indicate that the region-wise packing has another packing type.

In another embodiment of the 360 video transmission apparatus according to the present invention, the MPD described above may include a third descriptor. The third descriptor may include information about the coverage of the 360 video data. The coverage information may indicate a region occupied by the entire region corresponding to 360 video data in 3D space. This coverage information may indicate a region occupied by the 360 video content in the 3D space when the entire 360 video content is rendered in the 3D space.

In another embodiment of the 360 video transmission apparatus according to the present invention, the above-described coverage information may specify a region occupied by the entire region in the 3D space, by indicating the center point coordinates and/or the horizontal range and the vertical range of the region. Where the center point of the region may be specified by azimuth and elevation values. According to an embodiment, the center point may be specified by yaw and pitch values. Here, the horizontal range and the vertical range may be expressed as a range of angles. According to an embodiment, the horizontal range and the vertical range may be represented by a width and a height.

In another embodiment of the 360 video transmission apparatus according to the present invention, at least one of the above-mentioned DASH representations may be a timed metadata representation including timed metadata. The timed metadata may provide metadata about the 360 video data that is transmitted through other DASH representations.

In another embodiment of the 360 video transmission apparatus according to the present invention, the timed metadata may include initial viewpoint or initial viewing orientation information. The initial viewpoint or initial viewpoint information may indicate a viewpoint that the user first sees when the corresponding 360 content is started. As described above, the viewpoint may be the center point of the initial viewport.

In another embodiment of the 360 video transmission apparatus according to the present invention, the timed metadata including the initial view point information may indicate a DASH representation having 360 video data to which the initial view point information is to be applied. The timed metadata including the initial view point information may include identifier information for the DASH representation. Through this identifier information, the DASH representation to be associated with the initial view point information may be identified/indicated.

In another embodiment of the 360 video transmission apparatus according to the present invention, the timed metadata described above may include recommended viewport information. The recommended viewport information may indicate a viewport recommended by the service provider in the corresponding 360 content.

In another embodiment of the 360 video transmission apparatus according to the present invention, the timed metadata including the recommended viewport information may indicate a DASH representation having 360 video data to which the recommended viewport information is to be applied. The timed metadata including the recommended viewport information may include identifier information for the DASH representation. Through this identifier information, the DASH representation to be associated with the recommended viewport information may be identified/indicated.

In another embodiment of the 360 video transmission apparatus according to the present invention, a signaling field that simultaneously indicates whether the 360 video data is a monoscopic 360 video or a stereoscopic 360 video, and when the 360 video data is stereoscopic 360 video data, whether the 360 video data is a left view or a right view, or includes both the left and right views may be defined. That is, the signaling field may simultaneously indicate frame packing arrangement information and stereoscopic 360 video information about the 360 video data. The first descriptor, the second descriptor, and/or the third descriptor described above may each include the signaling field indicating the above-described details about the related 360 video data. This signaling field may correspond to the view_idc field.

In another embodiment of the 360 video transmission apparatus according to the present invention, the monoscopic 360 video data may refer to 360 video data provided in 2 dimensions (2D). The stereoscopic 360 video data may refer to 360 video data that may be provided in 3D. The stereoscopic 360 video data may also be provided in 2D, depending on the capability of the receiver.

The above-described embodiments of the 360 video transmission apparatus according to the present invention may be combined with each other. In addition, the internal/external components of the 360 video transmission apparatus described above according to the present invention may be added, changed, replaced or omitted according to embodiments. In addition, the internal/external components of the 360 video transmission apparatus described above may be implemented as hardware components.

FIG. 44 is a diagram illustrating a 360 video reception apparatus according to another aspect of the present invention.

In accordance with another aspect, the present invention may relate to a 360 video reception apparatus. The 360 video reception apparatus may receive and process 360 video data and/or signaling information about the 360 video data and render the 360 video for the user. The 360 video reception apparatus may be a reception side apparatus corresponding to the above-described 360 video transmission apparatus.

Specifically, the 360 video reception apparatus may receive 360 video data and/or signaling information about the 360 video data, acquire the signaling information, process the 360 video data based on the signaling information, and render a 360 video.

The 360 video reception apparatus according to the present invention may include a reception unit, a data processor, and/or a metadata parser as internal/external components.

The reception unit may receive 360 video data and/or signaling information about the 360 video data. According to an embodiment, the reception unit may receive the information in the form of a DASH representation and an MPD. According to an embodiment, the reception unit may receive the information over a broadcasting network or broadband. The reception unit may be a component corresponding to the reception unit described above.

The data processor may acquire the 360 video data and/or the signaling information about the 360 video data from the received file or the like. The data processor may process the received information according to a transport protocol, decapsulate the DASH segments of the DASH representation, or decode the 360 video data. The data processor may also perform re-projection of 360 video data and then perform corresponding rendering. The data processor may be a hardware processor that performs functions corresponding to the reception processor, the decapsulation processor, the data decoder, the re-projection processor, and/or the renderer described above.

The metadata parser may parse the signaling information from the acquired MPD. The metadata parser may correspond to the above-described metadata parser.

The 360 video reception apparatus according to the present invention may have embodiments corresponding to the 360 video transmission apparatus according to the present invention described above. The 360 video reception apparatus and the internal/external components thereof according to the present invention may carry out embodiments corresponding to the embodiments of the 360 video transmission apparatus according to the present invention described above.

The embodiments of the 360 video reception apparatus according to the present invention described above may be combined with each other. In addition, the internal/external components of the 360 video reception apparatus according to the present invention may be added, changed, replaced or omitted according to the embodiments. In addition, the internal/external components of the 360 video reception apparatus described above may be implemented as hardware components.

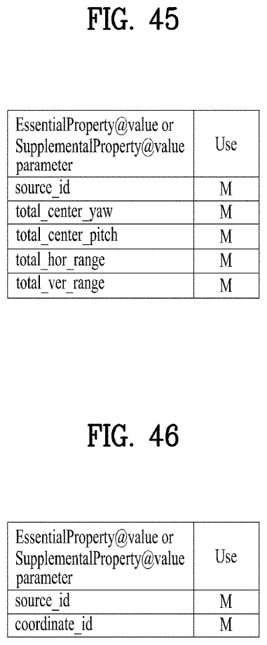

FIG. 45 shows an embodiment of a coverage descriptor according to the present invention.

In the present invention, when 360 video data is transmitted according to the DASH, signaling information about the 360 video data may be defined.

The signaling information about the 360 video data may include an indication of whether the 360 video is fisheye content, an indication of the projection type and/or mapping type for the 360 video if the 360 video is not fisheye content, a region of on the spherical surface covered by the content of the data, and information about the initial view point when the 360 video data starts to be rendered and/or the recommended view point.

In order for such signaling to be implemented in DASH, various kinds of signaling information may be defined in the form of a DASH descriptor. According to the present invention, a fisheye 360 video indication descriptor, a projection descriptor, a packing descriptor and/or a coverage descriptor may be defined.

The fisheye 360 video indication descriptor (not shown) according to the present invention may include fisheye 360 video indication-related information. The fisheye 360 video indication descriptor is a DASH descriptor and may be used to indicate whether the 360 video content is fisheye content.

In one embodiment of the fisheye 360 video indication descriptor, the fisheye 360 video indication descriptor may be identified by new schemIdURI such as “urn:mpeg:dash:omv-fisheye:201x.” _If the value of @value of this descriptor is 1, this may indicate that the 360 content is fisheye content. The fisheye 360 video indication descriptor may be delivered in the form of a Essential Property or Supplemental Property descriptor of DASH MPD. In addition, this descriptor may be positioned within the Adaptation Set, Representation, or Sub Representation in which the video data is stored/transmitted.

The projection descriptor (not shown) according to the present invention may include projection-related information. The projection descriptor is a DASH descriptor and may be used to indicate the projection format of the 360 video data. The projection descriptor may be referred to as a first descriptor.

In one embodiment of the projection descriptor, the projection descriptor may be identified by new schemIdURI such as “urn:mpeg:dash:omv-proj:201x.” _The value of @value of this descriptor may indicate the projection format used when the 360 video data is projected onto a picture. The @value of this descriptor may have the same meaning as projection_type of ProjectionFormatBox. The projection descriptor may be delivered in the form of an Essential Property or Supplemental Property descriptor of DASH MPD. In addition, this descriptor may be positioned within the Adaptation Set, Representation, or Sub Representation in which the video data is stored/transmitted.

According to an embodiment, the projection descriptor may indicate whether the projection type used in the projection operation is equirectangular projection or cubemap projection. The projection descriptor may indicate another projection type.

The packing descriptor (not shown) according to the present invention may include packing-related information. The packing descriptor is a DASH descriptor and may be used to indicate the packing format of the 360 video data. The packing descriptor may be referred to as a second descriptor.

In one embodiment of the packing descriptor, the packing descriptor may be identified by new schemIdURI such as “um:mpeg:dash:omv-pack:201x.” The value of @value of this descriptor may indicate the packing format used when region-wise packing of the 360 video data is performed from the first picture to the second picture. The value of @value of this descriptor may be a list of packing type values of RegionWisePackingBox separated by commas. The packing descriptor may be delivered in the form of an Essential Property or Supplemental Property descriptor of DASH MPD. In addition, this descriptor may be positioned within the Adaptation Set, Representation, or Sub Representation in which the video data is stored/transmitted.

According to an embodiment, the packing descriptor may indicate that the packing type used in the region-wise packing operation has a rectangular region-wise packing type. The packing descriptor may indicate that the region-wise packing has another packing type.

The coverage descriptor according to the present invention may include coverage-related information. The coverage descriptor is a DASH descriptor and may indicate a region of the 3D space occupied by the entire region corresponding to the 360 video data. That is, the coverage descriptor may indicate a region of the 3D space occupied by the 360 video content when the entire 360 video content is rendered in the 3D space. The coverage descriptor may be referred to as a third descriptor.

In one embodiment of the illustrated coverage descriptor, the coverage descriptor may be identified by new schemIdURI such as “urn:mpeg:dash:omv-coverage:201x.”_The value of @value of this descriptor may indicate a region of the 3D space occupied by the region corresponding to the 360 video data. The value of @value of this descriptor may be a list of CoverageInformationBox values separated by commas. The coverage descriptor may be delivered in the form of an Essential Property or Supplemental Property descriptor of DASH MPD. In addition, this descriptor may be positioned within the Adaptation Set, Representation, or Sub Representation in which the video data is stored/transmitted.

In one embodiment of the illustrated coverage descriptor, the coverage descriptor may include source_id, total_center_yaw, total_center_pitch, total_hor_range, and/or total_ver_range parameters.

The source_id parameter may indicate an identifier for identifying the source 360 video content. This parameter may be a non-negative integer.

The total_center_yaw and total_center_pitch parameters may indicate the coordinates of the center point (middle point) of the spherical surface onto which the entire 360 video content is projected. According to an embodiment, the parameters may indicate yaw and pitch values of the center point, respectively. According to an embodiment, the parameters may indicate longitude and latitude values of the center point, respectively. According to an embodiment, the parameters may indicate azimuth and elevation values of the center point, respectively.

The total_hor_range and total_ver_range parameters may indicate the horizontal and vertical ranges of the spherical surface onto which the entire 360 video content is projected. The horizontal range and the vertical range may be expressed as a range of angles. According to an embodiment, the horizontal range and the vertical range may be represented by a width and a height. According to the embodiment, the parameters may have the same meaning as hor_range and ver_range of CoverageInformationBox described above.

The above-described embodiments of the fisheye 360 video indication descriptor according to the present invention may be combined with each other. In the embodiments of the 360 video transmission apparatus according to the present invention, the fisheye 360 video indication descriptor may be the fisheye 360 video indication descriptor according to the above-described embodiments.

The above-described embodiments of the projection descriptor according to the present invention may be combined with each other. In the embodiments of the 360 video transmission apparatus according to the present invention, the projection descriptor may be the projection descriptor according to the above-described embodiments.

The above-described embodiments of the packing descriptor according to the present invention may be combined with each other. In the embodiments of the 360 video transmission apparatus according to the present invention, the packing descriptor may be the packing descriptor according to the above-described embodiments.

The above-described of the coverage descriptor according to the present invention may be combined with each other. In the embodiments of the 360 video transmission apparatus according to the present invention, the coverage descriptor may be the coverage descriptor according to the above-described embodiments.

FIG. 46 shows an embodiment of a dynamic region descriptor according to the present invention.

As described above, the initial viewpoint information and/or the recommended viewpoint/viewport information may be provided as signaling information. According to an embodiment, the initial viewpoint information and/or the recommended viewpoint/viewport information may be delivered in the form of timed metadata. At least one of the above-mentioned DASH representations may be a timed metadata representation, which may include the timed metadata.

In this case, a dynamic region descriptor may be used to utilize the initial viewpoint information and/or the recommended viewpoint/viewport information transmitted as the timed metadata.

The dynamic region descriptor may provide information about a region that changes on the spherical surface. The dynamic region descriptor is a DASH descriptor and may be used to provide information about a dynamic region on the spherical surface. The dynamic region descriptor may be identified by new schemIdURI such as “urn:mpeg:dash:dynamic-ros:201x.” The value of @value of this descriptor may be a list of parameter values separated by commas, as shown in the figure. The projection descriptor may be delivered in the form of an Essential Property or Supplemental Property descriptor of DASH MPD. In addition, this descriptor may be positioned within the Adaptation Set or Sub Representation in which the video data is stored/transmitted.

The illustrated dynamic region descriptor may include source_id and/or coordinate_id.

The source_id parameter may indicate an identifier for identifying the source 360 video content. This parameter may be a non-negative integer.

The coordinate_id parameter may indicate a representation of a timed metadata track that carries timed metadata for the spherical surface. That is, this parameter may specify @id of the representation that provides the timed metadata.

This dynamic region descriptor may be used to distinguish the initial viewpoint information and/or the recommended viewpoint/viewport information. That is, the representation over which specific 360 video data is delivered may include a dynamic region descriptor. The dynamic region descriptor may indicate a representation that provides timed metadata about the 360 video data. Here, the timed metadata representation providing the initial viewpoint information and/or the recommended viewpoint/viewport information may be identified by the dynamic region descriptor. Thereby, the initial viewpoint information and/or the recommended viewpoint/viewport information may be associated with the 360 video data.

Here, the initial viewpoint information may indicate a viewpoint that the user first sees when the corresponding 360 content is started. As described above, the viewpoint may be the center point of the initial viewport. Here, the recommended viewport information may indicate a viewport recommended by the service provider in the corresponding 360 content.

The timed metadata representing the initial viewpoint information and/or the recommended viewpoint/viewport information may be provided by the timed metadata representation. The timed metadata representation may provide an invp track. The timed metadata representation may be associated with a representation over which the actual 360 video data associated with the corresponding signaling information is transmitted.

The timed metadata representation including the initial viewpoint information may include @associationId. @associationId may indicate a representation that carries the actual 360 video data to which the initial viewpoint information is applied. That is, @associationId may identify the DASH representation by which the associated actual data is carried. This example is also applicable to the recommended viewpoint/viewport.

According to an embodiment, the timed metadata representation may further include @associationType. @associationType may indicate the type of association between the timed metadata representation and the representation that carries the actual data. If the value of @associationType is cdsc, the timed metadata may describe each media track. Here, the media track may refer to a track carrying the actual data. If the value of @associationType is cdtg, the timed metadata may describe a track group.

The above-described embodiments of the initial viewpoint information and the recommended viewpoint/viewport information according to the present invention may be combined with each other. In the embodiments of the 360 video transmission apparatus according to the present invention, the initial viewpoint information and the recommended viewpoint/viewport information may be the initial viewpoint information and recommended viewpoint/viewport information according to the above-described embodiments.

The above-described embodiments of the method for delivering the initial viewpoint information and the recommended viewpoint/viewport according to the present invention may be combined with each other. In the embodiments of the 360 video transmission apparatus according to the present invention, the method for delivering the initial viewpoint information and the recommended viewpoint/viewport may be the method for delivering the initial viewpoint information and the recommended viewpoint/viewport according to the above-described embodiments.

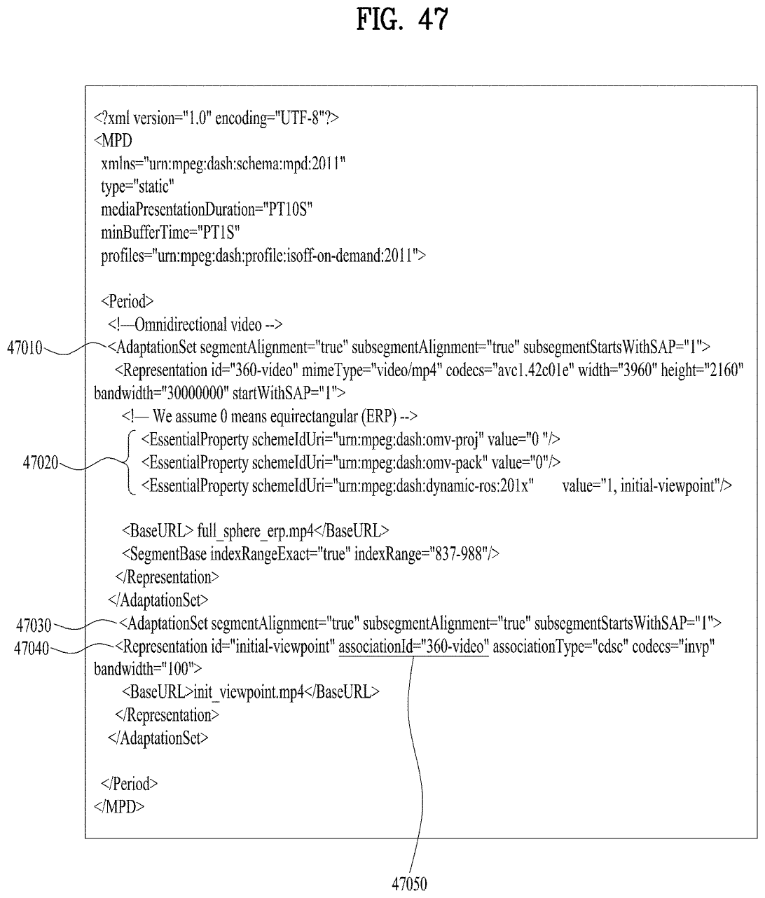

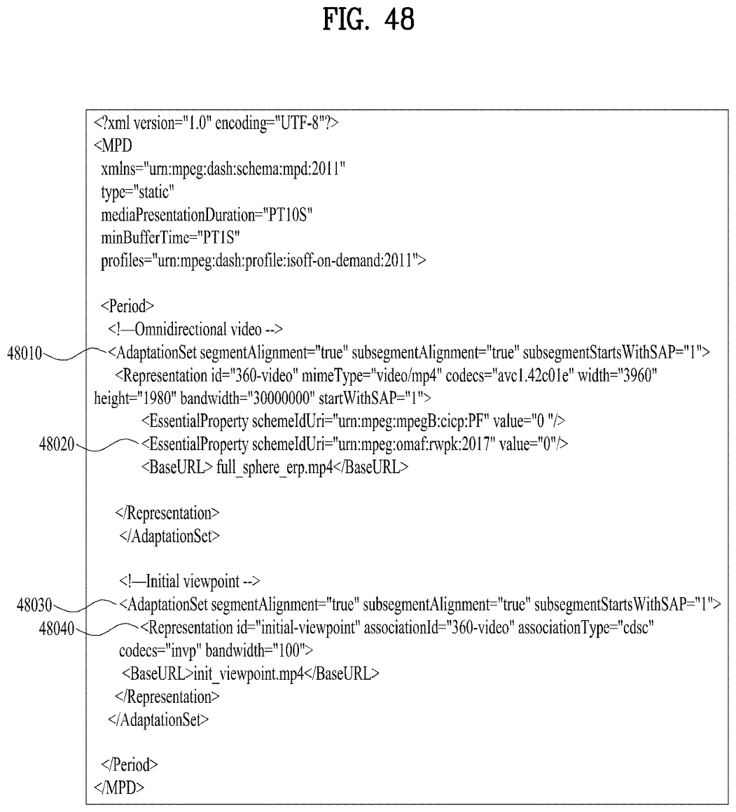

FIG. 47 shows an example of use of initial view point information and/or recommended view point/viewport information according to the present invention.

In the illustrated example of use, the MPD describes two Adaptation Sets for one Period. The first Adaptation Set 47010 may be an adaptation set that carries actual 360 video data and the second Adaptation Set 47030 may be an adaptation set that includes timed metadata that provides initial viewpoint information.

The first Adaptation Set 47010 includes one Representation, which may be a representation having an ID of ‘360-video’. This representation may include DASH descriptors 47020 describing information about the 360 video data being delivered through the representation.

Since these DASH descriptors 47020 are included in the representation level, they may describe 360 video data included in the representation. These descriptors may be a projection descriptor, a packing descriptor, and a dynamic region descriptor.

Since the value of the projection descriptor in the example of use is 0, it can be seen that equirectangular projection has been used for the 360 video data of this representation. Since the value of the packing descriptor is 0, it can be seen that rectangular region-wise packing has been performed on the 360 video data of this representation.

In the dynamic region descriptor in the example of use, the source id may be 1 and coordinate_id may be ‘initial-viewpoint’. Thus, it can be seen that the timed metadata associated with the 360 video data of the representation is provided by a representation identified as ‘initial-viewpoint’.

The second Adaptation Set 47030 also includes one Representation 47040. The Representation 47040 may be a representation having an ID of ‘initial-viewpoint’. This representation may include timed metadata that provides information about the initial viewpoint described above.

The Representation 47040 may have 360-video as the value of associationId 47050. Accordingly, it can be seen that the timed metadata is associated with the representation identified by the ID of 360-video. For the 360 video data of this representation, timed metadata provided by the timed metadata representation 47040 may be applied.

FIG. 48 shows another example of use of initial view point information and/or recommended view point/viewport information according to the present invention.

As described above, when 360 video data is delivered in a DASH format, the signaling information about the 360 video data may be delivered as timed metadata. The timed metadata may be delivered over a representation, which may include an invp track for providing initial viewpoint information and/or an rcvp track for providing recommended viewpoint/viewport information.

In the illustrated example of use, the MPD describes a timed metadata representation that provides one 360 video stream and initial viewpoint information.

In the illustrated example of use, the MPD may describe two Adaptation Sets.

The first Adaptation Set 48010 may be an adaptation set with actual 360 video data. This adaptation set may have a representation identified as ‘360-video’. This representation may carry 360 video data. This representation may include a rwpk descriptor, that is, a descriptor 48020 that provides information about region-wise packing. This descriptor may indicate that no region-wise packing has been performed on the 360 video data of the representation.

The second Adaptation Set 48030 may include timed metadata providing initial viewpoint-related information. This adaptation set may include a timed metadata representation. This representation may be identified by an ID of ‘initial-viewpoint’, and the value of associationId may be ‘360-video’. Based on the associationId value, it can be seen that the timed metadata of this timed metadata representation is applicable to 360 video data of the representation having the ID of ‘360-video’ in the first Adaptation Set 48010.

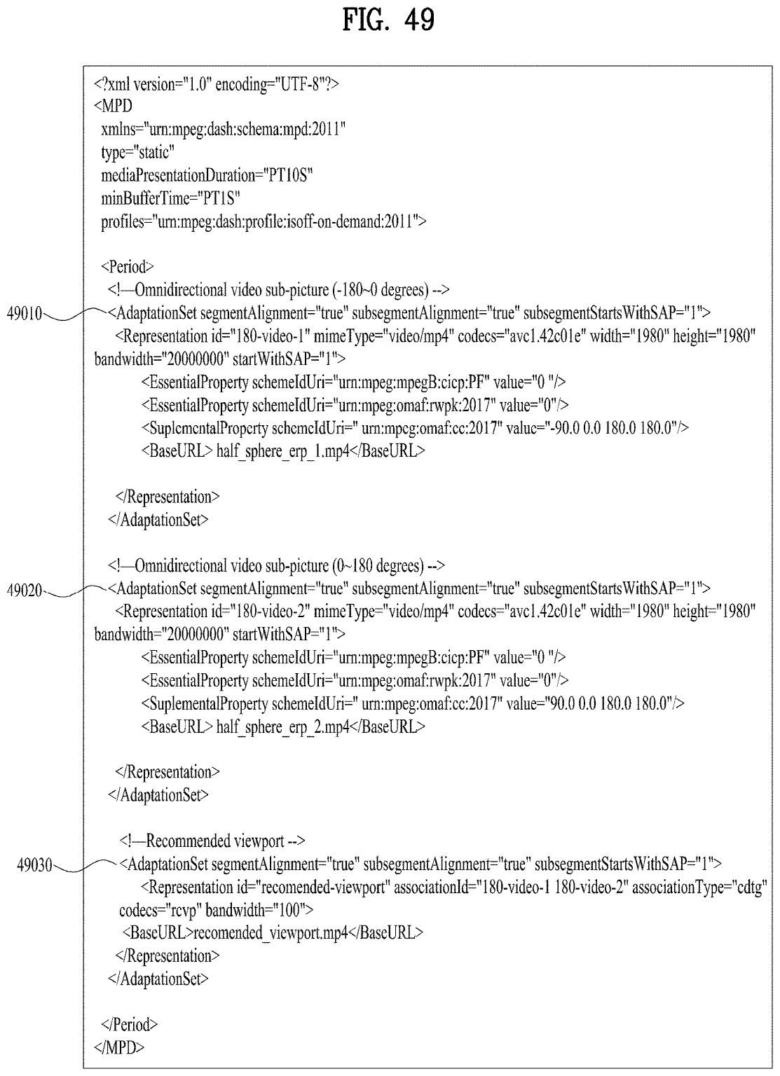

FIG. 49 shows yet another example of use of initial view point information and/or recommended view point/viewport information according to the present invention.

In the illustrated example of use, the MPD describes a timed metadata representation that provides recommended viewport information and two 360 video streams. The two 360 video streams may each carry a sub-picture stream of a 360 video. That is, one video stream may carry one sub-picture of the 360 video data.

In the illustrated example of use, the MPD may describe three Adaptation Sets.

The first Adaptation Set 49010 may be an adaptation set with actual 360 video data. This adaptation set may have a representation identified as ‘180-video-1’. This representation may carry a sub-picture of the 360 video data corresponding to −180 degrees to 0 degrees.

The second Adaptation Set 49020 may be an adaptation set with actual 360 video data. This adaptation set may have a representation identified as ‘180-video-2’. This representation may carry a sub-picture of 360 video data corresponding to 0 degrees to 180 degrees.

The third Adaptation Set 49030 may include timed metadata that provides the recommended viewport-related information. This adaptation set may include a timed metadata representation. This representation may be identified by an ID of ‘recommended-viewport’, and the value of associationId may be ‘180-video-1, 180-video-2’. From the value of associationId, it can be seen that the timed metadata of this timed metadata representation is applicable to the 360 video data of each representation in the first and second Adaptation Sets 49010 and 49020. In this case, the value of assocationType may be cdtg.

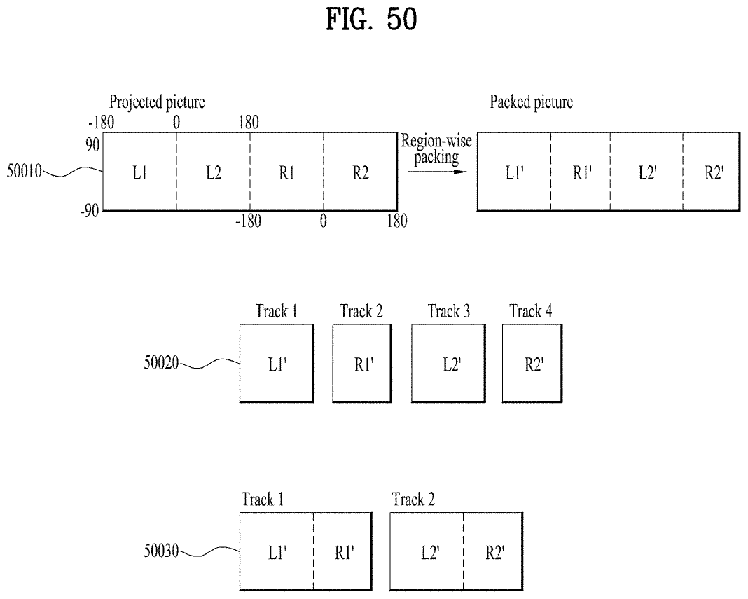

FIG. 50 is a diagram exemplarily illustrating a gap analysis in stereoscopic 360 video data signaling according to the present invention.

As described above, the signaling information about 360 video data may be stored/delivered in the form of a box of ISOBMFF, or may be stored/transmitted in the form of a descriptor of DASH MPD or the like.

In particular, a gap analysis may be performed on the signaling of the frame packing arrangement and the signaling of the view indication in the signaling information about the stereo-scopic 360 video data. Here, in particular, when each signaling information is signaled through ISOBMFF and DASH MPD, the difference may be analyzed.

Here, the frame packing may mean that a plurality of images is mapped to one sub-picture, one track, or the like. For example, when both the left view and the right view are included in one track, it may be said that frame packing has been performed. In this case, the arrangement type including the left view and the right view may be referred to as a frame packing arrangement. In case 50030 shown, it may be said that side-by-side frame packing arrangement is given.

Here, the view indication indicates whether the stereoscopic 360 video data is a left view or a right view, or has both the left view and the right view.

Signaling of frame packing arrangement will be described regarding the stereoscopic 360 video.

For signaling through ISOBMFF, the frame packing arrangement may be indicated through StereoVideoBox of ISOBMFF. Depending on stereo scheme, the frame packing arrangement may be indicated in various manners.

That is, when stereo_scheme is 1, a frame packing scheme according to ISO/IEC 14496-10 may be used. When stereo_scheme is 2, a frame packing scheme according to ISO/IEC 13818-2 may be used. When stereo_scheme is 3, a frame packing scheme according to ISO/IEC 23000-11 may be used.

For example, stereo_scheme having a value of 1 and stereo indication type having a value of 3 may indicate that side-by-side frame packing arrangement is used for the track. This frame packing arrangement may also be indicated by stereo_scheme having a value of 2 and stereo_indication_type having a value of 0000011. This frame packing arrangement may also be indicated by stereo_scheme having a value of 3 and stereo_indication_type having a value of 0x00.

For signaling through DASH MPD, the frame packing arrangement may be indicated by a FramePacking element. This element may identify a frame packing configuration scheme and/or a frame packing arrangement. A DASH client may select or reject an adaptation set based on this element. For example, if the 360 video data of the adaptation set and/or representation has the side-by-side frame packing arrangement, the value of @value of the FramePacking element may be 3.

Next, signaling of view indication regarding the stereoscopic 360 video will be described.

For signaling through ISOBMFF, view indication may be performed by StereoVideoBox. StereoVideoBox may indicate whether the stereoscopic 360 video data delivered by the other tracks of ISOBMFF is a left view or a right view. In this case, the value of scheme type may be 3, and the value of stereo_indication_type may be 0x03. The values may indicate that a stereo scheme defined in ISO/IEC 23000-11 and that the “left/right view sequence type” is applied, respectively.

For signaling through DASH MPD, view indication may be performed by the Role descriptor. @value of the Role descriptor with @schemeUri having the value of “urn:mpeg:dash:stereoid:2011” may be used to indicate a pair of left and right views of a stereoscopic video. For example, if an AdaptationSet element describing any two stream has a Role descriptor with @schemeUri having a value of “urn:mpeg:dash:stereoid:2011” and the value of @value is 10, r0, this may indicate that the streams correspond to the left and right views, respectively. Alternatively, according to an embodiment, a FramePacking element may be used. @value of the FramePacking element may be set to 6 to indicate a configuration. This may indicate “one frame of a frame pair.”

A gap analysis of the signaling methods for stereoscopic video is as follows.

For a stereoscopic 360 video, the projected left and right views may be arranged on a projected picture (first picture). Here, as the arrangement, the top-bottom or side-by-side frame packing arrangement may be used. The stereoscopic arrangement of the projected picture may be indicated by stereo scheme of the StereoVideoBox indicating 4 and stereo_indication_type indicating the frame packing arrangement, as described above. In addition, the stereoscopic arrangement of the projected picture may be indicated by the value of @value of FramePacking of MPD, as described above.

In the case where region-wise packing is performed, the position, resolution, size, and the like of the projected region may different from those of the packed region. The illustrated case 50010 indicate whether the position and/or size of the projected region can be changed before and after region-wise packing. While the projected regions (e.g., L1, L2) of the same view are positioned close to each other on the projected picture, the packed regions may be positioned farther from each other after region-wise packing. In addition, the resolution may change after region-wise packing. In the illustrated case 50010, L1 and R1 have the same resolution, but after the region-wise packing, L1′ has a higher resolution than R1′.

Signaling in a case where one view is stored/transmitted in one sub-picture track will be described.

As shown in 50020, the packed picture in case 50010 may be divided into 4 sub-pictures. The four sub-pictures may be carried by four sub-picture tracks. Here, each track may be a left view or a right view.

In this case, if StereoVideoBox is set to indicate the stereo video arrangement of each sub-picture according to ISOBMFF, scheme type may be 3 and stereo_indication_type may be 0x03.

In this case, if the FramePacking element is set according to the DASH MPD to indicate the stereo video arrangement of each sub-picture, @value of the FramePacking element may be 3 or a Role descriptor conforming to the “urn:mpeg:dash:stereoid:2011” scheme URI may be used.

However, for the stereoscopic 360 video, the StereoVideoBox and FramePacking elements are limited to indicating the frame packing arrangement of the projected left and right views, and thus view indication of an associated sub-picture may not be performed. Accordingly, an extended method may be needed for view information corresponding to the sub-picture of each track.

Signaling in the case where both the left view and the right view are stored/transmitted as one sub-picture track will be described.

As shown in part 50030, the packed pictures of part 50010 may be divided into two sub-pictures. The two sub-pictures may be transmitted in two sub-picture tracks, respectively. Here, each of the sub-picture tracks may include two packed regions corresponding to the right and left views.

In this case, if StereoVideoBox indicates the stereo video arrangement of each sub-picture according to ISOBMFF, it may not indicate that the sub-picture track includes left and right views having different resolutions.

In this case, if the FramePacking element indicates the stereo video arrangement of each sub-picture adaptation set or representation according to the DASH MPD, it may not indicate the adaptation set or representation that carries the left and right views having different resolutions together.

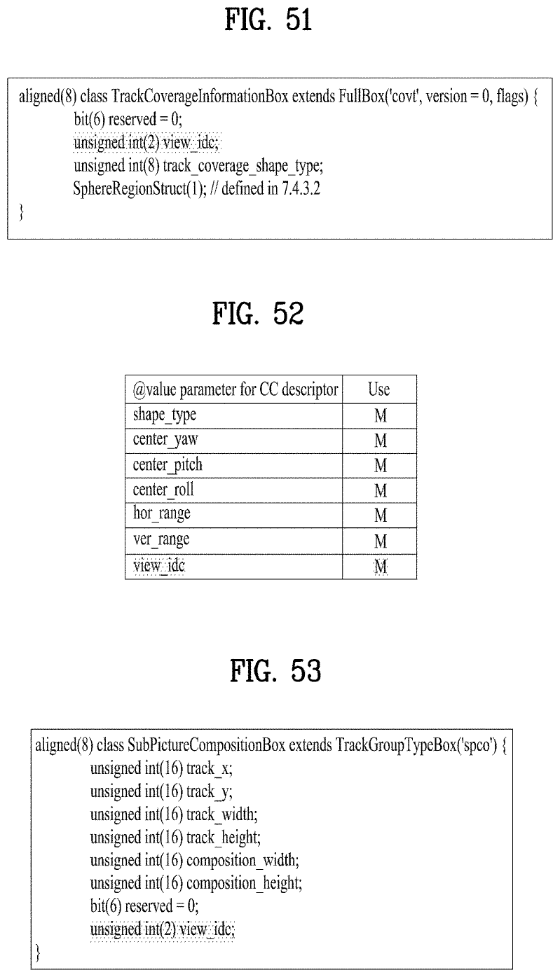

FIG. 51 shows another embodiment of a track coverage information box according to the present invention.

According to the above-described gap analysis, the signaling may be improved. In particular, in the case where a sub-picture track includes left and right view regions of different resolutions, signaling needs to be improved in order to indicate view information corresponding to each sub-picture track.

To this end, the above-described view_idc information may be added to TrackCoverageInformationBox, the content coverage (CC) descriptor, and/or SubPictureCompositionBox described above.

As described above, the view_idc field may indicate whether the 360 video data is stereoscopic 360 video and/or whether it is a left/right view. When this field is 0, the 360 video may be a monoscopic 360 video. When this field is 1, the 360 video may be the left image of a stereoscopic 360 video. When this field is 2, the 360 video may be the right image of the stereoscopic 360 video. When this field is 3, the 360 video may be the left view and the right view of the stereoscopic 360 video.

As shown in the figure, the view_idc field may be added to TrackCoverageInformationBox. Here, the view_idc field may describe the above-described information for a spherical region indicated by the content of the packed pictures of the track.

TrackCoverageInformationBox may further include track_coverage_shape_type and/or SphereRegionStruct.

The track_coverage_shape_type may indicate the shape of the sphere region. This field may be the same as the above-described shape_type.

When SphereRegionStruct is included in TrackCoverageInformationBox, the same content as the RegionOnSphereStruct( ) described above may be described for the sphere region. That is, center_yaw, center_pitch, center_roll, hor_range, ver _range, and/or interpolate in SphereRegionStruct may describe the same contents as those of the above-mentioned RegionOnSphereStruct( ) for the sphere region.

The above-described embodiments of TrackCoverageInformationBox according to the present invention may be combined with each other. In the embodiments of the 360 video transmission apparatus and/or the 360 video reception apparatus according to the present invention, TrackCoverageInformationBox may be the TrackCoverageInformationBox according to the above-described embodiments.

FIG. 52 shows another embodiment of a content coverage descriptor according to the present invention.

The content coverage descriptor may indicate a sphere region covered by the 360 video content. This may be implemented in the form of a DASH descriptor. The content coverage descriptor may be a descriptor that provides the above-described coverage information.

As shown in the figure, a view_idc field may be added to the content coverage descriptor. Here, the view_idc field may describe the above-described information for a spherical region indicated by 360 video data of each representation.

The content coverage descriptor may further include shape_type, center_yaw, center_pitch, center_roll, hor_range, and/or ver_range.

The shape_type may indicate the shape of the sphere region. This field may be the same as the above-described shape_type. This field may be the same as the above-described shape_type.

The center_yaw, center_pitch, center_roll, hor_range, and/or ver_range may indicate the yaw, pitch, roll, horizontal range, and vertical range of the center point of the sphere region, respectively. These values may be presented with respect to global coordinate axes. The horizontal and vertical ranges may be used to indicate the width and height with respect to the center point of the sphere region

The above-described embodiments of the content coverage descriptor according to the present invention may be combined with one another. In the embodiments of the 360 video transmission apparatus and/or the 360 video reception apparatus according to the present invention, the content coverage descriptor may be the content coverage descriptor according to the above-described embodiments.

FIG. 53 shows an embodiment of sub-picture composition box according to the present invention.

SubpictureCompositionBox according to the present invention may include information about sub-picture composition track grouping.

TrackGroupTypeBox with track_group_type having the value of ‘spco’ may indicate whether the track is included in the composition of tracks. Here, the tracks included in the composition may be spatially arranged to acquire a composition picture.

Visual tracks mapped to such grouping of tracks represent visual content that may be collectively presented. Here, the visual tracks mapped to the grouping may refer to visual tracks having the same value of track_group_id in TrackGroupTypeBox with track_group_type having the value of ‘spco’. Each visual track mapped to this grouping may or may not be intended to be presented alone without other visual tracks.

Here, the content creator may use CompositionRestrictionBox to indicate that one visual track is not intended to be reproduced alone without other visual tracks.

Here, if an HEVC video stream is carried through a set of tile tracks and a related tile base track and bitstream represent a sub-picture indicated by the sub-picture composition track group, only the tile base track may include SubpictureCompositionBox.

A composition picture may be derived by arranging time-parallel samples of all tracks in the same sub-picture composition track group in space as indicated by the track group.

In one embodiment of the illustrated SubpictureCompositionBox, a view_idc field may be added to SubpictureCompositionBox. Here, the view_idc field may describe the above-described information for the samples of a corresponding track of the composition picture.

The illustrated SubpictureCompositionBox may further include track_x, track_y, track_width, track_height, composition_width, and/or composition_height.

track_x and track_y may indicate the horizontal position and the vertical position of the top left point of the samples of the corresponding track of the composition picture in luma sample units, respectively. The ranges of these two values may be between 0 and composition_width−1 and between 0 and composition height−1, respectively.

track_width and track_height may indicate the width and height of the samples of the corresponding track of the composition picture in luma sample units, respectively. The ranges of these two values may be between 1 and composition_width−1 and between 1 and composition height−1, respectively.

composition_width and composition_height may indicate the width and height of the composition picture in luma sample units, respectively.

Here, for i having a value between 0 and track width−1, the i-th column of the track samples may be the colComposedPic-th column of luma samples of the composition picture. Here, colComposedPic may be (i+track_x) % composition_width.

Here, for j having a value between 0 and track_height−1, the j-th row of the track samples may be the rowComposedPic-th row of luma samples of the composition picture. Here, rowComposedPic may be (j+track_y) % composition_height.

The above-described embodiments of SubpictureCompositionBox according to the present invention may be combined with each other. In the embodiments of the 360 video transmission apparatus and/or the 360 video reception apparatus according to the present invention, SubpictureCompositionBox may be SubpictureCompositionBox according to the above-described embodiments.

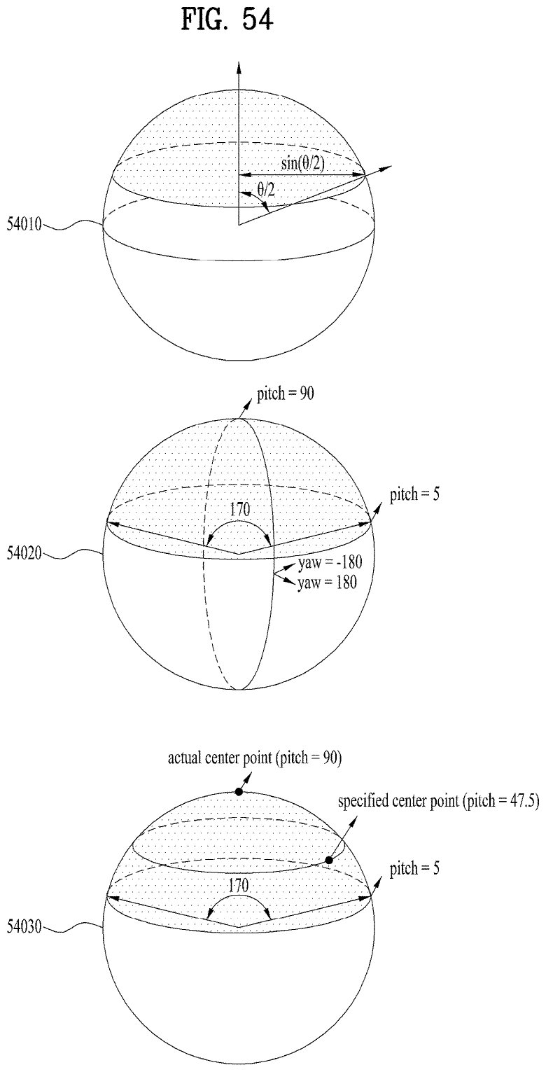

FIG. 54 illustrates an embodiment of a signaling process when fisheye 360 video data according to the present invention is rendered on a spherical surface.

According to an embodiment, the 360 video transmission apparatus may map the circular images acquired by the fisheye lens to a picture, generate signaling information about the fisheye 360 video data corresponding to the circular images, and transmit the data in various forms in various ways. According to an embodiment, the circular image is an image for a 360 video captured by the fisheye lens and may be referred to as a fisheye image or the like.

That is, the video processor may process one or more circular images captured by a camera having at least one fisheye lens. The video processor may map the circular images to a first picture. According to an embodiment, the video processor may map the circular images to the rectangular regions of the first picture. According to an embodiment, this mapping operation may be referred to as “packing” of the circular images.

According to an embodiment, the video processor may not either stitch or region-wise pack the circular images having fisheye 360 video data. That is, the video processor may omit the stitching and region-wise packing operations in processing fisheye lens-based fisheye 360 video data.

For the fisheye 360 video, the sub-picture composition grouping described above may be used. When TrackCoverageInformationBox is used for fisheye 360 video, a sub-picture track carrying the circular images corresponding to the user viewport may be efficiently selected. In addition, when GlobalCoverageInformationBox is used, the full coverage of the entire projected picture to which the fisheye images are mapped may be indicated.

Each circular image of the fisheye 360 video may be mapped to a sphere region. Here, the coverage angle of each circular image may be set as 0. For example, if 0 is 180 degrees, this may mean that the coverage corresponds to a hemisphere. The sphere region may be specified by a small circle. This small circle is a circle having a radius corresponding to sin(θ/2), and may be a circle surrounding the sphere along the latitudinal plane indicated by θ/2 (54010).

Here, when the center point of the circular image is aligned with the north pole of the spherical surface, the sphere region corresponding to the circular image may be indicated by GlobalCoverageInformationBox, or by the TrackCoverageInformationBox in which the value of global_coverage_shape_type or track_coverage_shape_type is 1. Here, the north pole may refer to a point at which the pitch is 90 degrees.

For example, the sphere region of a circular image with a coverage angle of 170 degrees may be defined by two yaw circles and two pitch circles (54020). In the illustrated part 54020, the two yaw circles may have −180 degrees and 180 degrees, respectively. The two yaw circles may overlap each other on the spherical surface as circles passing through the north pole. In addition, in the illustrated part 54020, the two pitch circles may have 5 degrees and 90 degrees, respectively. In other words, these two pitch circles may be one circle surrounding the sphere along the points having a pitch of 5 and one circle substantially indicated as a point on the north pole having the pitch of 90 degrees.

New constraints may be considered to indicate the coverage information about a circular image with shape_type set to 1. For example, to indicate the position of the center point of the circular image at the north pole, ProjectionOrientationBox may be provided for each circular image. In addition, the value of hor range of SphereRegionStruct( ) may need to be constantly set to 360*216, and the value of center_pitch may need to be set to 90*216 minus half the value of ver range. Here, setting the value of center_pitch may be intended to indicate a midpoint between one pitch circle (north pole) and the other pitch circle.

In addition, the center point of a sphere region specified by SphereRegionStruct( ) may be positioned in the middle between the north pole and the other pitch circle. For example, the center point of the sphere region in the illustrated diagram 54020 may be a point on a circle having the pitch of 47.5 degrees (54030).

The center point of the sphere region specified by SphereRegionStruct( ) may be different from the sphere of the actual sphere region. In the illustrated diagram 54030, the center point of the actual sphere region is represented by a point on a circle with pitch=90, while the center point of the sphere region specified by SphereRegionStruct( ) is represented by a point on a pitch circle with pitch=47.5 have. In this case, the position of the wrong center point may have an inaccurate result when applying center_roll.

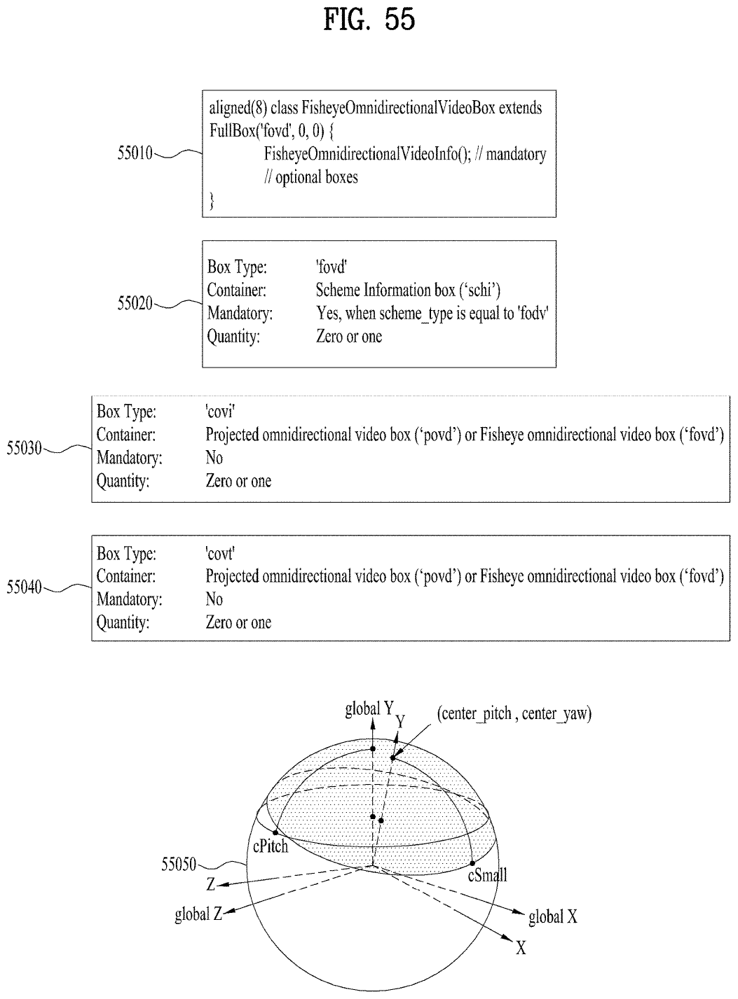

FIG. 55 illustrates an embodiment of signaling information in which new shape_type is defined according to the present invention.

In the present invention, new shape_type values may be defined in GlobalCoverageInformationBox and/or GlobalCoverageInformationBox in order to address the above-mentioned issue. These new shape_type values may be used to indicate the coverage information of the fisheye 360 video.

The proposed new shape_type values may be further defined in the fisheye 360 video box, GlobalCoverageInformationBox and/or TrackCoverageInformationBox described above.

The illustrated fisheye 360 video box 55010 may provide fisheye video information. The fisheye video information is a kind of the signaling information, and may provide information about a circular image, a rectangular region to which the circular image is mapped, monoscopic 360 video data or stereoscopic 360 video data transmitted in the form of the circular image, the type of the rectangular region, and the like. In addition, the fisheye video information may provide information necessary for extraction, projection, and blending of the circular image at the reception side.

The illustrated fisheye 360 video boxes 55010 and 55020 defined as fovd may describe the characteristics of the projected picture (the picture to which the circular images are mapped). The fisheye 360 video box 55010 may provide fisheye video information about the fisheye 360 video and/or information about the spherical coverage of the fisheye 360 video.

The GlobalCoverageInformationBox may provide information about the coverage of the sphere region represented by the picture of the entire content.

The illustrated GlobalCoverageInformationBox 55030 may be included in the fisheye 360 video box 55010 described above. According to an embodiment, the global coverage information box 55030 may be included in a projection 360 video box povd that provides information about the 360 video being projected.

GlobalCoverageInformationBox may include global_coverage_shape_type and/or SphereRegionStruct( ).

The global_coverage_shape_type is information indicating the shape of the sphere region, and may have the same meaning as the shape_type field described above for the sphere region represented by the entire content.

As described above, the shape_type information may indicate what shape the corresponding region has. When the value of shape_type is 0, the region may have a shape specified by the four great circles described above. When the value of shape_type is 1, the region may have a shape specified by two yaw circles and two pitch circles.

Here, when shape_type has a newly defined value of 2, the region or the sphere region may be defined as one small circle as shown in the illustrated diagram 55050. In the illustrated diagram 55050, the circle denoted as cSmall may be defined by a variable cPitch. When the circle cSmall is defined by the variable cPitch, it may be defined relative to the Y axis aligned with the direction of the center point specified by center_yaw and center_pitch. The variable cPitch may be defined as cPitch=(90*216−ver_range÷2)÷65536.

If SphereRegionStruct( ) is included in GlobalCoverageInformationBox, the same details as those of RegionOnSphereStruct( ) described above may be described for the sphere region.

Specifically, when the value of global_coverage_shape_type is 0 or 1, center_yaw, center_pitch, and center_roll may indicate the yaw, pitch, and roll values of the center point of the sphere region, similarly to the center_yaw, center_pitch, and center_roll of SphereRegionStruct described above.

When the value of global_coverage_shape_type is 2, center_yaw, center_pitch, and center_roll may indicate the yaw, pitch, and roll values of the center point of the sphere region relative to the global coordinate axes.

The units and ranges of center_yaw, center_pitch, and center_roll may be the same as those of SphereRegionStruct described above.

When the value of global_coverage_shape_type is 0 or 1, hor_range and ver_range may indicate the horizontal range and the vertical range of the sphere region, similarly to the hor_range and ver_range of SphereRegionStruct described above. In this case, the units and ranges of hor_range and ver_range may be the same as those of SphereRegionStruct described above.

When the value of global_coverage_shape_type is 2, the value of hor—range may be ignored. ver_range may indicate the range based on the center of the sphere region (55050). ver_range may have a value between 0 and 360*2¹⁶. The value of interpolate may be 0.

TrackCoverageInformationBox may provide information about the coverage of the sphere region indicated by the track.

The illustrated TrackCoverageInformationBox 55040 may be included in the fisheye 360 video box 55010 described above. According to an embodiment, the TrackCoverageInformationBox 55040 may be included in the projection 360 video box povd.

TrackCoverageInformationBox may include track_coverage_shape_type and/or SphereRegionStruct( ).

The track_coverage_shape_type is information indicating the shape of the sphere region, and may have the same meaning as the shape_type field described above for the sphere region indicated by the track.

When SphereRegionStruct( ) is included in TrackCoverageInformationBox, it may describe the same details as those of RegionOnSphereStruct( ) described above for the sphere region.

Specifically, when the value of track_coverage_shape_type is 0 or 1, center_yaw, center_pitch, and center_roll may indicate the yaw, pitch, and roll values of the center point of the sphere region, similarly to the center_yaw, center_pitch, and center_roll of SphereRegionStruct described above.

When the value of track_coverage_shape_type is 2, center_yaw, center_pitch, and center_roll may indicate the yaw, pitch, and roll values of the center point of the sphere region relative to the global coordinate axes.

The units and ranges of center_yaw, center_pitch, and center_roll may be the same as those of SphereRegionStruct described above.

When the value of track_coverage_shape_type is 0 or 1, hor_range and ver_range may indicate the horizontal range and the vertical range of the sphere region, similarly to the hor_range and ver_range of SphereRegionStruct described above. In this case, the units and ranges of hor_range and ver_range may be the same as those of SphereRegionStruct described above.

When the value of track_coverage_shape_type is 2, the value of hor_range may be ignored. ver_range may indicate the range based on the center of the sphere region (55050). ver_range may have a value between 0 and 360*216. The value of interpolate may be 0.

The above-described embodiments of the fisheye 360 video box according to the present invention may be combined with each other. In the embodiments of the 360 video transmission apparatus and/or the 360 video reception apparatus according to the present invention, the fisheye 360 video box may be the fisheye 360 video box according to the above-described embodiments.

The above-described embodiments of GlobalCoverageInformationBox according to the present invention may be combined with each other. In the embodiments of the 360 video transmission apparatus and/or the 360 video reception apparatus according to the present invention, GlobalCoverageInformationBox may be the GlobalCoverageInformationBox according to the above-described embodiments.

The above-described embodiments of TrackCoverageInformationBox according to the present invention may be combined with each other. In the embodiments of the 360 video transmission apparatus and/or the 360 video reception apparatus according to the present invention, TrackCoverageInformationBox may be the TrackCoverageInformationBox according to the above-described embodiments.

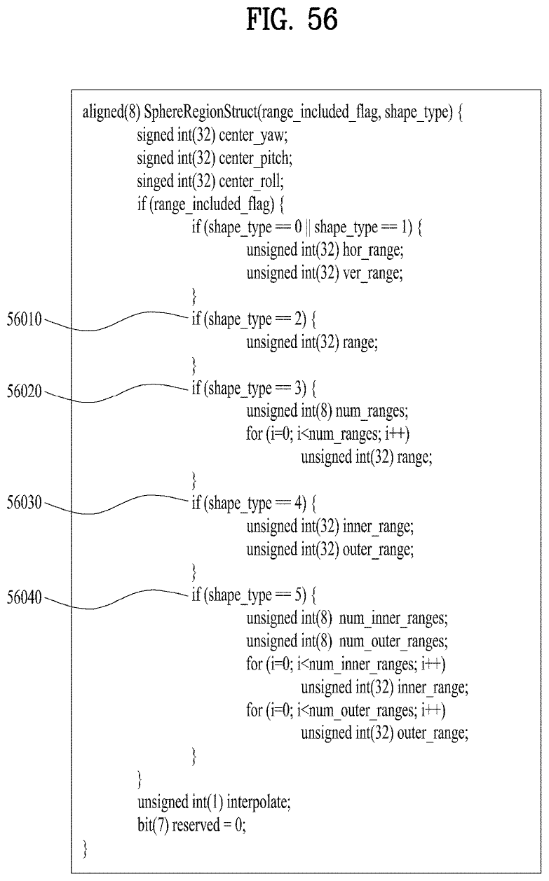

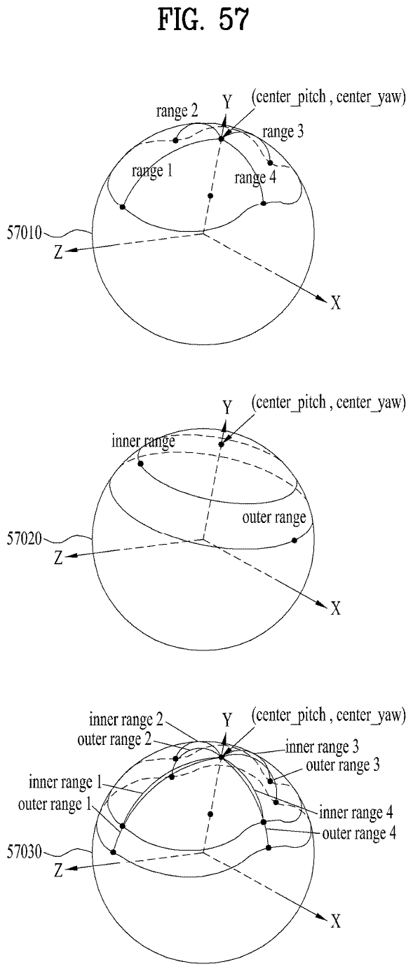

FIGS. 56 and 57 show another embodiment of SphereRegionStruct for a fisheye 360 video according to the present invention.

As described above, SphereRegionStruct may describe a region presented on a spherical surface. SphereRegionStruct may specify the center point of the region through center_yaw, center_pitch, and center_roll.

SphereRegionStruct according to the illustrated embodiment may be SphereRegionStruct of a modified form according to shape_type having the new values described above. In the case where the fisheye 360 video data is used, SphereRegionStruct according to the illustrated embodiment may be used to describe the region presented on the spherical surface. Here, another shape_type value other than ‘2’ described above may be further defined.

Specifically, when shape_type is 2, it may be indicated that the region is specified by one small circle described above. In this case, a range field may be included in SphereRegionStruct to specify the range of the region. The range field may indicate a value of half the angle from the center point to the ‘small circle’, similarly to ver_range described above.

When shape_type is 3, it may be indicated that the region is surrounded by curved surfaces having a plurality of ranges (57010). In this case, in order to specify the range of the region, a num_range field for indicating the number of ranges may be included in SphereRegionStruct. A range field may be further added for each range according to the num_range field.

The range field may indicate a value of half the angle from the center point to each curved surface. According to an embodiment, the order in which a plurality values of the range field is applied and/or the spacing between the curved surfaces may be determined. According to an embodiment, the order may be determined as clockwise or counterclockwise with respect to the Z axis. According to an embodiment, the spacing between the curved surfaces may be determined as 360/num_range. In this case, if num_range has a value of 4, the curved surfaces may be positioned at intervals of 90 degrees.

If the shape_type is 4, it may be indicated that the region is surrounded by two small circles (57020). In this case, in order to specify the range of the region, inner_range and/or outer_range fields may be included in SphereRegionStruct. The outer_range field may indicate the value of half the angle from the center point to the outer small circle. The inner_range field may indicate the value of half the angle from the center point to the inner small circle. According to an embodiment, this type of region may be mapped to a donut-shaped circular image.

When shape_type is 5, there may be two curved surfaces having the same shape as in the case where shape_type is 3, and it may be indicated that the region has a shape surrounded by these two curved surfaces (57030). In this case, a num_inner_ranges field and/or a num_outer_ranges field may be included in SphereRegionStruct to specify the range of the region.

An inner_range field may be further added for each inner_range according to the num_inner_ranges field. The inner_range field may indicate a value of half the angle from the curve surface closer to the center point to the center point.

An outer_range field may be further added for each outer range according to the num_outer_ranges field. The outer_range field may indicate a value of half the angle from the curved surface farther to the center point to the center point.

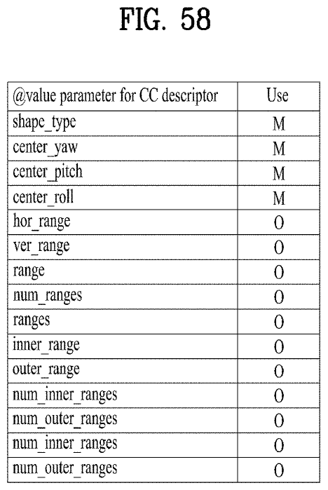

FIG. 58 show yet another embodiment of SphereRegionStruct for a fisheye 360 video according to the present invention.

The above-described SphereRegionStruct for the fisheye 360 video may take the form of a DASH descriptor. When the fisheye 360 video data is transmitted as described above, it may be transmitted through DASH. In this case, SphereRegionStruct for the fisheye 360 video may be delivered in the form of an Essential Property or Supplemental Property descriptor of DASH MPD. According to an embodiment, this descriptor may be included in each level on the MPD, such as Adaptation Set, Representation, and/or Sub Representation.

SphereRegionStruct for the fisheye 360 video according to the illustrated embodiment may include shape_type, center_yaw, center_pitch, center_roll, hor_range, ver_range, range, num_ranges, ranges, inner_range, outer_range, num_inner_ranges, num_outer_ranges, num_inner_ranges, and/or num_outer_ranges.

The shape_type may correspond to the shape_type having newly defined values described above. It may indicate the shape of the sphere region of the fisheye 360 video data for the corresponding representation.

The center_yaw, center_pitch, and center_roll may indicate the yaw, pitch, and roll values of the center point of the sphere region based on the global coordinate axes.

The hor_range, and ver_range may indicate the horizontal range and vertical range of the sphere region based on the center point specified by center_yaw, center_pitch, and center_roll.

The range, num_ranges, ranges, inner_range, outer_range, num_inner_ranges, num_outer_ranges, num_inner_ranges, and num_outer_ranges may have the same meaning as the above-described fields of the same names. Here, since they are described in the form of a DASH descriptor, ranges may have individual range values described by being separated by commas. The num_inner_ranges and num_outer_ranges may have individual inner_range and outer_range values described by being separated by commas.

The above-described embodiments of SphereRegionStruct for fisheye 360 video according to the invention may be combined with each other. In the embodiments of the 360 video transmission apparatus and/or the 360 video reception apparatus according to the present invention, SphereRegionStruct for fisheye 360 video may be the SphereRegionStruct for fisheye 360 video according to the above-described embodiments.

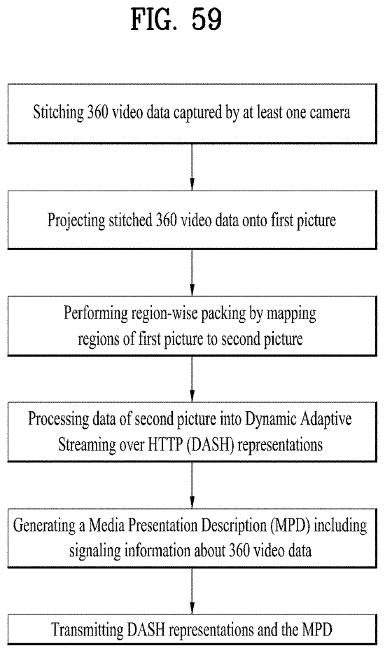

FIG. 59 illustrates an embodiment of a method for transmitting a 360 video, which may be carried out by the 360 video transmission apparatus according to the present invention.

One embodiment of a method for transmitting a 360 video may include stitching 360 video data captured by at least one camera, projecting the stitched 360 video data onto a first picture, performing region-wise packing by mapping regions of the first picture to a second picture, processing data of the second picture into Dynamic Adaptive Streaming over HTTP (DASH) representations, generating a Media Presentation Description (MPD) including signaling information about the 360 video data, and/or transmitting the DASH representations and the MPD.

The video processor of the 360 video transmission apparatus may stitch the 360 video data captured by at least one camera and project the stitched 360 video data onto the first picture. In addition, the video processor may perform region-wise packing by mapping the regions of the first picture to the second picture.

The encapsulation processor may process the data of the second picture into Dynamic Adaptive Streaming over HTTP (DASH) representations. The metadata processor may generate a Media Presentation Description (MPD) including signaling information about the 360 video data. The transmission processor or the transmission unit may transmit the DASH representations and the MPD.

In another embodiment of the method for transmitting a 360 video, the MPD may include a first descriptor and/or a second descriptor. Here, the first descriptor may include information indicating a projection type used when the stitched 360 video data is projected onto the first picture. The second descriptor may include information indicating a packing type used when the region-wise packing is performed from the first picture to the second picture.

In another embodiment of the method for transmitting a 360 video, the information indicating the projection type may indicate that the projection has an equirectangular projection type or a cubemap projection type. The information indicating the packing type may indicate that the region-wise packing has a rectangular region-wise packing type.

In another embodiment of the method for transmitting 360 video, the MPD may include a third descriptor. The third descriptor may include coverage information indicating a region occupied by the entire region corresponding to the 360 video data in the 3D space. The coverage information may specify the center point of the region in the 3D space using azimuth and elevation values and may specify the horizontal and vertical ranges of the region.

In another embodiment of the method for transmitting a 360 video, at least one of the DASH representations may be a timed metadata representation including timed metadata. The timed metadata may include initial viewpoint information indicating an initial viewpoint. The timed metadata may also include information for identifying a DASH representation having 360 video data to which the initial viewpoint information is applied.

In another embodiment of the method for transmitting a 360 video, the timed metadata may include recommended viewport information indicating a viewport that is recommended by the service provider. The timed metadata may also include information for identifying a DASH representation having 360 video data to which the recommended viewport information is applied.

In another embodiment of the method for transmitting a 360 video, the third descriptor may further include a single signaling field simultaneously indicating frame packing arrangement information about a 360 video corresponding to the region and/or whether the 360 video is a stereomoscopic 360 video. This signaling field may be view_idc described above.

The above-described 360 video reception apparatus according to the present invention may carry out a method for receiving a 360 video. The method for receiving a 360 video may have embodiments corresponding to the above-described method for transmitting a 360 video according to the present invention. The method for receiving a 360 video and embodiments thereof may be carried out by the 360 video reception apparatus and the internal/external components thereof according to the present invention described above.

Here, the region (in the sense of region-wise packing) may refer to a region for which 360 video data projected onto a 2D image is positioned within a packed frame through region-wise packing. Here, the region may refer to a region used in the region-wise packing depending on the context. As described above, the regions may be distinguished by dividing the 2D image equally or arbitrarily according to the projection scheme or the like.

Here, the region (having a general meaning) may be used according to the dictionary definition thereof, unlike the region used in the above-described region-specific packing. In this case, the region may have the meaning of “area,” “section,” “part,” or the like as defined in the dictionary. For example, in referring to one area of a face which will be described later, an expression such as “one region of the face” may be used. In this case, the region is distinguished from the region in the above-described region-specific packing, and both regions may indicate different regions irrelevant to each other.

Here, the picture may refer to the entire 2D image onto which the 360 video data is projected. According to an embodiment, a projected frame or a packed frame may be a picture.

Here, a sub-picture may refer to a part of the above-mentioned picture. For example, a picture may be divided into several sub-pictures to perform tiling or the like. In this case, each sub-picture may be a tile.

Here, a tile is a sub-concept of a sub-picture, and a sub-picture may be used as a tile for tiling. That is, in tiling, the sub-picture may be conceptually the same as the tile.

A spherical region or sphere region may refer to one region in a spherical surface when 360 video data is rendered on a 3D space (e.g., a sphere) on the reception side. Here, the spherical region is irrelevant to the region in the region-wise packing. In other words, the spherical region does not need to mean the same region as the region defined in the region-wise packing. The spherical region is a term used to refer to a part of a spherical surface to which rendering is performed, where “region” may refer to the “region” as defined in the dictionary. Depending on the context, the spherical region may simply be called a region. The spherical region or the sphere region may be referred to as a spherical surface region.

Here, the face may be a term that refers to each face according to a projection scheme. For example, when cubemap projection is used, the front, back, both sides, top, and bottom may be referred to as faces.

Each of the aforementioned parts, modules or units may be a processor or a hardware part designed to execute a series of execution steps stored in a memory (or a storage unit). Each step described in the above-mentioned embodiments may be implemented by processors or hardware parts. Each module, each block, and/or each unit described in the above-mentioned embodiments may be realized by a processor/hardware. In addition, the above-mentioned methods of the present invention may be realized by code written in recoding media configured to be read by a processor so that the code may be read by the processor provided by the apparatus.

Although the description of the present invention is explained with reference to each of the accompanying drawings for clarity, it is possible to design new embodiments by merging the embodiments shown in the accompanying drawings with each other. If a recording medium readable by a computer, in which programs for executing the embodiments mentioned in the foregoing description are recorded, is designed by those skilled in the art, it may fall within the scope of the appended claims and their equivalents.

The devices and methods according to the present invention may be non-limited by the configurations and methods of the embodiments mentioned in the foregoing description. The embodiments mentioned in the foregoing description may be configured in a manner of being selectively combined with one another entirely or in part to enable various modifications.

In addition, a method according to the present invention may be implemented with processor-readable code in a processor-readable recording medium provided to a network device. The processor-readable medium may include all kinds of recording devices capable of storing data readable by a processor. The processor-readable medium may include one of ROM, RAM, CD-ROM, magnetic tapes, floppy disks, optical data storage devices, and the like and also include carrier-wave type implementation such as a transmission via Internet. Furthermore, as the processor-readable recording medium is distributed to a computer system connected via a network, processor-readable code may be saved and executed in a distributed manner.

Although the invention has been described with reference to the exemplary embodiments, those skilled in the art will appreciate that various modifications and variations can be made in the present invention without departing from the spirit or scope of the invention described in the appended claims. Such modifications are not to be understood individually from the technical idea or viewpoint of the present invention

It will be appreciated by those skilled in the art that various modifications and variations may be made in the present invention without departing from the spirit or scope of the inventions. Thus, it is intended that the present invention covers the modifications and variations of this invention provided they come within the scope of the appended claims and their equivalents.

Both apparatus and method inventions are mentioned in this specification and descriptions of both the apparatus and method inventions may be complementarily applicable to each other.

### Mode for Invention

Various embodiments have been described in the best mode for carrying out the invention.

### Industrial Applicability

The present invention is used in a series of VR related fields.

It will be apparent to those skilled in the art that various modifications and variations may be made in the present invention without departing from the spirit or scope of the invention. Thus, it is intended that the present invention cover the modifications and variations of this invention provided they come within the scope of the appended claims and their equivalents.

1. A method for transmitting a 360 video comprising:
stitching 360 video data captured by at least one camera;
projecting the stitched 360 video data on a first picture;
region-wise packing each region of the first picture by mapping the each region of the first picture into a second picture;
generating data in the second picture based on Dynamic Adaptive Streaming over HTTP (DASH) representations;
generating signaling information for the 360 video data; and
transmitting the DASH representations and the signaling information.

2. The method according to claim 1,
wherein the signaling information includes coverage information including yaw information and pitch information of a viewpoint for the 360 video data.

3. The method according to claim 1,
wherein the signaling information includes a first descriptor and a second descriptor,
the first descriptor includes information representing a projection type used for the projecting the stitched 360 video data,
the second descriptor includes information representing a packing type used for the region-wise packing each region of the first picture,
wherein the information representing the projection type indicates that the projecting includes equirectangular projection type or a cubemap projection type,
the information representing the packing type indicates that the region-wise packing includes a rectangular region-wise packing type.

4. The method according to claim 1,
wherein the signaling information comprises a third descriptor,
the third descriptor includes coverage information representing a coverage of a 3D space for a full region corresponding to the 360 video data,
the coverage information represents a center of the coverage of the 3D space on a azimuth value and an elevation value and a horizontal range and a vertical range of the coverage.

5. The method according to claim 1,
wherein at least one of the DASH representations is a timed metadata representation including timed metadata,
the timed metadata comprises initial viewpoint information indicating an initial viewpoint,
the timed metadata includes information indicating the initial viewpoint information.

6. The method according to claim 5,
wherein the timed metadata includes recommended viewport information representing a viewport recommended by a service provider,
the timed metadata includes information identifying a DASH representation including 360 video data for the recommended viewport information.

7. The method according to claim 4,
wherein the third descriptor includes frame packing arrangement information of 360 video data corresponding to the coverage and a signaling field representing whether or not the 360 video data is stereoscopic 360 video data.

8. An apparatus for transmitting a 360 video, comprising:
a video processor configured to stitch 360 video data captured by at least one camera,
the video processor projecting the stitched 360 video data on a first picture and region-wise packing each region of the first picture by mapping the each region of the first picture into a second picture;
an encapsulation processor configured to generate data of the second picture based on Dynamic Adaptive Streaming over HTTP (DASH) representations;
a metadata processor configured to generate signaling information about the 360 video data; and
a transmission unit configured to transmit the DASH representations and the signaling information.

9. The apparatus according to claim 8,
wherein the signaling information includes coverage information including yaw information and pitch information of a viewpoint for the 360 video data.

10. The apparatus according to claim 8,
wherein the signaling information includes a first descriptor and a second descriptor,
the first descriptor includes information representing a projection type used for the projecting the stitched 360 video data,
the second descriptor includes information representing a packing type used for the region-wise packing each region of the first picture,
wherein the information representing the projection type indicates that the projecting includes an equirectangular projection type or a cubemap projection type,
the information representing the packing type indicates that the region-wise packing includes a rectangular region-wise packing type.

11. The apparatus according to claim 8,
wherein the signaling information includes a third descriptor,
the third descriptor includes coverage information representing a coverage of a 3D space for a full region corresponding to the 360 video data,
the coverage information represents a center of the coverage of the 3D space based on a azimuth value and an elevation value and a horizontal range and a vertical range of the coverage.

12. The apparatus according to claim 8,
wherein at least one of the DASH representations is a timed metadata representation including timed metadata,
the timed metadata includes initial viewpoint information representing initial viewpoint,
the timed metadata includes information indicating the initial viewpoint information.

13. The apparatus according to claim 12,
wherein the timed metadata includes recommended viewport information representing a viewport recommended by a service provider,
the timed metadata includes information identifying a DASH representation including 360 video data for the recommended viewport information.

14. The apparatus according to claim 8,
wherein the third descriptor includes frame packing arrangement information of 360 video data corresponding to the coverage and a signaling field representing whether or not the 360 video data is stereoscopic 360 video data.
